(19) United States
(12) Patent Application Publication
(10) Pub. No.: US 2026/0129647 A1
(43) Pub. Date: May 7, 2026

(54) UE INITIATED BEAM REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/367,774

(22) Filed: Oct. 23, 2025

Related U.S. Application Data
(60) Provisional application No. 63/717,673, filed on Nov. 7, 2024.
(60) Provisional application No. 63/733,248, filed on Dec. 12, 2024.
(60) Provisional application No. 63/778,987, filed on Mar. 27, 2025.
(60) Provisional application No. 63/781,077, filed on Mar. 31, 2025.
(60) Provisional application No. 63/783,404, filed on Apr. 4, 2025.
(60) Provisional application No. 63/807,280, filed on May 16, 2025.

(51) Int. Cl. H04W 72/21; H04B 7/06

(52) U.S. Cl. CPC H04W 72/21; H04B 7/0626

(57) ABSTRACT

Methods and apparatuses for user equipment (UE)-initiated beam reporting procedures. A method performed by a UE includes receiving first information related to event evaluation and UE-initiated reporting, determining, based on the first information, whether to trigger transmission of a UE-initiated report indicator (UERI), and when the transmission is triggered, determining a first transmission occasion (TO) of a physical uplink control channel (PUCCH) resource to carry the UEIRI. The method further includes identifying, based on the first TO, a second TO of a resource for a target physical uplink shared channel (PUSCH) overlapping with the first TO and transmitting the UEIRI in the second TO. The target PUSCH carries second information.

### CROSS-REFERENCE TO RELATED AND CLAIM OF PRIORITY

The present application claims priority under 35 U.S.C. § 119(e) to U.S. Provisional Patent Application No. 63/717,673 filed on Nov. 7, 2024; U.S. Provisional Patent Application No. 63/733,248 filed on Dec. 12, 2024; U.S. Provisional Patent Application No. 63/778,987 filed on Mar. 27, 2025; U.S. Provisional Patent Application No. 63/781,077 filed on Mar. 31, 2025; U.S. Provisional Patent Application No. 63/783,404 filed on Apr. 4, 2025; and U.S. Provisional Patent Application No. 63/807,280 filed on May 16, 2025, which are hereby incorporated by reference in their entirety.

### TECHNICAL FIELD

The present disclosure relates generally to wireless communication systems and, more specifically, the present disclosure relates to methods and apparatuses for user equipment (UE)-initiated beam reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated beam reporting.

In one embodiment, a user equipment (UE) is provided. The UE includes a transceiver configured to receive first information related to event evaluation and UE-initiated reporting and a processor operably coupled with the transceiver. The processor is configured to determine, based on the first information, whether to trigger transmission of a UE-initiated report indicator (UERI), when the transmission is triggered, determine a first transmission occasion (TO) of a physical uplink control channel (PUCCH) resource to carry the UEIRI, and identify, based on the first TO, a second TO of a resource for a target physical uplink shared channel (PUSCH) overlapping with the first TO, wherein the target PUSCH carries second information. The transceiver is further configured to transmit the UEIRI in the second TO.

In another embodiment, a base station (BS) is provided. The BS includes a processor and a transceiver operably coupled with the processor. The transceiver is configured to transmit first information related to event evaluation and UE-initiated reporting and receive a UERI in a second TO after transmission of a UERI is triggered. The second TO is of a resource for a target PUSCH overlapping with a first TO. The first TO is of a PUCCH resource to carry the UEIRI. The target PUSCH carries second information.

In yet another embodiment, a method performed by a UE is provided. The method includes receiving first information related to event evaluation and UE-initiated reporting, determining, based on the first information, whether to trigger transmission of a UERI, and when the transmission is triggered, determining a first TO of a PUCCH resource to carry the UEIRI. The method further includes identifying, based on the first TO, a second TO of a resource for a target PUSCH overlapping with the first TO and transmitting the UEIRI in the second TO. The target PUSCH carries second information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example timeline of periodicities and time offsets according to embodiments of the present disclosure;

FIG. 8 illustrates an example timeline of periodicities and time offsets according to embodiments of the present disclosure;

FIG. 9 illustrates an example timeline of periodicities and time offsets according to embodiments of the present disclosure;

FIGS. 10A and 10B illustrate an example timeline for time window determination according to embodiments of the present disclosure; and

FIG. 11 illustrates an example method performed by a UE in a wireless communication system according to embodiments of the present disclosure.

### DETAILED DESCRIPTION

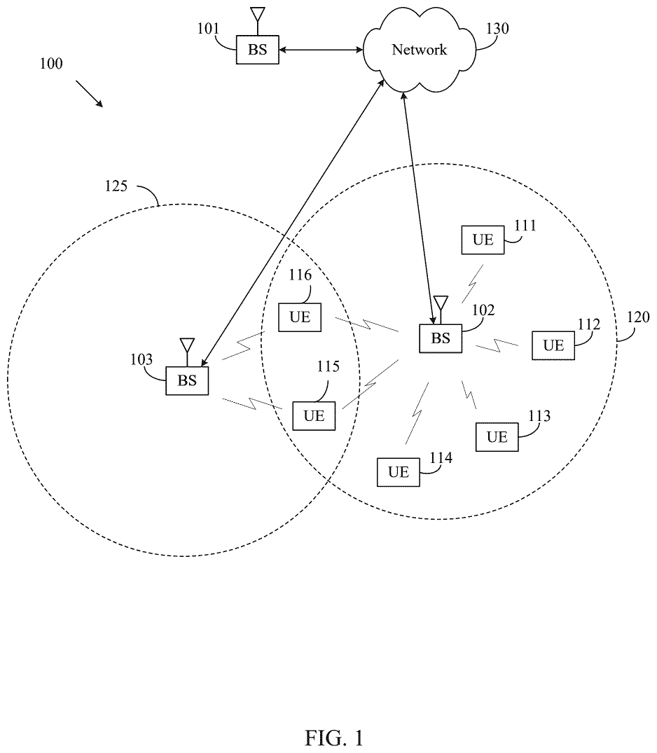

FIGS. 1-11, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE-initiated beam reporting procedures. In certain embodiments, one or more of the BSs 101-103 include circuitry, programing, or a combination thereof to support UE-initiated beam reporting procedures.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

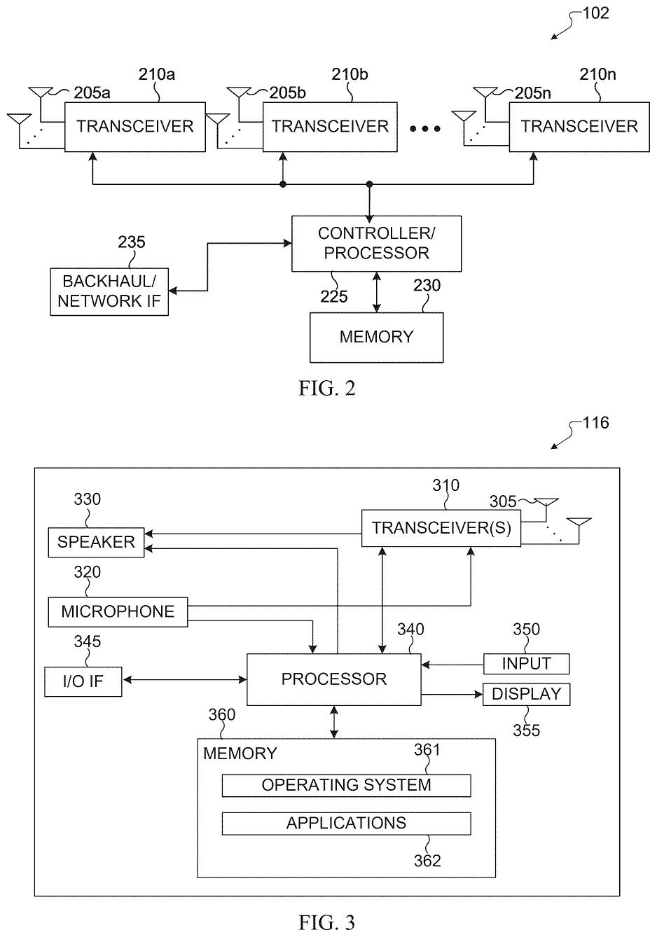

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting UE-initiated beam reporting procedures. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize UE-initiated beam reporting procedures as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

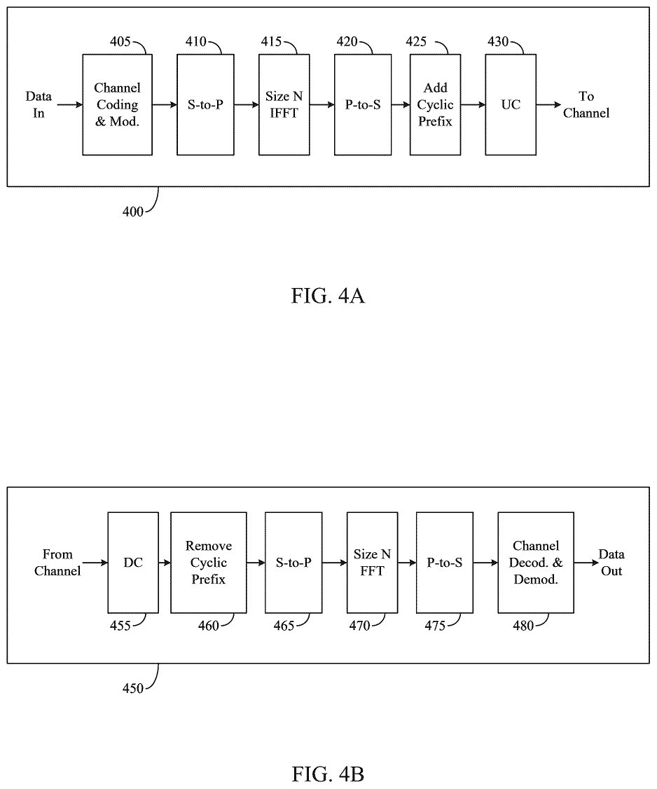

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support UE-initiated beam reporting procedures as described in embodiments of the present disclosure. In some embodiments, the receive path 450 is configured to support UE-initiated beam reporting procedures as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

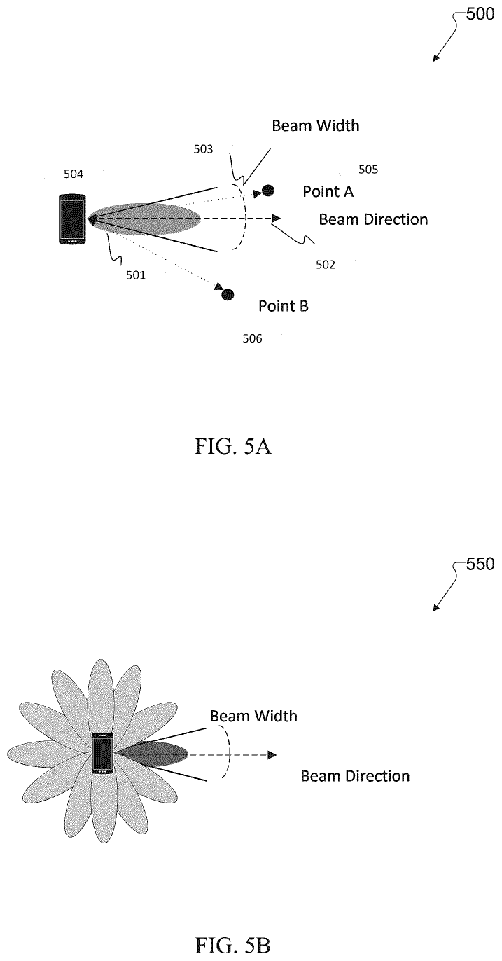

As illustrated in FIG. 5A, in a wireless system 500, a beam 501 for a device 504 can be characterized by abeam direction 502 and abeam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

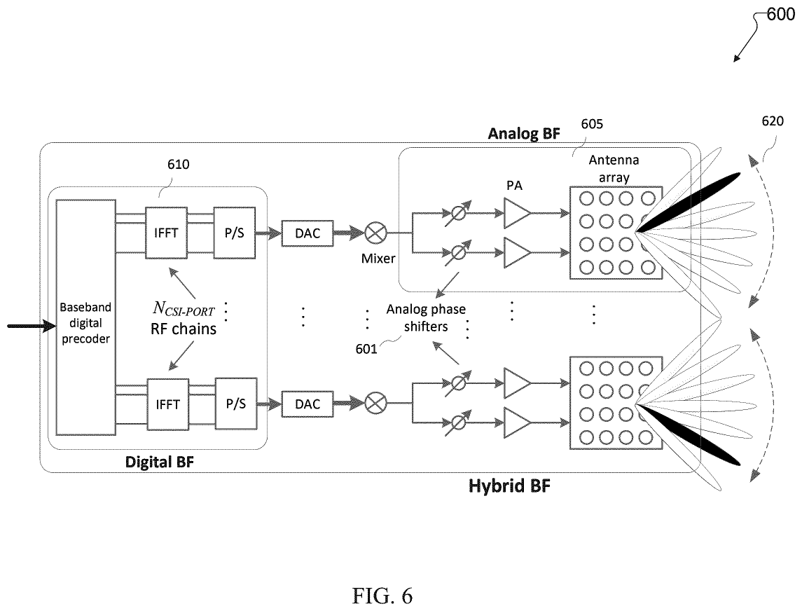

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In this disclosure, a beam is determined by either of,
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g. for beam report, the event can be beam failure, and for CSI, the event can be user throughput degradation or increasing retransmission rate).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various report formats customized for the UE-initiated/event-driven beam reporting, and specifies different conditions or settings to apply or use different report formats. Means of detecting/declaring different events or combinations of different events, and designs of their corresponding configurations and signaling details are specified in this disclosure as well.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB (e.g., the network 130/the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. channel quality indicator (CQI) report interval (CRI), SSB resource indicator (SSBRI)) and Jᵢ is a beam metric (e.g. L1—reference signal received power (RSRP), L1—signal-to-interference-plus-noise ratio (SINR)).
In one example, the content includes CSI-related quantity/quantities. For example, at least one of: rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE (e.g., the UE 116) can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be Joint, as shown in Table 4. A few examples of the autonomous UE-initiated report are shown in Table 5.

TABLE 1
event-based UE-initiated report

| | Report | | |
|---|---|---|---|
| | | Trigger/pre- | |
| | | notification | |
| Event type | Type | message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/ | (A) | Yes (e.g. non-CSI-related event) | No |
| beam/TDCP | (B) | No | Yes |
| | (C) | Yes (e.g. non-CSI-related event) | Yes |
| 4. other (content-free/ | (A) | Yes (no need for content) | No |
| less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| | Trigger/pre- | |
|---|---|---|
| | notification | |
| Report-type | message | Content |
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| | Trigger/pre- | |
|---|---|---|
| | notification | |
| Type | message | Content |
| 0 | Yes (content- | No |
| | agnostic/ | |
| | transparent) | |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. MCS, or number of CWs.
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network (e.g., the network 130), e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

Under the aforementioned unified TCI framework, a UE could receive a (unified) TCI state(s) activation/deactivation (MAC CE) command, used to map up to a number of activated TCI states and/or pairs of activated TCI states, with one activated TCI state for DL channels/signals and/or one activated TCI state for UL channels/signals to the codepoints of the DCI field ‘Transmission Configuration Indication’ for one or for a set of CCs/DL BWPs, and if applicable, for one or for a set of CCs/UL BWPs. That is, a UE could receive from the network, in/via a (unified) TCI state(s) activation/deactivation (MAC CE) command, up to a number of TCI codepoints of the DCI field ‘Transmission Configuration Indication’ for one or for a set of CCs/DL BWPs, and if applicable, for one or for a set of CCs/UL BWPs with each TCI codepoint mapped to an activated TCI state and/or a pair of activated TCI states, with one activated TCI state for DL channels/signals and/or one activated TCI state for UL channels/signals. In the present disclosure, an activated TCI state can also be referred to as an activated beam, and vice versa.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources as specified/defined herein in the present disclosure; furthermore, the UE could determine or identify the one or more activated beams/TCI states as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. Here, the UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

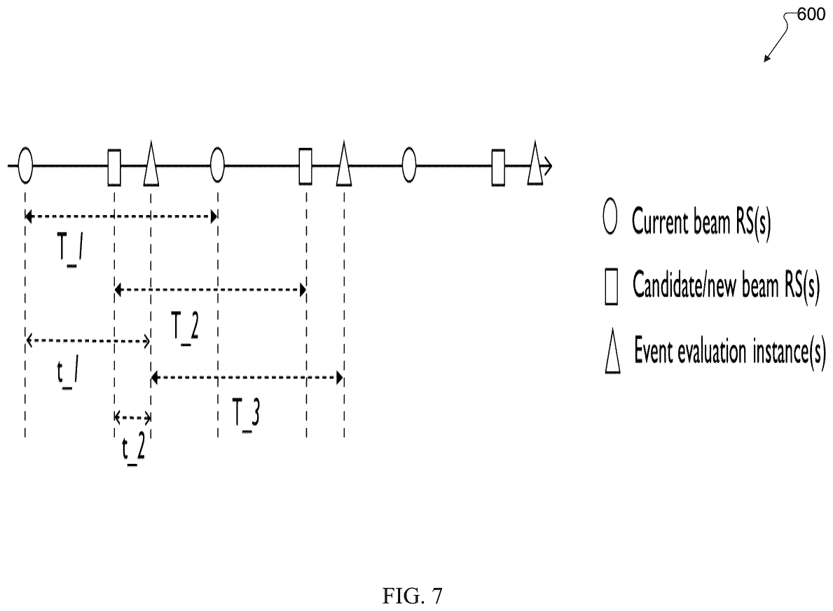

FIG. 7 illustrates an example timeline 700 of periodicities and time offsets according to embodiments of the present disclosure. For example, timeline 700 can be followed by any of the UEs 111-116 of FIG. 1, such as the UE 111 of FIG. 1. This example is for illustration only and other embodiments can be used without departing from the scope of the present disclosure.

With reference to FIG. 7, T_1, T_2, T_3: periodicities of current beam RS(s), candidate/new beam RS(s) and event evaluation instance(s), which could be the same/identical; t_1 is the time offset between an event evaluation instance and a corresponding current beam RS, t_1≥X; and/or t_2 is the time offset between an event evaluation instance and corresponding candidate/new beam RS(s), t_2≥X.

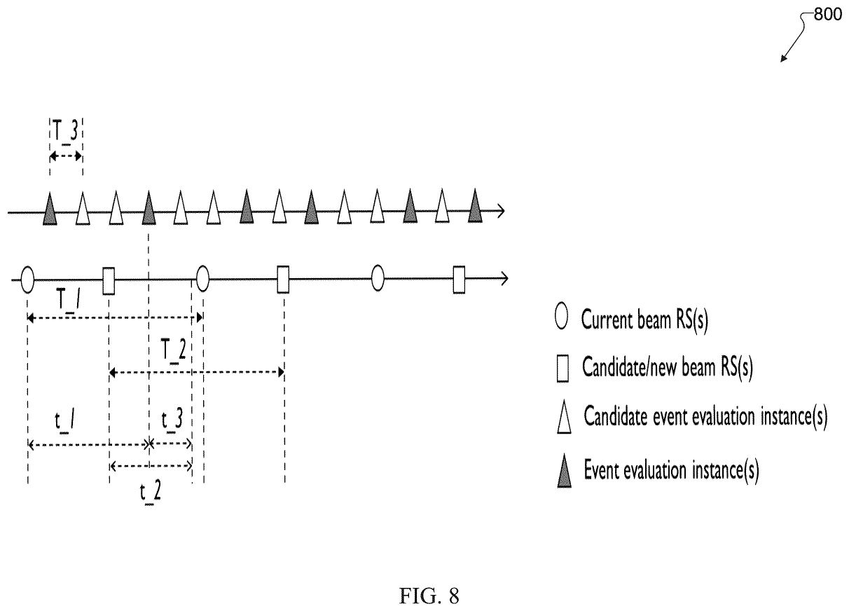

FIG. 8 illustrates an example timeline 800 of periodicities and time offsets according to embodiments of the present disclosure. For example, timeline 800 can be followed by any of the UEs 111-116 of FIG. 1, such as the UE 113 of FIG. 1. This example is for illustration only and other embodiments can be used without departing from the scope of the present disclosure.

With reference to FIG. 8, T_1, T_2, T_3: periodicities of current beam RS(s), candidate/new beam RS(s) and event evaluation instance(s); t_1 is the time offset between an event evaluation instance and a corresponding current beam RS, t_1≥X; t_2 is the time offset between a reference time instance and corresponding MO, t_2≥Z; and/or t_3 is the time offset between the event evaluation instance and the reference time instance t_3≥Y.

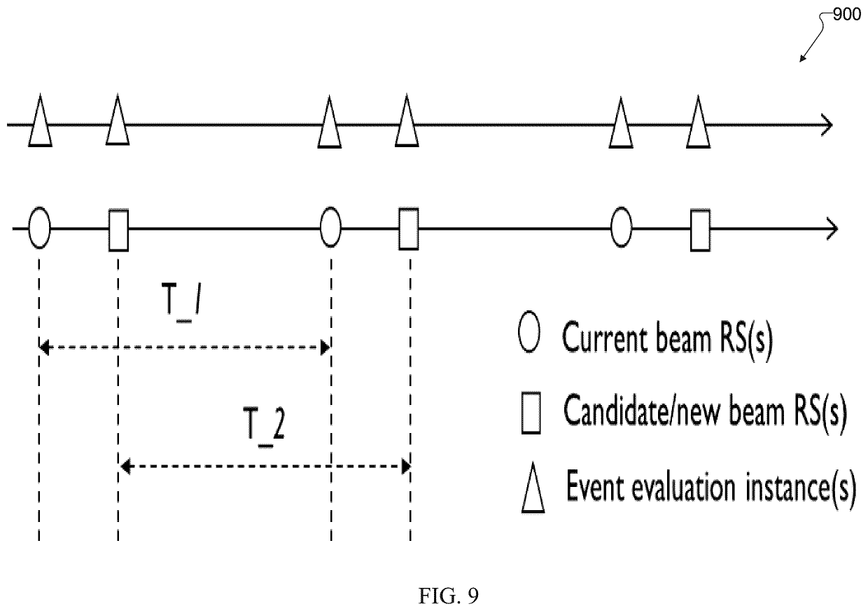

FIG. 9 illustrates an example timeline 900 of periodicities and time offsets according to embodiments of the present disclosure. For example, timeline 900 can be followed by any of the UEs 111-116 of FIG. 1, such as the UE 116 of FIG. 1. This example is for illustration only and other embodiments can be used without departing from the scope of the present disclosure.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be provided in or associated with higher layer parameter(s) CSI-ReportConfig, CSI-ResourceConfg associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1

For an activated TCI state—e.g., a joint/DL TCI state, a UE could determine or identify RS(s) or RS resource(s) or RS resource index(es) of/for the activated TCI state—denoted by activation beam RS(s) or RS resource(s) or RS resource indexe(s)—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set of NZP CSI-RS resources provided by NZP-CSI-RS-Resource Set (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g. currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g. currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g. currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network (e.g., the network 130) such that the higher layer parameter e.g. currentBeamRStype is set to ‘CSI-RS’.

According to or following those specified herein in the present disclosure, an event evaluation or event evaluation instance for determining an event instance (e.g., an Event-1 instance, Event-2 instance or Event-3 instance according to or following those specified herein in the present disclosure) could be associated/specific to one or more RSs/RS resources (e.g., a current beam RS/RS resource and/or one or more candidate/new beam RSs/RS resources in the corresponding resource set) such that: (case-1) the event evaluation/event evaluation instance could collide or overlap or comprise the one or more RSs/RS resources—e.g., the starting symbol/slot of the event evaluation (instance) is the same as/identical to the starting symbol/slot of the one or more RSs/RS resources, and/or the ending symbol/slot of the event evaluation (instance) is the same as/identical to the ending symbol/slot of (last transmission of) the one or more RSs/RS resources, (case-2) the event evaluation/event evaluation instance is after (or before) the one or more RSs/RS resources: in one example, the starting symbol/slot of the event evaluation (instance) could be the same as/identical to the ending (or starting) symbol/slot of the one or more RSs/RS resources or the first symbol/slot after (or before) the ending (or starting) symbol/slot of the one or more RSs/RS resources; in another example, the starting symbol/slot of the event evaluation (instance) could be at least (or at most) X symbol(s)/slot(s) after (or before) or no earlier (or later) than or starting from the ending (or starting) symbol/slot of the one or more RSs/RS resources or the first symbol/slot after (or before) the ending (or starting) symbol/slot of the one or more RSs/RS resources, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Optionally, an event evaluation or event evaluation instance could be of (time) length or duration L symbol(s)/slot(s)/etc., wherein the UE could determine or identify the value of L according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For or within or during an event evaluation or event evaluation instance, the UE could perform (L1) measurement(s) on/off the one or more RSs/RS resources associated/specific to the event evaluation (instance) and obtain/determine/identify the corresponding radio link/beam quality(s) including L1-RSRP(s)/L1-SINR(s)—e.g., when/if the event evaluation (instance) overlaps, collides or comprises the one or more RSs/RS resources as specified/defined herein in the present disclosure, and/or determine or identify occurrence of an event instance—e.g., based on or according to the (latest) L1 measurements of the one or more RSs/RS resources according to or following those specified herein in the present disclosure.
For evaluating, assessing or determining Event-1 or Event-1 instance(s) and/or when/if Event-1 as defined/specified herein in the present disclosure is enabled or provided or configured for the UEI beam reporting, the UE could determine or identify event evaluation(s) or event evaluation instance(s) or time interval(s) between event evaluations/evaluation instances or an event evaluation periodicity or a periodicity of event evaluation for determining Event-1 instance(s) as specified/defined herein in the present disclosure according to or following one or more of:
   In one example, the UE could determine or identify or expect or assume a/the same periodicity between the current serving beam RS(s)/RS resource(s) and the candidate/new beam RS(s)/RS resource(s) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could also be the same/identical. In this case, the event evaluation periodicity for determining Event-1 instance(s) could be the same as/identical to the periodicity of the current serving beam RS(s)/RS resource(s) or the candidate/new beam RS(s)/RS resource(s). Alternatively, the event evaluation periodicity for determining Event-1 instance(s) could be multiple (e.g., K times) of the periodicity of the current serving beam RS(s)/RS resource(s) or the candidate/new beam RS(s)/RS resource(s), wherein the UE could determine or identify the value K according to or based on: (i) a fixed value in system specification(s) and/or per RRC (re-)configuration, e.g., K=1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the UE (e.g., the UE 116) could determine or identify a time offset between a current serving beam RS/RS resource and a set of candidate/new beam RS(s)/RS resource(s) as the time offset between the current serving beam RS/RS resource and the p-th (e.g., with the p-th lowest/highest resource ID/index, the p-th earliest/latest in time/ordering/ordinal position in the resource set, the p-th transmission/reception and/or etc.) candidate/new beam RS/RS resource (the first (or last) symbol/slot that carries or conveys the current serving beam RS/RS resource could start (or end) a/the time offset earlier (or later) in time than the first (or last) symbol/slot that carries or conveys the p-th candidate/new beam RS/RS resource in the corresponding resource set) among the candidate/new beam RS(s)/RS resource(s) in the corresponding resource set, wherein the UE could determine or identify the value of p according to or based on: (i) a fixed value in system specification(s) and/or per RRC (re-)configuration, e.g., p=1 or p=P or p=┌P/2┐ or p=┌P/2┐ (P represents the total number of candidate/new beam RS(s)/RS resource(s) in the corresponding resource set), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could determine or identify value(s) of the aforementioned time offset based on or according to: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling:
      Case-a: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, an event evaluation (instance) for determining Event-1 instance(s) could comprise or correspond to a current serving beam RS/RS resource and candidate/new beam RS(s)/RS resource(s) in the corresponding resource set with zero time offset(s). Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set with zero time offset(s) for determining Event-1 instance(s).
      Case-b: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is non-zero (e.g., greater than zero), an event evaluation (instance) for determining Event-1 instance(s) could comprise or correspond to a current serving beam RS/RS resource and candidate/new beam RS(s)/RS resource(s) in the corresponding resource set having/with the lowest/smallest time offset. Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set having/with the lowest/smallest time offset for determining Event-1 instance(s).
      Case-c: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is non-zero (e.g., greater than zero), an event evaluation (instance) for determining Event-1 instance(s) could comprise or correspond to a current serving beam RS/RS resource and candidate/new beam RS(s)/RS resource(s) in the corresponding resource set having/with the lowest/smallest time offset among the time offset(s) determined or identified or configured or provided or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) earlier in time than the first (or last) symbol/slot that carries or conveys the current serving beam RS/RS resource. Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set having/with the lowest/smallest time offset—among the time offset(s) determined or identified or provided or configured or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) earlier in time than the first (or last) symbol/slot that carries or conveys the current serving beam RS/RS resource—for determining Event-1 instance(s).
      Case-d: when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is non-zero (e.g., greater than zero), an event evaluation (instance) for determining Event-1 instance(s) could comprise or correspond to a current serving beam RS/RS resource and candidate/new beam RS(s)/RS resource(s) in the corresponding resource set having/with the lowest/smallest time offset among the time offset(s) determined or identified or provided or configured or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) later in time than the first (or last) symbol/slot that carries or conveys the current serving beam RS/RS resource. Or equivalently, the UE could evaluate or assess, for/in an event evaluation or an event evaluation instance, radio link/beam qualities including L1-RSRPs/L1-SINRs of/for a current serving beam RS/RS resource and candidate/new beam RS(s)/RS resource(s) in the corresponding resource set having/with the lowest/smallest time offset—among the time offset(s) determined or identified or provided or configured or computed or calculated between the current serving beam RS/RS resource and the p-th candidate/new beam RS(s)/RS resource(s) in the corresponding resource set(s) according to or following those specified herein in the present disclosure wherein the first (or last) symbol(s)/slot(s) that carries or conveys the p-th candidate/new beam RS(s)/RS resource(s) in the corresponding resource set(s) could start (or end) later in time than the first (or last) symbol/slot that carries or conveys the current serving beam RS/RS resource—for determining Event-1 instance(s).

As specified or defined herein in the present disclosure, the event evaluation periodicity for determining Event-1 instance(s) could be the same as/identical to or multiple (e.g., K times) of (a) the periodicity of the current serving beam RS(s)/RS resource(s) and/or (b) the periodicity of the candidate/new beam RS(s)/RS resource(s) in the corresponding resource set(s) depending on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the UE could determine or identify a time offset between an event evaluation (instance) and a set of one or more RSs/RS resources (e.g., a current serving beam RS/RS resource or a set of one or more candidate/new beam RSs/RS resources) as the time offset between the event evaluation (instance) and the p-th (e.g., with the p-th lowest/highest resource ID/index, the p-th earliest/latest in time/ordering/ordinal position in the set, the p-th transmission/reception and/or etc.) RS/RS resource (the first (or last) symbol/slot of the event evaluation instance could start (or end) a/the time offset earlier (or later) in time than the first (or last) symbol/slot that carries or conveys the p-th RS/RS resource in the corresponding set) among the RS(s)/RS resource(s) in the corresponding set, wherein the UE could determine or identify the value of p according to or based on: (i) a fixed value in system specification(s) and/or per RRC (re-)configuration, e.g., p=1 or p=P or p=┌P/2┐ or p=┌P/2┐ (P represents the total number of RS(s)/RS resource(s) in the corresponding set), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could determine or identify value(s) of the aforementioned time offset based on or according to: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For an event evaluation (instance),
(A): a/the (lowest/smallest) time offset (e.g., higher layer configured/provided by the network subject to a corresponding UE's capability or capability signaling) between the event evaluation (instance) and the current serving beam RS(s)/RS resource(s) could be zero, and a/the (lowest/smallest) time offset (e.g., higher layer configured/provided by the network subject to a corresponding UE's capability or capability signaling) between the event evaluation (instance) and the candidate/new beam RS(s)/RS resource(s) in the corresponding resource set(s) could be non-zero (e.g., greater than zero). In this case, the event evaluation (instance) could be specific/associated to a corresponding current serving beam RS/RS resource. That is, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the current serving beam RS(s)/RS resource(s)—e.g., following those specified or defined in case-1 and/or case-2 by replacing the one or more RSs/RS resources with the current serving beam RS(s)/RS resource(s). For instance, the starting (and/or ending) symbol/slot of the event evaluation (instance) could be the same as/identical to the starting (and/or ending) symbol/slot of the current beam RS/RS resource—denoted by the first starting (and/or first ending) symbol/slot.
(B): a/the (lowest/smallest) time offset (e.g., higher layer configured/provided by the network subject to a corresponding UE's capability or capability signaling) between the event evaluation (instance) and the candidate/new beam RS(s)/RS resource(s) in the corresponding resource set(s) could be zero, and a/the (lowest/smallest) time offset (e.g., higher layer configured/provided by the network subject to a corresponding UE's capability or capability signaling) between the event evaluation (instance) and the current serving beam RS(s)/RS resource(s) could be non-zero (e.g., greater than zero). In this case, the event evaluation (instance) could be specific/associated to the corresponding candidate/new beam RS(s)/RS resource(s) in the corresponding resource set. That is, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the candidate/new beam RS(s)/RS resource(s) in the corresponding resource set—e.g., following those specified or defined in case-1 and/or case-2 by replacing the one or more RSs/RS resources with the candidate/new beam RS(s)/RS resource(s). For instance, the starting symbol/slot of the event evaluation (instance) could be the same as/identical to the starting symbol/slot of the first transmission of the one or more candidate/new beam RSs/RS resources in the corresponding resource set—denoted by the second starting symbol/slot, and the ending symbol/slot of the event evaluation (instance) could be the same as/identical to the ending symbol/slot of the last transmission of the one or more candidate/new beam RSs/RS resources in the corresponding resource set—denoted by the second ending symbol/slot.
(C): a/the (lowest/smallest) time offset (e.g., higher layer configured/provided by the network subject to a corresponding UE's capability or capability signaling) between the event evaluation (instance) and the candidate/new beam RS(s)/RS resource(s) in the corresponding resource set(s) could be zero, and a/the (lowest/smallest) time offset (e.g., higher layer configured/provided by the network subject to a corresponding UE's capability or capability signaling) between the event evaluation (instance) and the current serving beam RS(s)/RS resource(s) could be zero, and/or a/the (lowest/smallest) time offset (e.g., higher layer configured/provided by the network subject to a corresponding UE's capability or capability signaling) between the event evaluation (instance) and a set of the candidate/new beam RS(s)/RS resource(s) in the corresponding resource set(s) and the current serving beam RS(s)/RS resource(s) could be zero. In this case, the event evaluation (instance) could be specific/associated to a corresponding current serving beam RS/RS resource and/or candidate/new beam RS(s)/RS resource(s) in the corresponding resource set. That is, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding current beam RS/RS resource and/or candidate/new beam RS(s)/RS resource(s) in the corresponding resource set—e.g., following those specified or defined in case-1 and/or case-2 by replacing the one or more RSs/RS resources with the corresponding current beam RS/RS resource and/or candidate/new beam RS(s)/RS resource(s). For instance, the starting symbol/slot of the event evaluation (instance) could be the same as/identical to one or more of: (1) the starting symbol/slot of the current beam RS/RS resource—denoted by the first starting symbol/slot, (2) the starting symbol/slot of the first transmission of the one or more candidate/new beam RSs/RS resources in the corresponding resource set—denoted by the second starting symbol/slot, (3) min{the first starting symbol/slot, the second starting symbol/slot}—i.e., which one of them comes earlier in time, and (4) max{the first starting symbol/slot, the second starting symbol/slot}—i.e., which one of them comes later in time, wherein the UE could determine or identify which one or more of (1), (2), (3) and (4) to use or apply for determining the starting symbol/slot of the event evaluation (instance) according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In addition, the ending symbol/slot of the event evaluation (instance) could be the same as/identical to one or more of: (a) the ending symbol/slot of the current beam RS/RS resource—denoted by the first ending symbol/slot, (b) the ending symbol/slot of the last transmission of the one or more candidate/new beam RSs/RS resources in the corresponding resource set—denoted by the second ending symbol/slot, (3) min{the first ending symbol/slot, the second ending symbol/slot}—i.e., which one of them comes earlier in time, and (4) max{the first ending symbol/slot, the second ending symbol/slot}—i.e., which one of them comes later in time, wherein the UE could determine or identify which one or more of (a), (b), (c) and (d) to use or apply for determining the ending symbol/slot of the event evaluation (instance) according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(D): the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding current serving beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of a corresponding current serving beam RS/RS resource or the first symbol/slot after (or before) the ending (or starting) symbol/slot of the corresponding current serving beam RS/RS resource, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling.
(E): the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding candidate/new beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of one or more corresponding candidate/new beam RSs/RS resources in the resource set or the first symbol/slot after (or before) the ending (or starting) symbol/slot of the corresponding candidate/new beam RS(s)/RS resource(s) in the resource set, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(F): when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s) and their timing relations with respect to the corresponding current serving beam RS(s)/RS resource(s) and/or candidate/new beam RS(s)/RS resource(s)—e.g., the UE could determine or identify that the starting symbol/slot of an event evaluation (instance) could be at least (or at most) X symbol(s)/slot(s) after (or before) or no earlier (or later) than or starting from (1) the ending (or starting) symbol/slot of a corresponding current serving beam RS/RS resource or (2) the ending (or starting) symbol/slot of one or more corresponding candidate/new beam RSs/RS resources in the resource set according to or based on: (i) fixed rule(s) in system specification(s) and/or per RRC (re-)configuration, e.g., which of (1) or (2) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, or the UE could determine or identify that the starting symbol/slot of an event evaluation (instance) could be at least (or at most) X symbol(s)/slot(s) after (or before) or no earlier (or later) than or starting from (a) the first symbol/slot after (or before) the ending (or starting) symbol/slot of the corresponding current serving beam RS/RS resource or (b) the first symbol/slot after (or before) the ending (or starting) symbol/slot of the corresponding candidate/new beam RS(s)/RS resource(s) in the resource set according to or based on: (i) fixed rule(s) in system specification(s) and/or per RRC (re-)configuration, e.g., which of (a) or (b) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(G): the UE could identify or determine event evaluation instances (and therefore, carry out or perform or conduct the corresponding operation(s) according to or following those specified herein in the present disclosure) for determining Event-1 instance(s) based on or according to a/the periodicity of the event evaluation instance(s). In this case, the UE could autonomously determine or decide or choose or select or identify timing relation(s) between (1) the event evaluation instance(s) and (2) the corresponding current serving beam RS(s)/RS resource(s) and/or candidate/new beam RS(s)/RS resource(s), e.g., by the UE's implementation.
   The UE could identify or determine event evaluation instances (and therefore, carry out or perform or conduct the corresponding operation(s) according to or following those specified herein in the present disclosure) for determining Event-1 instance(s) based on or according to one or more of (A), (B), (C), (D), (E), (F) and (G) based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. A conceptual example characterizing the aforementioned timing relations between/of the current serving beam RS(s)/RS resource(s), candidate/new beam RS(s)/RS resource(s) and event evaluation(s)/event evaluation instance(s) is presented in FIG. 7.
   In another example, the UE could determine or identify or expect or assume a/the same periodicity between the current serving beam RS(s)/RS resource(s) and the candidate/new beam RS(s)/RS resource(s) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could also be the same/identical. In this case, periodicity of candidate event evaluation(s) or candidate event evaluation instance(s) for determining Event-1 instance(s) could be different from the periodicity of the current serving beam RS(s)/RS resource(s) or the candidate/new beam RS(s)/RS resource(s), wherein when/if a candidate event evaluation instance is determined or identified as an event evaluation instance, the UE could conduct, perform or carry out the corresponding event evaluation(s) procedure(s) for/within the candidate event evaluation instance according to or following those specified herein in the present disclosure for determining Event-1 instance(s); otherwise, the UE would not conduct, perform or carry out any event evaluation(s) procedure(s) for/within the candidate event evaluation instance according to or following those specified herein in the present disclosure for determining Event-1 instance(s). For example, the periodicity of the candidate event evaluation(s) or event evaluation instance(s) could be smaller than (e.g., I/N times of) the periodicity of the current serving beam RS(s)/RS resource(s) or the candidate/new beam RS(s)/RS resource(s), wherein N>1. For another example, the periodicity of the candidate event evaluation(s) or event evaluation instance(s) could be greater than (e.g., N times of) the periodicity of the current serving beam RS(s)/RS resource(s) or the candidate/new beam RS(s)/RS resource(s), wherein N>1. The UE could determine or identify the periodicity of the candidate event evaluation instance(s) and/or the value of N according to or based on: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, an event evaluation (instance)—i.e., out of the candidate event evaluation instance(s)—for determining Event-1 instance(s) could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d.
(H): the UE could identify or determine event evaluation instances (and therefore, carry out or perform or conduct the corresponding operation(s) according to or following those specified herein in the present disclosure)—out of the candidate event evaluation instance(s)—for determining Event-1 instance(s) based on or according to a/the periodicity of the candidate event evaluation instance(s), their timing relations with respect to the corresponding current serving beam RS(s)/RS resource(s)—e.g., the starting symbol/slot of an event evaluation (instance)—e.g., out of the candidate event evaluation instance(s)—could be at least (or at most) X symbol(s)/slot(s) after (or before) or no earlier (or later) than or starting from the ending (or starting) symbol/slot of a corresponding current serving beam RS/RS resource or the first symbol/slot after (or before) the ending (or starting) symbol/slot of the corresponding current serving beam RS/RS resource, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance)—e.g., out of the candidate event evaluation instance(s)—could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to the candidate/new beam RS(s)/RS resource(s) in the corresponding resource set—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(I): the UE could identify or determine event evaluation instances (and therefore, carry out or perform or conduct the corresponding operation(s) according to or following those specified herein in the present disclosure)—out of the candidate event evaluation instance(s)—for determining Event-1 instance(s) based on or according to a/the periodicity of the candidate event evaluation instance(s), their timing relations with respect to the corresponding candidate/new beam RS(s)/RS resource(s)—e.g., the starting symbol/slot of an event evaluation (instance)—e.g., out of the candidate event evaluation instance(s)—could be at least (or at most) X symbol(s)/slot(s) after (or before) or no earlier (or later) than or starting from the ending (or starting) symbol/slot of one or more corresponding candidate/new beam RSs/RS resources in the resource set or the first symbol/slot after (or before) the ending (or starting) symbol/slot of the corresponding candidate/new beam RS(s)/RS resource(s) in the resource set, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance)—e.g., out of the candidate event evaluation instance(s)—could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to a current beam RS/RS resource—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(J): when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, the UE could identify or determine event evaluation instances (and therefore, carry out or perform or conduct the corresponding operation(s) according to or following those specified herein in the present disclosure)—out of the candidate event evaluation instance(s)—for determining Event-1 instance(s) based on or according to a/the periodicity of the candidate event evaluation instance(s), their timing relations with respect to the corresponding current serving beam RS(s)/RS resource(s) and/or candidate/new beam RS(s)/RS resource(s)—e.g., the UE could determine or identify that the starting symbol/slot of an event evaluation (instance)—e.g., out of the candidate event evaluation instance(s)—could be at least (or at most) X symbol(s)/slot(s) after (or before) or no earlier (or later) than or starting from (1) the ending (or starting) symbol/slot of a corresponding current serving beam RS/RS resource or (2) the ending (or starting) symbol/slot of one or more corresponding candidate/new beam RSs/RS resources in the resource set according to or based on: (i) fixed rule(s) in system specification(s) and/or per RRC (re-)configuration, e.g., which of (1) or (2) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, or the UE could determine or identify that the starting symbol/slot of an event evaluation (instance)—e.g., out of the candidate event evaluation instance(s)—could be at least (or at most) X symbol(s)/slot(s) after (or before) or no earlier (or later) than or starting from (a) the first symbol/slot after (or before) the ending (or starting) symbol/slot of the corresponding current serving beam RS/RS resource or (b) the first symbol/slot after (or before) the ending (or starting) symbol/slot of the corresponding candidate/new beam RS(s)/RS resource(s) in the resource set according to or based on: (i) fixed rule(s) in system specification(s) and/or per RRC (re-)configuration, e.g., which of (a) or (b) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; in this case, the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance)—e.g., out of the candidate event evaluation instance(s)—could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(K): the UE could identify or determine event evaluation instances (and therefore, carry out or perform or conduct the corresponding operation(s) according to or following those specified herein in the present disclosure)—i.e., out of the candidate event evaluation instances—for determining Event-1 instance(s) based on or according to a/the periodicity of the candidate event evaluation instance(s), and/or their timing relations with respect to a measurement occasion (MO)—e.g., the starting symbol/slot of an event evaluation (instance)—e.g., out of the candidate event evaluation instance(s)—could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(L): the UE could identify or determine event evaluation instances (and therefore, carry out or perform or conduct the corresponding operation(s) according to or following those specified herein in the present disclosure)—i.e., out of the candidate event evaluation instances—for determining Event-1 instance(s) based on or according to a/the periodicity of the candidate event evaluation instance(s), and/or their timing relations with respect to a measurement occasion (MO)—e.g., the starting symbol/slot of an event evaluation (instance)—e.g., out of the candidate event evaluation instance(s)—could be at least (or at most) X symbol(s)/slot(s) after (or before) or no earlier (or later) than or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of X according to or based on: fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(M): the UE could identify or determine event evaluation instances (and therefore, carry out or perform or conduct the corresponding operation(s) according to or following those specified herein in the present disclosure)—i.e., out of the candidate event evaluation instances—for determining Event-1 instance(s) based on or according to a/the periodicity of the candidate event evaluation instance(s). In this case, the UE could autonomously determine or decide or choose or select or identify timing relation(s) between (1) the event evaluation instance(s) and (2) the corresponding current serving beam RS(s)/RS resource(s) and/or candidate/new beam RS(s)/RS resource(s), e.g., by/according to/based on the UE's implementation. In this case, each of the candidate event evaluation instances could correspond to an event evaluation instance as specified/defined herein in the present disclosure, or equivalently, the UE could determine or identify each of the candidate event evaluation instances as an event evaluation instance as specified/defined herein in the present disclosure, within which the UE could carry out or perform or conduct the corresponding event evaluation operation(s) for determining Event-1 instance(s) according to or following those specified herein in the present disclosure.

The UE could identify or determine event evaluation instances (and therefore, carry out or perform or conduct the corresponding operation(s) according to or following those specified herein in the present disclosure) for determining Event-1 instance(s) based on or according to one or more of (H), (I), (J), (K) and (L) based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. A conceptual example characterizing the aforementioned timing relations between/of the current serving beam RS(s)/RS resource(s), candidate/new beam RS(s)/RS resource(s) and event evaluation(s)/event evaluation instance(s) is presented in FIG. 8.
In another example, the UE could determine or identify or expect or assume a/the same periodicity between the current serving beam RS(s)/RS resource(s) and the candidate/new beam RS(s)/RS resource(s) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could also be the same/identical. For this design example, an event evaluation (instance) for determining an Event-1 instance could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d.
(N): the UE could identify or determine event evaluation instances (and therefore, carry out or perform or conduct the corresponding operation(s) according to or following those specified herein in the present disclosure) for determining Event-1 instance(s) based on or according to their timing relations with respect to the corresponding current serving beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of a corresponding current serving beam RS/RS resource or the first symbol/slot after (or before) the ending (or starting) symbol/slot of the corresponding current serving beam RS/RS resource, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance) could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to the candidate/new beam RS(s)/RS resource(s) in the corresponding resource set—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(O): the UE could identify or determine event evaluation instances (and therefore, carry out or perform or conduct the corresponding operation(s) according to or following those specified herein in the present disclosure) for determining Event-1 instance(s) based on or according to their timing relations with respect to the corresponding candidate/new beam RS(s)/RS resource(s)—e.g., the starting symbol/slot of an event evaluation (instance) could be at least (or at most) X symbol(s)/slot(s) after (or before) or no earlier (or later) than or starting from the ending (or starting) symbol/slot of one or more corresponding candidate/new beam RSs/RS resources in the resource set or the first symbol/slot after (or before) the ending (or starting) symbol/slot of the corresponding candidate/new beam RS(s)/RS resource(s) in the resource set, wherein the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance) could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s)—in this case, a MO could be referred to as the MO that comprises or corresponds to a current beam RS/RS resource—and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling.
(P): when/if a/the (lowest/smallest) time offset (e.g., higher layer configured/provided by the network subject to a corresponding UE's capability or capability signaling) between the current serving beam RS(s)/RS resource(s) and the candidate/new beam RS(s)/RS resource(s) in the corresponding resource set is zero, the UE could identify or determine event evaluation instances (and therefore, carry out or perform or conduct the corresponding operation(s) according to or following those specified herein in the present disclosure) for determining Event-1 instance(s) based on or according to their timing relations with respect to the corresponding current serving beam RS(s)/RS resource(s) and/or candidate/new beam RS(s)/RS resource(s)—e.g., the UE could determine or identify that the starting symbol/slot of an event evaluation (instance) could be at least (or at most) X symbol(s)/slot(s) after (or before) or no earlier (or later) than or starting from (1) the ending (or starting) symbol/slot of a corresponding current serving beam RS/RS resource or (2) the ending (or starting) symbol/slot of one or more corresponding candidate/new beam RSs/RS resources in the resource set according to or based on: (i) fixed rule(s) in system specification(s) and/or per RRC (re-)configuration, e.g., which of (1) or (2) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, or the UE (e.g., the UE 116) could determine or identify that the starting symbol/slot of an event evaluation (instance) could be at least (or at most) X symbol(s)/slot(s) after (or before) or no earlier (or later) than or starting from (a) the first symbol/slot after (or before) the ending (or starting) symbol/slot of the corresponding current serving beam RS/RS resource or (b) the first symbol/slot after (or before) the ending (or starting) symbol/slot of the corresponding candidate/new beam RS(s)/RS resource(s) in the resource set according to or based on: (i) fixed rule(s) in system specification(s) and/or per RRC (re-)configuration, e.g., which of (a) or (b) that ends earlier (or later) in time, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; in this case, the UE could determine or identify the value of the time gap X symbol(s)/slot(s) according to or based on: (i) fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or their timing relations with respect to a measurement occasion (MO)—e.g., the starting symbol/slot of an event evaluation (instance) could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(Q): the UE could identify or determine event evaluation instances (and therefore, carry out or perform or conduct the corresponding operation(s) according to or following those specified herein in the present disclosure) for determining Event-1 instance(s) based on or according to their timing relations with respect to a measurement occasion (MO)—e.g., the starting symbol/slot of an event evaluation (instance) could be at least Y symbol(s)/slot(s) before or prior to or earlier than a reference time instance e.g. a symbol/slot that is at least Z symbol(s)/slot(s) after (or before) or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of Y and/or Z according to or based on: fixed value(s) in system specification(s) and/or per RRC (re-)configuration, e.g., Y=0, 1, 2, . . . , and/or Z=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(R): the UE could identify or determine event evaluation instances (and therefore, carry out or perform or conduct the corresponding operation(s) according to or following those specified herein in the present disclosure) for determining Event-1 instance(s) based on or according to their timing relations with respect to a measurement occasion (MO)—e.g., the starting symbol/slot of an event evaluation (instance) could be at least (or at most) X symbol(s)/slot(s) after (or before) or no earlier (or later) than or starting from the ending (or starting) symbol/slot of a corresponding MO or the first symbol/slot after (or before) the ending (or starting) symbol/slot of the corresponding MO, wherein a MO could comprise or correspond to a current serving beam RS/RS resource and/or candidate/new beam RS(s)/RS resource(s) and the UE could determine or identify the value(s) of X according to or based on: fixed value(s) in system specification(s) and/or per RRC (re-)configuration, e.g., X=0, 1, 2, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The UE could identify or determine event evaluation instances (and therefore, carry out or perform or conduct the corresponding operation(s) according to or following those specified herein in the present disclosure) for determining Event-1 instance(s) based on or according to one or more of (N), (O), (P), (Q) and (R) based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. A conceptual example characterizing the aforementioned timing relations between/of the current serving beam RS(s)/RS resource(s), candidate/new beam RS(s)/RS resource(s) and event evaluation(s)/event evaluation instance(s) is presented in FIG. 9.
In another example, the UE could determine or identify or expect or assume different periodicities between the current serving beam RS(s)/RS resource(s) and the candidate/new beam RS(s)/RS resource(s) such that the UE could determine or identify a first periodicity for/of the current beam RS(s)/RS resource(s) and/or a second periodicity of/for the candidate/new beam RS(s)/RS resource(s) in the corresponding resource set (i.e., the first periodicity is different from the second periodicity) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could be the same/identical. The UE could determine or identify periodicity of (candidate) event evaluation(s) or (candidate) event evaluation instance(s)—denoted by a reference periodicity—as or according to or same as/identical to one or more of:
   The periodicity of the current serving beam RS(s)/RS resource(s)—denoted by a first periodicity
   The periodicity of the candidate/new beam RS(s)/RS resource(s)—denoted by a second periodicity
   min{the first periodicity, the second periodicity}
   max{the first periodicity, the second periodicity}
   max{x ms, min{the first periodicity, the second periodicity}}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   Fixed value(s)/rule(s) in system specification(s) and/or per RRC (re-)configuration
   Network's configuration(s)/indication(s) via higher layer RRC signaling(s)/parameter(s) and/or MAC CE command(s) and/or dynamic DCI based L1 signaling(s) according to or based on a corresponding UE's capability or capability signaling
   UE's autonomous determination/selection, which could be further sent to the network via various UL channels/signals and/or in part of a CSI/beam report and/or UE's capability signaling

For this design example, an event evaluation (instance) for determining an Event-1 instance could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d. Furthermore, the UE could identify or determine event evaluation instances (and therefore, carry out or perform or conduct the corresponding operation(s) according to or following those specified herein in the present disclosure) for determining Event-1 instance(s) according to or based on the periodicity of the (candidate) event evaluation instance(s), their timing relations with respect to the corresponding current serving beam RS(s)/RS resource(s), and/or their timing relations with respect to the corresponding candidate/new beam RS(s)/RS resource(s) in the resource set, and/or their timing relations with respect to MO(s) with each MO comprising or corresponding to a current serving beam RS/RS resource and/or candidate/new beam RS(s)/RS resource(s), according to or following those specified herein in the present disclosure—e.g., following or according to one or more examples described herein.
In another example, the UE could determine or identify or expect or assume different periodicities between the current serving beam RS(s)/RS resource(s) and the candidate/new beam RS(s)/RS resource(s) such that the UE could determine or identify a first periodicity for/of the current beam RS(s)/RS resource(s) and/or a second periodicity of/for the candidate/new beam RS(s)/RS resource(s) in the corresponding resource set (i.e., the first periodicity is different from the second periodicity) according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could be the same/identical. For this design example, an event evaluation (instance) for determining an Event-1 instance could comprise or correspond to a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or candidate/new beam RS(s)/RS resource(s) in the corresponding resource set, wherein the UE could determine or identify the timing relations between the current serving beam RS/RS resource and the candidate/new beam RS(s)/RS resource(s) in the corresponding resource set according to or following those specified/defined in one or more of Case-a, Case-b, Case-c and Case-d. Furthermore, the UE could identify or determine event evaluation instances (and therefore, carry out or perform or conduct the corresponding operation(s) according to or following those specified herein in the present disclosure) for determining Event-1 instance(s) according to or based on their timing relations with respect to the corresponding current serving beam RS(s)/RS resource(s), and/or their timing relations with respect to the corresponding candidate/new beam RS(s)/RS resource(s) in the resource set, and/or their timing relations with respect to MO(s) with each MO comprising or corresponding to a current serving beam RS/RS resource and/or candidate/new beam RS(s)/RS resource(s), according to or following those specified herein in the present disclosure—e.g., following or according to one or more examples described herein.
For evaluating, assessing or determining Event-2 or Event-2 instance(s) and/or when/if Event-2 as defined/specified herein in the present disclosure is enabled or provided or configured for the UEI beam reporting, the UE could determine or identify event evaluation(s) or event evaluation instance(s) or time interval(s) between event evaluations/evaluation instances or an event evaluation periodicity or a periodicity of event evaluation for determining Event-2 instance(s) as specified/defined herein in the present disclosure according to or following those specified/defined herein in the present disclosure—e.g., following or according to those specified in one or more examples described herein for determining or identifying event evaluation(s) or event evaluation instance(s) or time interval(s) between event evaluations/evaluation instances or an event evaluation periodicity or a periodicity of event evaluation for determining Event-1 instance(s). The measurement RS(s)/RS resource(s) of current serving beam RS(s)/RS resource(s) and/or candidate/new beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-1 instance(s) as specified/described one or more examples described herein can be replaced by/with measurement RS(s)/RS resource(s) of only current serving beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-2 instance(s). That is, means of determining or identifying event evaluation(s) or event evaluation instance(s) or time interval(s) between event evaluations/evaluation instances or an event evaluation periodicity or a periodicity of event evaluation for determining Event-1 instance(s) can be extended/applied to determine or identify event evaluation(s) or event evaluation instance(s) or time interval(s) between event evaluations/evaluation instances or an event evaluation periodicity or a periodicity of event evaluation for determining Event-2 instance(s) by taking into account, updating or modifying a MO in one or more examples described herein that comprises or corresponds to current beam RS(s)/RS resource(s) and/or candidate/new beam RS(s)/RS resource(s) in the corresponding resource set to comprise or correspond to only the current serving beam RS(s)/RS resource(s). For evaluating, assessing or determining Event-3 or Event-3 instance(s) and/or when/if Event-3 as defined/specified herein in the present disclosure is enabled or provided or configured for the UEI beam reporting, the UE could determine or identify event evaluation(s) or event evaluation instance(s) or time interval(s) between event evaluations/evaluation instances or an event evaluation periodicity or a periodicity of event evaluation for determining Event-3 instance(s) as specified/defined herein in the present disclosure according to or following those specified/defined herein in the present disclosure—e.g., following or according to those specified in one or more examples described herein for determining or identifying event evaluation(s) or event evaluation instance(s) or time interval(s) between event evaluations/evaluation instances or an event evaluation periodicity or a periodicity of event evaluation for determining Event-1 instance(s).
   In one example, the periodicity of the activation beam RS(s)/RS resource(s) in the corresponding activated TCI state(s), e.g., indicated/provided by/in a (unified) TCI state(s) activation/deactivation MAC CE, could be the same/identical. For this design example, the UE could determine or identify or assume or expect
      a/the same periodicity between the candidate/new beam RS(s)/RS resource(s) in the corresponding resource set and the activation beam RS(s)/RS resource(s) in the corresponding activated TCI state(s), or
      different periodicities between the candidate/new beam RS(s)/RS resource(s) in the corresponding resource set and the activation beam RS(s)/RS resource(s) in the corresponding activated TCI state(s) such that the UE could determine or identify a first periodicity for/of the candidate/new beam RS(s)/RS resource(s) and/or a second periodicity of/for the activation beam RS(s)/RS resource(s) (i.e., the first periodicity is different from the second periodicity)
   according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could also be the same/identical.
   In another example, each of the activation beam RS(s)/RS resource(s) in the corresponding activated TCI state(s), e.g., indicated/provided by/in a (unified) TCI state(s) activation/deactivation MAC CE, could have a different periodicity (e.g., from other activate beam RS(s)/RS resource(s)). For this design example, the UE could determine or identify or assume or expect
      a/the same periodicity between the candidate/new beam RS(s)/RS resource(s) in the corresponding resource set and the activation beam RS(s)/RS resource(s) in the corresponding activated TCI state(s) that has the shortest/smallest periodicity among the activation beam RS(s)/RS resource(s) in the corresponding activated TCI state(s), e.g., indicated/provided by/in the (unified) TCI state(s) activation/deactivation MAC CE, or
      a/the same periodicity between the candidate/new beam RS(s)/RS resource(s) in the corresponding resource set and the activation beam RS(s)/RS resource(s) in the corresponding activated TCI state(s) that has the longest/largest periodicity among the activation beam RS(s)/RS resource(s) in the corresponding activated TCI state(s), e.g., indicated/provided by/in the (unified) TCI state(s) activation/deactivation MAC CE, or
      a/the same periodicity between the candidate/new beam RS(s)/RS resource(s) in the corresponding resource set and the q-th (e.g., with the q-th lowest/highest resource ID/index, the q-th earliest/latest in time/ordering/ordinal position among the activation beam RS(s)/RS resource(s), the q-th transmission/reception and/or etc.) activation beam RS(s)/RS resource(s) in the corresponding activated TCI state(s) among the activation beam RS(s)/RS resource(s) in the corresponding activated TCI state(s), e.g., indicated/provided by/in the (unified) TCI state(s) activation/deactivation MAC CE, or
      a/the same periodicity between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among the activated TCI state(s) and/or etc.) activated TCI state(s) among the activated TCI state(s), e.g., indicated/provided by/in the (unified) TCI state(s) activation/deactivation MAC CE, or
      different periodicities between the candidate/new beam RS(s)/RS resource(s) in the corresponding resource set and the activation beam RS(s)/RS resource(s) in the corresponding activated TCI state(s) that has the shortest/smallest periodicity among the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the shortest/smallest periodicity for/of the activation beam RS(s)/RS resource(s) among the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
      different periodicities between the candidate/new beam RS(s)/RS resource(s) in the corresponding resource set and the activation beam RS(s)/RS resource(s) in the corresponding activated TCI state(s) that has the longest/largest periodicity among the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the longest/largest periodicity for/of the activation beam RS(s)/RS resource(s) among the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
      different periodicities between the candidate/new beam RS(s)/RS resource(s) in the corresponding resource set and the q-th (e.g., with the q-th lowest/highest resource ID/index, the q-th earliest/latest in time/ordering/ordinal position among the activation beam RS(s)/RS resource(s), the q-th transmission/reception and/or etc.) activation beam RS(s)/RS resource(s) in the corresponding activated TCI state(s) among the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity for/of the q-th activation beam RS(s)/RS resource(s) among the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
      different periodicities between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among the activated TCI state(s) and/or etc.) activated TCI state(s) among the activated TCI state(s), e.g., indicated/provided by/in the (unified) TCI state(s) activation/deactivation MAC CE such that such that the UE could determine or identify a first periodicity for/of the candidate/new beam RS(s)/RS resource(s) in the corresponding resource set and/or a second periodicity for/of the activation beam RS(s)/RS resource(s) in the q-th activated TCI state(s) among the activated TCI state(s), e.g., indicated/provided by/in the (unified) TCI state(s) activation/deactivation MAC CE (i.e., the first periodicity is different from the second periodicity)
   according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could be the same/identical. The UE could determine or identify the value of q (if any) according to or based on: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   In another example, one or more of the activation beam RS(s)/RS resource(s) in the corresponding activated TCI state(s), e.g., indicated/provided by/in a (unified) TCI state(s) activation/deactivation MAC CE, could have a same/identical periodicity, and one or more of the activation beam RS(s)/RS resource(s) in the corresponding activated TCI state(s), e.g., indicated/provided by/in the (unified) TCI state(s) activation/deactivation MAC CE, could have different periodicities from each other. For this design example, the UE could determine or identify or assume or expect
      a/the same periodicity between the candidate/new beam RS(s)/RS resource(s) in the corresponding resource set and the activation beam RS(s)/RS resource(s) in the corresponding activated TCI state(s) that has the shortest/smallest periodicity among the activation beam RS(s)/RS resource(s) in the corresponding activated TCI state(s), e.g., indicated/provided by/in the (unified) TCI state(s) activation/deactivation MAC CE, or
      a/the same periodicity between the candidate/new beam RS(s)/RS resource(s) in the corresponding resource set and the activation beam RS(s)/RS resource(s) in the corresponding activated TCI state(s) that has the longest/largest periodicity among the activation beam RS(s)/RS resource(s) in the corresponding activated TCI state(s), e.g., indicated/provided by/in the (unified) TCI state(s) activation/deactivation MAC CE, or
      a/the same periodicity between the candidate/new beam RS(s)/RS resource(s) in the corresponding resource set and the q-th (e.g., with the q-th lowest/highest resource ID/index, the q-th earliest/latest in time/ordering/ordinal position among the activation beam RS(s)/RS resource(s), the q-th transmission/reception and/or etc.) activation beam RS(s)/RS resource(s) in the corresponding activated TCI state(s) among the activation beam RS(s)/RS resource(s) in the corresponding activated TCI state(s), e.g., indicated/provided by/in the (unified) TCI state(s) activation/deactivation MAC CE,
      a/the same periodicity between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among the activated TCI state(s) and/or etc.) activated TCI state(s) among the activated TCI state(s), e.g., indicated/provided by/in the (unified) TCI state(s) activation/deactivation MAC CE
      different periodicities between the candidate/new beam RS(s)/RS resource(s) in the corresponding resource set and the activation beam RS(s)/RS resource(s) in the corresponding activated TCI state(s) that has the shortest/smallest periodicity among the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the shortest/smallest periodicity for/of the activation beam RS(s)/RS resource(s) among the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
      different periodicities between the candidate/new beam RS(s)/RS resource(s) in the corresponding resource set and the activation beam RS(s)/RS resource(s) in the corresponding activated TCI state(s) that has the longest/largest periodicity among the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity corresponding to the longest/largest periodicity for/of the activation beam RS(s)/RS resource(s) among the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
      different periodicities between the candidate/new beam RS(s)/RS resource(s) in the corresponding resource set and the q-th (e.g., with the q-th lowest/highest resource ID/index, the q-th earliest/latest in time/ordering/ordinal position among the activation beam RS(s)/RS resource(s), the q-th transmission/reception and/or etc.) activation beam RS(s)/RS resource(s) in the corresponding activated TCI state(s) among the activation beam RS(s)/RS resource(s) in the corresponding activated TCI state(s), e.g., indicated/provided by/in the (unified) TCI state(s) activation/deactivation MAC CE such that the UE could determine or identify a first periodicity for/of the candidate/new beam RS(s)/RS resource(s) in the corresponding resource set and/or a second periodicity for/of the q-th activation beam RS(s)/RS resource(s) among the activation beam RS(s)/RS resource(s) in the corresponding activated TCI state(s), e.g., indicated/provided by/in the (unified) TCI state(s) activation/deactivation MAC CE (i.e., the first periodicity is different from the second periodicity), or
      different periodicities between the candidate/new beam RS(s)/RS resource(s) in the corresponding resource set and the activation beam RS(s)/RS resource(s) in the q-th (e.g., with the q-th lowest/highest TCI state ID/index, the q-th in ordering/ordinal position among the activated TCI state(s) and/or etc.) activated TCI state(s) among the activated TCI state(s), e.g., indicated/provided by/in the (unified) TCI state(s) activation/deactivation MAC CE such that such that the UE could determine or identify a first periodicity for/of the candidate/new beam RS(s)/RS resource(s) in the corresponding resource set and/or a second periodicity for/of the activation beam RS(s)/RS resource(s) in the q-th activated TCI state(s) among the activated TCI state(s), e.g., indicated/provided by/in the (unified) TCI state(s) activation/deactivation MAC CE (i.e., the first periodicity is different from the second periodicity)
   according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling; note here that the periodicity of the candidate/new beam RS(s)/RS resource(s) in the corresponding candidate/new beam RS(s)/RS resource(s) set could be the same/identical. The UE could determine or identify the value of q (if any) according to or based on: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The UE could determine or identify which one or more of the design examples, e.g., the one or more examples described herein, specified/described herein in the present disclosure to use or apply to determine or identify the timing relations between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE, based on or according to: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
For example, when/if the UE-initiated beam reporting is configured or enabled by the network, e.g., when/if a higher layer parameter ueInitiatedBeamReporting is provided or configured in higher layer parameter(s)/signaling(s) that provides or configures necessary information and/or setting(s) for the UE-initiated beam reporting and/or is set to ‘enabled’, and/or when/if the Event-3 is (higher layer) configured or enabled by the network, the UE could follow those specified one or more examples described herein to determine the timing relations between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE; otherwise, the UE could follow those specified in one or more examples described herein to determining the timing relations, and/or the UE could expect or assume that there is no timing restriction(s), between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE.
For another example, when/if the number of activated TCI state(s) provided/indicated in/by a/the (unified) TCI state(s) activation/deactivation MAC CE is smaller or lower than or equal to a threshold/number/quantity, the UE could follow those specified in one or more examples described herein to determine the timing relations between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE; otherwise, i.e., when/if the number of activated TCI state(s) provided/indicated in/by a/the (unified) TCI state(s) activation/deactivation MAC CE is larger or greater than or equal to the threshold/number/quantity the UE could follow one or more examples described herein to determining the timing relations, and/or the UE could expect or assume that there is no timing restriction(s), between the (periodicity of) candidate/new beam RS(s)/RS resource(s) in the corresponding resource set and the (periodicity(s) of) activation beam RS(s)/RS resource(s) in the corresponding activated TCI state(s), e.g., provided/indicated by/in a (unified) TCI state(s) activation/deactivation MAC CE, wherein the UE could identify or determine value(s) of the threshold/number/quantity based on or according to: (i) fixed value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

The UE could determine or identify a periodicity (if any) of the event evaluation(s) or event evaluation instance(s) for determining Event-3 instance(s) as one or more of:
Periodicity of the current (serving) beam RS(s)/RS resource(s)—denoted by a first periodicity
A reference periodicity of the activation beam RS(s)/RS resource(s) in the corresponding activated TCI state(s), e.g., provided/indicated in a (unified) TCI state(s) activation/deactivation MAC CE—denoted by a second periodicity
min{the first periodicity, the second periodicity}
max{the first periodicity, the second periodicity}
max{x ms, min{the first periodicity, the second periodicity}}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling based on or according to: (i) fixed rule(s)/value(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, wherein the UE could determine or identify the reference periodicity of the activation beam RS(s)/RS resource(s)—i.e., the second periodicity—as one or more of:
Periodicity of the activation beam RS(s)/RS resource(s), e.g., assuming that the periodicity of the activation beam RS(s)/RS resource(s), e.g., in the corresponding activated TCI state(s) provided/indicated in a/the (unified) TCI state(s) activation/deactivation MAC CE, could be the same/identical
the shortest/smallest periodicity among the activation beam RS(s)/RS resource(s) in the corresponding activated TCI state(s), e.g., indicated/provided by/in the (unified) TCI state(s) activation/deactivation MAC CE
the longest/largest periodicity among the activation beam RS(s)/RS resource(s) in the corresponding activated TCI state(s), e.g., indicated/provided by/in the (unified) TCI state(s) activation/deactivation MAC CE
For these design examples, an event evaluation (instance) for determining an Event-3 instance could comprise or correspond to a current serving beam RS/RS resource and/or activation beam RS(s)/RS resource(s) in the corresponding activated TCI state(s), e.g., provided/indicated in a/the (unified) TCI state(s) activation/deactivation MAC CE, wherein the UE could determine or identify the timing relations between the current serving beam RS/RS resource and the activation beam RS(s)/RS resource(s) according to or following those specified/defined in one or more of Case-a, Case-b, Case-c and Case-d; or equivalently, the UE could evaluate or assess, for/in an event evaluation or an event evaluation instance, radio link/beam qualities including L1-RSRPs/L1-SINRs of/for a current serving beam RS/RS resource and/or activation beam RS(s)/RS resource(s) in the corresponding activated TCI state(s) e.g. provided/indicated in a/the (unified) TCI state(s) activation/deactivation MAC CE, wherein the UE could determine or identify the timing relations between the current serving beam RS/RS resource and the corresponding activation beam RS(s)/RS resource(s) according to or following those specified/defined in one or more of Case-a, Case-b, Case-c and Case-d. The measurement RS(s)/RS resource(s) of current serving beam RS(s)/RS resource(s) and/or candidate/new beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-1 instance(s) as specified/described in one or more examples described herein can be replaced by/with measurement RS(s)/RS resource(s) of current serving beam RS(s)/RS resource(s) and/or activation beam RS(s)/RS resource(s) for determining or identifying event evaluation(s) or event evaluation instance(s) or time interval(s) between event evaluations/evaluation instances or an event evaluation periodicity or a periodicity of event evaluation for determining Event-3 instance(s). That is, means of determining or identifying event evaluation(s) or event evaluation instance(s) or time interval(s) between event evaluations/evaluation instances or an event evaluation periodicity or a periodicity of event evaluation for determining Event-1 instance(s) can be extended/applied to determine or identify event evaluation(s) or event evaluation instance(s) or time interval(s) between event evaluations/evaluation instances or an event evaluation periodicity or a periodicity of event evaluation for determining Event-3 instance(s) by taking into account, updating or modifying a MO in one or more examples described herein that comprises or corresponds to current beam RS(s)/RS resource(s) and/or candidate/new beam RS(s)/RS resource(s) in the corresponding resource set to comprise or correspond to the current serving beam RS(s)/RS resource(s) and/or activation beam RS(s)/RS resource(s).

Throughout the present disclosure, a starting symbol/slot could correspond to or could be equivalent to a first (or 1^{st}) symbol/slot (vice versa), an ending symbol/slot could correspond to or could be equivalent to a last symbol/slot (vice versa), a time offset could correspond to or could be equivalent to a time gap (vice versa). Furthermore, throughout the present disclosure, when/if a time offset between an event evaluation (instance) and one or more measurement RSs/RS resources (e.g., current serving beam RS(s)/RS resource(s), candidate/new beam RS(s)/RS resource(s) and/or activation beam RS(s)/RS resource(s)) is non-zero (e.g., greater than zero), the event evaluation (instance) and the one or more measurement RSs/RS resources would not overlap in time-domain.

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure, and/or upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms, etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfg. The network could configure a PUCCH-Resource of PUCCH-format0 or PUCCH-format1 or PUCCH-format3 or PUCCH-format4.
Step-2: after the UE has transmitted the PN message/trigger, the UE (e.g., the UE 116) could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including configured grant (CG) PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a physical resource block (PRB), a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=└log₂K┘. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=└log₂K┘. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type 1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a cell-radio network temporary identifier (C-RNTI), a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure, and/or upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms, etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure, and/or upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘I’ (or ‘0’) indicating acknowledgement (ACK) for the PN message/trigger and ‘0’ (or ‘I’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type 1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=└log₂K┘. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network (e.g., the network 130), e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=└log₂K┘. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 01, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE (e.g., the UE 116) could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/triggertransmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p 1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type 1 and/or Type2 is (pre-)configured by the network for transmitting or sending the UEI report content(s)/quantity(s) as defined or specified herein in the present disclosure, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network (e.g., the network 130) via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:

{Mode A}
{Mode B}
{Mode C}
{Mode A, Mode B}
{Mode A, Mode C}
{Mode B, Mode C}

According to or following those specified herein in the present disclosure,
For Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.
For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.
For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure.
   When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
   When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.

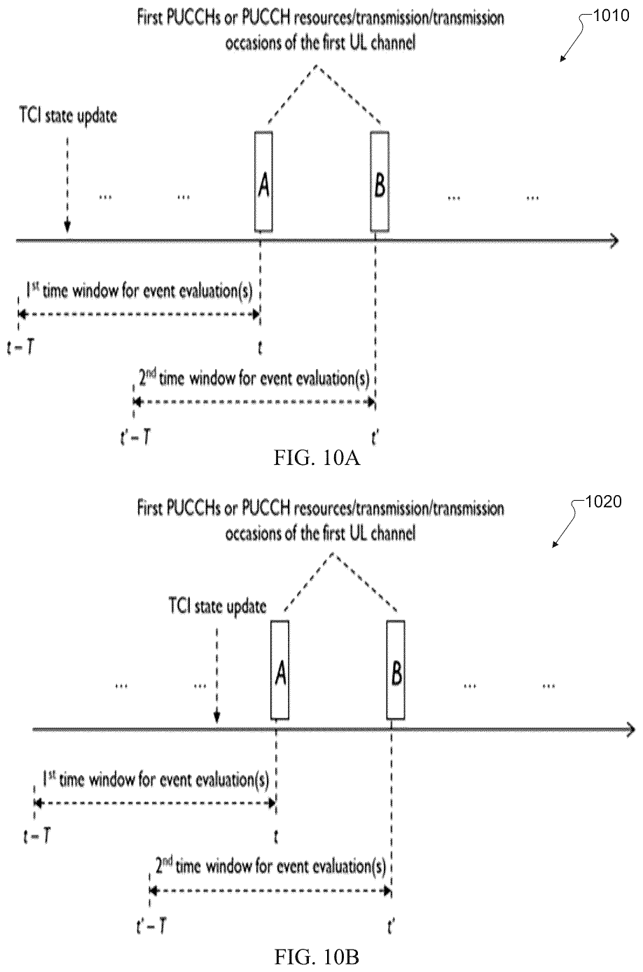

FIGS. 10A and 10B illustrate an example timeline 1010 and 1020 for time window determination according to embodiments of the present disclosure. For example, timeline 1010 and 1020 can be followed by the UE 116 of FIG. 3. This example is for illustration only and other embodiments can be used without departing from the scope of the present disclosure.

With reference to FIG. 10A, the TCI state update within the first time window PUCCH A is not transmitted. No TCI state update within the second time window, PUCCH B can be transmitted, if event conditions are satisfied. With reference to FIG. 10B, TCI state update within the first and second time windows, both PUCCH A and PUCCH B are not transmitted.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE (e.g., the UE 116) does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. One conceptual example of the described design example/procedure herein is presented in FIG. 10.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′+1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Furthermore, the reference beam RS or RS resource could be derived from an activated TCI state with the Q-th best beam quality e.g. L1-RSRP among the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
   the UE could transmit or trigger or initiate a transmission of the PN message/trigger over/on/via/in the PUCCH resource or transmission or transmission occasion of the first UL channel. Here, T′ could be less than or equal to T, and the time duration or length of the time window is (T−T′) or (T−T′−1) or (T+T′+1) symbol(s)/slot(s), which could be higher layer configured/provided by the network (e.g., the network 130) according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. Furthermore, the reference beam RS or RS resource could be derived from an activated TCI state with the Q-th best beam quality e.g. L1-RSRP among the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T−T_proc (e.g., in form of a slot or a symbol, i.e., slot or symbol t−T−T_proc or the (t−T−T_proc)-th slot or symbol) and ending at time t−T_proc is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, the time duration or length of the time window is T or T−1 or T+1 symbol(s)/slot(s), which could be higher layer configured/provided by the network according to or based on a corresponding UE's capability or capability signaling. Here, T_proc could be in slot, symbol, etc., which could represent processing time of PUCCH transmission(s) of the first UL channel including UCI bit(s) preparation and etc. The UE could determine or identify value(s) of T_proc according to or based on one or more of (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. When/if the UE could not determine or identify or declare an/the event within a first time window starting from time t−T−T_proc and ending at time t−T_proc according to or following those specified herein in the present disclosure: for example, when/if the UE could not identify or determine, within the first time window starting from time t−T−T_proc and ending at time t−T_proc, any candidate/new beam RS(s) or RS resource(s) that satisfies or achieves the event condition(s)—e.g., to satisfy the event condition(s) for a candidate/new beam RS or RS resource, the number/counting of event instance(s) within the first time window should be greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE does not receive a (unified) TCI state(s) activation/deactivation MAC CE within the first time window
The UE (e.g., the UE 116) does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE does not receive any form/format of a beam failure recover response (BFRR) within the first time window
The UE or higher layer(s) of the UE does not start (or starts) a prohibit timer as defined/specified herein in the present disclosure within the first time window, and/or the prohibit timer expires (or does not expire) within the first time window
For Mode-A/Mode-B, the UE does not receive a DCI in Step-2 in response to the transmission of the PN message/trigger in Step-1 within the first time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE does not receive triggering of aperiodic or semi-persistent CSI measurement and/or reporting (e.g., via a CSI request field in a triggering DCI) within the first time window
The UE does not receive activation of semi-persistent CSI measurement and/or reporting (e.g., via SP CSI measurement and/or reporting activation MAC CE(s)) within the first time window;
   and for another example, when/if one or more of the following conditions are achieved or satisfied:
The UE receives a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE receives a (unified) TCI state(s) activation/deactivation MAC CE within the first time window
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE receives a beam failure recover response (BFRR) within the first time window
The UE or higher layer(s) of the UE starts (or does not start) a prohibit timer as defined/specified herein in the present disclosure within the first time window, and/or the prohibit timer does not expire (or expires) within the first time window
For Mode-A/Mode-B, the UE receives a DCI in Step-2 in response to the transmission of the PN message/trigger in Step-1 within the first time window
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE receives triggering of aperiodic or semi-persistent CSI measurement and/or reporting (e.g., via a CSI request field in a triggering DCI) within the first time window
The UE receives activation of semi-persistent CSI measurement and/or reporting (e.g., via SP CSI measurement and/or reporting activation MAC CE(s)) within the first time window,
   the UE could determine or identify or declare an/the event when/if the number/counting of event instance(s) within a second time window starting from time t−T−T_proc−t_offset (e.g., in form of a slot or a symbol, i.e., slot or symbol t−T−T_proc−t_offset or the (t−T−T_proc−t_offset)-th slot or symbol) and ending at time t−T_proc−t_offset is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
      and/or when/if one or more of the following conditions are achieved or satisfied:
The UE does not receive a TCI state update within the second time window
The UE receives a TCI state update within the second time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the second time window
The UE does not receive a (unified) TCI state(s) activation/deactivation MAC CE within the second time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the second time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the second time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the second time window, wherein the UE could determine or identify the value of m according to or following those specified herein in the present disclosure
The UE does not receive any form/format of a beam failure recover response (BFRR) within the second time window
The UE or higher layer(s) of the UE does not start (or starts) a prohibit timer as defined/specified herein in the present disclosure within the second time window, and/or the prohibit timer expires (or does not expire) within the second time window
For Mode-A/Mode-B, the UE does not receive a DCI in Step-2 in response to the transmission of the PN message/trigger in Step-1 within the second time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the second time window
The UE does not receive triggering of aperiodic or semi-persistent CSI measurement and/or reporting (e.g., via a CSI request field in a triggering DCI) within the second time window
The UE does not receive activation of semi-persistent CSI measurement and/or reporting (e.g., via SP CSI measurement and/or reporting activation MAC CE(s)) within the second time window.

After the determination or identification or declaration of an/the event according to the second time window, the UE could transmit or trigger or initiate a transmission of the PN message/trigger over/on/via/in the PUCCH resource or transmission or transmission occasion of the first UL channel at time t. The UE could determine or identify value(s) of t_offset (e.g., in form/terms of symbol(s)/slot(s)/etc.) according to or based on: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. For example, candidate value(s) of t_offset could be {1, 2, . . . , 10, 20, 40, . . . } slot(s)/symbol(s)/ms/etc. For another example, t_offset could correspond to one or more of:
Periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
Periodicity of an event evaluation or event evaluation instance for determining an event instance according to or following those specified herein in the present disclosure
Periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). According to or following those specified herein in the present disclosure:
When/if the UE could determine or identify or declare an/the event within a k-th time window starting from time t−T−T_proc−k×t_offset and ending at time t−T_proc−k×t_offset according to or following those specified herein in the present disclosure, the UE could transmit or trigger or initiate a transmission of the PN message/trigger over/on/via/in the PUCCH resource or transmission or transmission occasion of the first UL channel at time t, and/or
When/if the UE could determine or identify or declare an/the event within a k-th time window starting from time t−T−T_proc−k×t_offset and ending at time t−T_proc−k×t_offset according to or following those specified herein in the present disclosure, the UE may not check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure, and/or
When/if the UE could not determine or identify or declare an/the event within a k-th time window starting from time t−T−T_proc−k×t_offset and ending at time t−T_proc−k×t_offset according to or following those specified herein in the present disclosure, the UE could further check or evaluate or assess whether the UE could determine or identify or declare an/the event within a (k+1)-th or (k−1)-th time window starting from time t−T−T_proc−(k+1)×t_offset and ending at time t−T_proc−(k+1)×t_offset according to or following those specified herein in the present disclosure.

In this case, k∈{0, . . . , Kmax}, wherein the UE could determine or identify value(s) of k and/or Kmax according to or based on: 1) fixed value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.
In one example, the starting time t−T−T_proc−(Kmax+1)×t_offset of the Kmax-th time window could be no earlier than t−2×T−T_proc, and/or the ending time t−T_proc−(Kmax+1)×t_offset of the Kmax-th time window could be no earlier than t−T−T_proc.
In another example, the ending time t−T_proc−(Kmax+1)×t_offset of the Kmax-th time window could be no earlier than t−T_pucch−T_proc, wherein T_pucch (e.g., in form/terms of symbol(s)/slot(s)/etc.) represents the periodicity of/for the PUCCH resource(s).

The (second) time window(s) here can also be referred to as sliding time window(s) with a time offset t_offset.

In another example, when/if a UE has determined or identified or declared an event instance wherein:
for Event-1, the event instance could be associated/specific to at least one (same) new/candidate beam RS/RS resource according to or following those specified herein in the present disclosure
for Event-2, the event instance could be associated/specific to the current beam RS/RS resource according to or following those specified herein in the present disclosure
for Event-3, the event instance could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
(higher layer(s) of) the UE could start a time window/timer;
according to or following those specified herein in the present disclosure, when/if (higher layer(s) of) the UE has determined or identified the aforementioned event instance before end of the time window and/or within the time window (e.g., before the last symbol/slot/etc. of the time window, wherein duration/length of the time window could be higher layer configured) and/or before the timer expires, (higher layer(s) of) the UE could increment an event instance count/counting for or of or specific to the new beam RS or RS resource by one;
before end of the time window and/or within the time window (e.g., before the last symbol/slot/etc. of the time window, wherein duration/length of the time window could be higher layer configured) and/or before the timer expires, when/if (higher layer(s) of) the UE has determined or identified that the number of the event instance(s) and/or the event instance count(s)/counting(s) is greater than or equal to maxCount (e.g., higher layer configured), (higher layer(s) of) the UE could determine or identify or declare a potential/candidate event occurrence.

For Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could first determine or identify a time duration starting from time t−T_du−T_proc (e.g., in form of a slot or a symbol, i.e., slot or symbol t−T_du−T_proc or the (t−T_du−T_proc)-th slot or symbol) and ending at time t−T_proc—e.g., the time duration here could be associated/specific/corresponding to the PUCCH resource or transmission or transmission occasion at time t. The UE (e.g., higher layer(s) of the UE) could determine or identify or declare an/the event when/if (higher layer(s) of) the UE could determine or identify or declare at least one potential/candidate event occurrence (or one or more potential/candidate event occurrences) according to or following those specified or described herein in the present disclosure within the aforementioned time duration associated/specific/corresponding to the PUCCH resource or transmission or transmission occasion at time t—for instance,
the start of the time window(s)/timer(s) used to determine or identify or declare the at least one (or the one or more) potential/candidate event occurrence(s) could be after or no earlier than the start of the time duration; and/or
the end of the time window(s) used to determine or identify or declare the at least one (or the one or more) potential/candidate event occurrence(s) could be before or no later than the end of the time duration, or the timer(s) used to determine or identify or declare the at least one (or the one or more) potential/candidate event occurrence(s) may not expire or may not be expired before or no later than the end of the time duration; and/or
the time window(s) used to determine or identify or declare the at least one (or the one or more) potential/candidate event occurrence(s) could be within the time duration
   and/or when/if one or more of the following conditions are achieved or satisfied:
The UE does not receive a TCI state update within the time duration
The UE receives a TCI state update within the time duration, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time duration
The UE does not receive a (unified) TCI state(s) activation/deactivation MAC CE within the time duration
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time duration
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time duration, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time duration, wherein the UE could determine or identify the value of m according to or following those specified herein in the present disclosure
The UE does not receive any form/format of a beam failure recover response (BFRR) within the time duration
The UE or higher layer(s) of the UE does not start (or starts) a prohibit timer as defined/specified herein in the present disclosure within the time duration, and/or the prohibit timer expires (or does not expire) within the time duration
For Mode-A/Mode-B, the UE does not receive a DCI in Step-2 in response to the transmission of the PN message/trigger in Step-1 within the time duration
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time duration
The UE does not receive triggering of aperiodic or semi-persistent CSI measurement and/or reporting (e.g., via a CSI request field in a triggering DCI) within the time duration
The UE does not receive activation of semi-persistent CSI measurement and/or reporting (e.g., via SP CSI measurement and/or reporting activation MAC CE(s)) within the time duration.

After the determination or identification or declaration of an/the event according to the time duration, the UE could transmit or trigger or initiate a transmission of the PN message/trigger over/on/via/in the PUCCH resource or transmission or transmission occasion of the first UL channel at time t. Here, the UE could determine or identify value(s) of the time duration and/or T_du according to or following: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
For example, T_du could correspond to or higher layer configured as T_pucch, wherein T_pucch represents the periodicity of the PUCCH resource(s)/transmission(s)/transmission occasion(s) of the first UL channel.
For another example, T_du could correspond to or higher layer configured as 0 or T_pucch or a value (e.g., in form/terms of number of symbol(s)/slot(s)/ms/etc.) in the range of [0, T_pucch], wherein T_pucch represents the periodicity of the PUCCH resource(s)/transmission(s)/transmission occasion(s) of the first UL channel.
For another example, T_du could correspond to or higher layer configured as the periodicity of an event evaluation or event evaluation instance for determining an event instance according to or following those specified herein in the present disclosure
For another example, T_du could correspond to or higher layer configured as the periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
For another example, T_du could correspond to or higher layer configured as min{periodicity of a first MO, periodicity of a second MO}
For another example, T_du could correspond to or higher layer configured as max{periodicity of a first MO, periodicity of a second MO}
For another example, T_du could correspond to or higher layer configured as max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Furthermore, according to or following those specified herein in the present disclosure, i.e., for the operation(s) in Mode-A, Mode-B and/or Mode-C as specified/defined herein in the present disclosure, the UE could send or transmit to the network beam report(s)—e.g., via/in/by the (CG/DG) PUSCH resource(s) of the second UL channel—associated/specific to the transmission or triggering or initiation of the transmission of the PN message/trigger over/on/via/in the PUCCH resource or transmission or transmission occasion of the first UL channel at time t. In this case, the UE could determine or identify report content(s)/quantity(s) including at least SSBRI(s)/CRI(s) and/or L1-RSRP(s)/L1-SINR(s) of the beam report(s) based on or according to at least the new/candidate beam RS(s)/RS resource(s) associated or specific or corresponding to the potential/candidate event occurrence(s) determined or identified or declared by (higher layer(s) of) the UE within the time duration specific/corresponding/associated to the PUCCH resource or transmission or transmission occasion of the first UL channel at time t. For this design example, the time window(s) associated/specific to the event instance(s) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure could correspond to or could be sliding time window(s) as specified/defined herein in the present disclosure.

Throughout the present disclosure, when/if (higher layer(s) of) the UE starts a time window/timer of or for or specific to a new/candidate beam RS/RS resource for determining or identifying or declaring event instance(s) according to or following those specified herein in the present disclosure,
In one example, before the end of the time window or before the timer expires, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may start another time window/timer of or for or specific to a/the same new/candidate beam RS/RS resource for determining or identifying or declaring event instance(s) according to or following those specified herein in the present disclosure no earlier than the end of the time window or the expiration of the timer.
In another example, after (higher layer(s)) of the UE has started the time window/timer, (higher layer(s) of) the UE could start a prohibit timer specific/corresponding/associated to the time window/timer. In this case, when/if the prohibit timer is running, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may not start another time window/timer of or for or specific to a/the same new/candidate beam RS/RS resource for determining or identifying or declaring event instance(s) according to or following those specified herein in the present disclosure before the expiration of the prohibit timer. The UE could determine or identify value(s)/duration(s)/length(s) of the prohibit timer (e.g., in slot(s)/symbol(s)/ms/etc.) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s).

Throughout the present disclosure, a time duration, a time window, a time offset, a time gap and/or etc. could be equivalent such that they can be used in an exchangeable manner.

Throughout the present disclosure, any time duration, time length, time window, time gap or time offset could be in form/terms of (number of) slot(s)/symbol(s) or milli-second, i.e., ms. Furthermore, throughout the present disclosure, within a time window/duration as specified/defined herein in the present disclosure, (higher layer(s) of) the UE could reset the counting of event instance(s), e.g., to zero, when/if one or more of the following conditions are achieved or satisfied:
The UE receives a TCI state update within the time window/duration
The UE receives a TCI state update within the time window/duration, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window/duration
The UE receives a (unified) TCI state(s) activation/deactivation MAC CE within the time window/duration
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window/duration
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window/duration, wherein the UE could determine or identify the value of m according to or following those specified herein in the present disclosure
The UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window/duration, wherein the UE could determine or identify the value of m according to or following those specified herein in the present disclosure
The UE receives a beam failure recover response (BFRR) within the time window/duration
The UE or higher layer(s) of the UE starts (or does not start) a prohibit timer as defined/specified herein in the present disclosure within the time window/duration, and/or the prohibit timer does not expire (or expires) within the time window/duration
For Mode-A/Mode-B, the UE receives a DCI in Step-2 in response to the transmission of the PN message/trigger in Step-1 within the time window/duration
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window/duration
The UE receives triggering of aperiodic or semi-persistent CSI measurement and/or reporting (e.g., via a CSI request field in a triggering DCI) within the time window/duration
The UE receives activation of semi-persistent CSI measurement and/or reporting (e.g., via SP CSI measurement and/or reporting activation MAC CE(s)) within the time window/duration,
   wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

For the described or specified design examples in the present disclosure, the UE could perform or conduct or carry out or do the aforementioned determination or identification or declaration of an/the event, and/or instance(s) of the aforementioned determination or identification or declaration of an/the event could be:
for each periodic PUCCH resource or transmission or transmission occasion of the first UL channel
based on or according to (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling
with a periodicity, wherein
   the periodicity could be the same as the periodicity of the PUCCH resource(s)/transmission(s)/transmission occasion(s) of the first UL channel
   the periodicity could be a fixed value in system specification(s) and/or per RRC (re-)configuration
   the periodicity could be determined by the UE and subject to a corresponding UE's capability/capability signaling
   the periodicity could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling
with a (minimum) time gap/offset between two adjacent or neighboring instances of determination or identification or declaration of an/the event, wherein
   the (minimum) time gap/offset could be the same as the periodicity of the PUCCH resource(s)/transmission(s)/transmission occasion(s) of the first UL channel
   the (minimum) time gap/offset could be a fixed value in system specification(s) and/or per RRC (re-)configuration
   the (minimum) time gap/offset could be determined by the UE and subject to a corresponding UE's capability/capability signaling
   the (minimum) time gap/offset could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling

For the described or specified design examples in the present disclosure, within the time window, when/if the UE
receives a TCI state update
receives a TCI state update, and the (measured) current beam RS/RS resource associated/specific to or determined/identified based on or according to the TCI state update or updated TCI state according to or following those specified herein in the present disclosure is updated/changed in contrast to or different from the previous one
receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
receives a (unified) TCI state(s) activation/deactivation MAC CE
receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure
receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
receives a beam failure recover response (BFRR)
starts (or does not start) a prohibit timer as defined/specified herein in the present disclosure, and/or the prohibit timer does not expire (or expires)
for Mode-A/Mode-B, receives a DCI in Step-2 in response to the transmission of the PN message/trigger in Step-1
receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
receives triggering of aperiodic or semi-persistent CSI measurement and/or reporting (e.g., via a CSI request field in a triggering DCI)
receives activation of semi-persistent CSI measurement and/or reporting (e.g., via SP CSI measurement and/or reporting activation MAC CE(s))
   the UE could reset the number/counting of the event instance(s) determined or identified or declared
within the corresponding time window
before the reception of the TCI state update
before the reception of the (unified) TCI state(s) activation/deactivation MAC CE
for Mode-A/Mode-B, before the reception of the DCI in Step-2 in response to the transmission of the PN message/trigger in Step-1
before the reception of the reconfiguration of new beam RS(s) or RS resource(s)
before the reception of the triggering of aperiodic or semi-persistent CSI measurement and/or reporting (e.g., via a CSI request field in a triggering DCI)
before the reception of the activation of semi-persistent CSI measurement and/or reporting (e.g., via SP CSI measurement and/or reporting activation MAC CE(s))
   to zero, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In one example, for one or more RSs or RS resources each corresponding to one or more of: (1) a (same) new/candidate beam RS/RS resource (e.g., for Event-1 or Event-3), (2) the current beam RS/RS resource (e.g., for Event-2), (3) (a pair of) a (same) new/candidate beam RS/RS resource and a (same) activation beam RS/RS resource (or equivalently, a (same) activated beam/TCI state)—e.g., for Event-3, the MAC entity of/for a UE (e.g., the UE 116) could or shall for each Serving Cell configured/enabled for UE-initiated/event-driven beam reporting according to those specified herein in the present disclosure:
1> to initiate or trigger a UEI/event-driven beam reporting based on or according to detection or declaration or determination of an event (e.g., Event-1, Event-2 and/or Event-3 in the present disclosure), e.g., to transmit or trigger or initiate a transmission of the PN message/trigger over/on/via/in the PUCCH resource or PUCCH transmission or PUCCH transmission occasion of the first UL channel in Mode A and/or Mode B and/or Mode C at time t:
   2> if an indication for an event instance (e.g., an Event-1 instance or an Event-2 instance or an Event-3 instance) associated/specific to the one or more RSs or RS resources determined or identified according to or following those specified herein in the present disclosure has been received from lower layers:
      3> start or restart an EventInstanceDetectionTimer (higher layer configured for the event—when/if applicable), e.g., associated/specific to the one or more RSs or RS resources;
      3> increment an EventInstanceCounter (higher layer configured for the event—when/if applicable), e.g., associated/specific to the one or more RSs or RS resources by 1;
      3> if EventInstanceCounter>=EventInstanceMaxCount (higher layer configured for the event—when/if applicable), identify or determine or detect or declare a first potential/candidate event occurrence, e.g., associated/specific to the one or more RSs or RS resources, according to or following those specified herein in the present disclosure:
         4> if the identification or determination or detection or declaration of the first potential/candidate event occurrence is within a time duration starting from time t−T_du−T_proc (e.g., in form of a slot or a symbol, i.e., slot or symbol t−T_du−T_proc or the (t−T_du−T_proc)-th slot or symbol) and ending at time t−T_proc—e.g., the time duration here could be associated/specific/corresponding to the PUCCH resource or transmission or transmission occasion of the first UL channel in Mode-A and/or Mode-B and/or Mode-C at time t, wherein T_du, T_proc and/or etc. could be determine or identified according to or following those specified herein in the present disclosure, and/or
         4> if there is no other potential/candidate event occurrence(s), e.g., associated/specific to the same one or more RSs or RS resources, identified or determined within the aforementioned time window starting from time t−T_du−T_proc (e.g., in form of a slot or a symbol, i.e., slot or symbol t−T_du−T_proc or the (t−T_du−T_proc)-th slot or symbol) and ending at time t−T_proc and later in time than the identification or determination or detection of the first potential/candidate event occurrence
         5> trigger or initiate a transmission of the PN message/trigger over/on/via/in the PUCCH resource or PUCCH transmission or PUCCH transmission occasion of the first UL channel at time t according to or based on (identification, determination, detection or declaration of) at least the first potential/candidate event occurrence, wherein the report content(s)/quantity(s) in the UEI beam report(s) could be determined or identified according to or based on (identification, determination, detection or declaration of) at least the first potential/candidate event occurrence (hence, the one or more RSs or RS resources associated/specific to the first potential/candidate event occurrence);
   2> if one or more of the following conditions are satisfied or achieved:
      the EventInstanceDetectionTimer, e.g., associated/specific to the one or more RSs or RS resources, expires
      the UE receives a TCI state update
      the UE receives a (unified) TCI state(s) activation/deactivation MAC CE
      the UE receives a (unified) TCI state(s) activation/deactivation MAC CE that activates or updates the activation beam RS(s)/RS resource(s), and therefore, the corresponding activated beam(s)/TCI state(s), used for determining or identifying the first candidate/potential event occurrence according to or following those specified herein in the present disclosure
      the UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command used for determining or identifying the first candidate/potential event occurrence according to or following those specified herein in the present disclosure, wherein the UE could determine or identify the value of m according to or following those specified herein in the present disclosure
      the UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure—used for determining or identifying the first candidate/potential event occurrence, wherein the UE could determine or identify the value of m according to or following those specified herein in the present disclosure
      the UE receives a beam failure recover response (BFRR)
      for Mode-A/Mode-B, the UE receives a DCI in Step-2 in response to the transmission of the PN message/trigger in Step-1
      the UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
      the UE receives reconfiguration/update/addition/removal/release (e.g., via/by/in upper layer(s) and/or RRC signaling(s) and/or MAC CE command(s) and/or dynamic DCI based L1 signaling(s)) of the one or more RSs or RS resources
      the UE receives triggering of aperiodic or semi-persistent CSI measurement and/or reporting (e.g., via a CSI request field in a triggering DCI)
      the UE receives activation of semi-persistent CSI measurement and/or reporting (e.g., via SP CSI measurement and/or reporting activation MAC CE(s))
      3> set EventInstanceCounter, e.g., associated/specific to the one or more RSs or RS resources, to 0.

The one or more RSs or RS resources could belong to or could be a subset of or one(s) of the RS(s) or RS resource(s) configured, provided, determined or identified for event evaluation(s) according to or following those specified/described herein in the present disclosure, wherein one or more of or each of the RS(s) or RS resource(s) configured, provided, determined or identified for event evaluation(s) could correspond to one or more of:
the current beam RS/RS resource
new/candidate beam RS(s)/RS resource(s) in the corresponding resource set
activation beam RS(s)/RS resource(s) in the corresponding activated TCI state(s), e.g., provided/indicated in a (unified) TCI state(s) activation/deactivation MAC CE
Pair(s) of new/candidate beam RS(s)/RS resource(s) in the corresponding resource set and activation beam RS(s)/RS resource(s) in the corresponding activated TCI state(s), e.g., provided/indicated in a (unified) TCI state(s) activation/deactivation MAC CE

According to or following those specified herein in the present disclosure, a UE or higher layer(s) of the UE could trigger or initiate a transmission of the PN message/trigger over/on/via/in the PUCCH resource or PUCCH transmission or PUCCH transmission occasion of the first UL channel in Mode A and/or Mode B and/or Mode C according to or based on (identification, determination, detection or declaration of) one or more potential/candidate event occurrences, wherein each of the one or more potential/candidate event occurrences could be associated/specific to different/separate (sets of) RSs or RS resources. In this case, the corresponding UEI/event-driven beam report(s)—e.g., carried or conveyed or transmitted or sent via PUSCH resource(s) of the second UL channel in Mode A and/or Mode B and/or Mode C associated/specific to the transmission of the PN message/trigger over/on/via/in the PUCCH resource or PUCCH transmission or PUCCH transmission occasion of the first UL channel in Mode A and/or Mode B and/or Mode C—could comprise or include or contain report content(s)/quantity(s) including resource indicator(s) such as SSBRI(s)/CRI(s) and beam metric(s) such as L1-RSRP(s)/L1-SINR(s) determined or identified according to or based on (identification, determination, detection or declaration of) the one or more potential/candidate event occurrences (hence, the RS(s) or RS resource(s) associated/specific to the potential/candidate event occurrence(s)). A UE or higher layer(s) of a UE could start a prohibit timer (duration, length and/or etc. of the prohibit timer and/or how/when the prohibit timer would expire could be higher layer configured)
after the last symbol/slot/etc. of transmitting a PN message/trigger on/over/in a PUCCH resource or a PUCCH transmission/transmission occasion of the first UL channel of Mode A and/or Mode B and/or Mode C, and/or
after the last symbol/slot/etc. of receiving the UL grant DCI in Step-2 of Mode A and/or Mode C, and/or
after the last symbol/slot/etc. of when the UL grant DCI received in Step-2 of Mode A and/or Mode C has become applicable, and/or
after the last symbol/slot/etc. of transmitting a beam report on/over/in (DG and/or CG e.g. Type1 CG) PUSCH resource(s) of the second UL channel of Mode A and/or Mode B and/or Mode C.

When a prohibit timer is running, the UE or higher layer(s) of the UE may not transmit any PN message(s)/trigger(s)/notification(s) on/over/in a PUCCH resource or a PUCCH transmission/transmission occasion of the first UL channel (e.g., in Mode A, Mode B and/or Mode C). That is, only when there is no prohibit timer running, the UE or higher layer(s) of the UE could transmit a PN message/trigger on/over/in a PUCCH resource or a PUCCH transmission/transmission occasion of the first UL channel (e.g., in Mode A, Mode B and/or Mode C). In addition, when/if a prohibit timer is running, and/or when/if the duration, length and/or etc. of the prohibit timer is less/smaller (or larger/greater) than or equal to a threshold,
in one example, the UE or higher layer(s) of the UE could continue performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE may not reset the number/counting of the event instance(s), e.g., to zero, and could continue/keep incrementing the number/counting of the (same) event instance(s) counted before the prohibit timer starts according to or following those specified herein in the present disclosure;
   for another example, when/if the UE or higher layer(s) of the UE starts the prohibit timer, the UE or higher layer(s) of the UE could or may reset the number/counting of the event instance(s), e.g., to zero;
   for another example, when/if or after the prohibit timer expires, the UE or higher layer(s) of the UE could or may reset the number/counting of the event instance(s), e.g., to zero;
in another example, the UE or higher layer(s) of the UE could stop performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE could or may reset the number/counting of the event instance(s), e.g., to zero;
   for another example, when/if the UE or higher layer(s) of the UE starts the prohibit timer, the UE or higher layer(s) of the UE may not reset the number/counting of the event instance(s), e.g., to zero, and when/if or after the prohibit timer expires, the UE or higher layer(s) of the UE could continue/keep incrementing the number/counting of the (same) event instance(s) counted before the prohibit timer starts according to or following those specified herein in the present disclosure

The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n times with n=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Otherwise, e.g., when/if a prohibit timer is running, and/or when/if the duration, length and/or etc. of the prohibit timer is larger/greater (or less/smaller) than or equal to the threshold specified herein in the present disclosure,
the UE or higher layer(s) of the UE could stop performing or conducting the event evaluation(s) including counting of the event instance(s) according to or following those specified herein in the present disclosure, and/or
when/if the UE or higher layer(s) of the UE starts the prohibit timer, the UE or higher layer(s) of the UE could or may reset the number/counting of the event instance(s), e.g., to zero, and/or
when/if or after the prohibit timer expires, the UE or higher layer(s) of the UE could or may reset the number/counting of the event instance(s), e.g., to zero, and/or
when/if or after the prohibit timer expires, the UE or higher layer(s) of the UE may not continue/keep incrementing the number/counting of the (same) event instance(s) counted before the prohibit timer starts according to or following those specified herein in the present disclosure.

Regarding the event instance(s) specified/discussed herein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.

In addition, UE could determine or identify the value of n according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, when/if a UE or higher layer(s) of a UE has determined or detected or declared an event and there is no prohibit timer running, the UE could transmit a PN message/trigger on/over/in/by a first PUCCH resource or a first PUCCH transmission/transmission occasion (of the first UL channel) at time t, wherein the UE could determine or identify association(s)/linkage(s)/correspondence(s)—e.g., in terms of their timing relations—between the determination or detection or declaration of the event and the first PUCCH resource or first PUCCH transmission or first PUCCH transmission occasion at time t according to or following those specified herein in the present disclosure. When/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′ to transmit a PN message/trigger based on the determination, detection or declaration of the event according to or following those specified herein in the present disclosure, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′.

Furthermore, delta_t=t′−t could be smaller/less (or larger/greater) than or equal to a threshold. The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n′ times with n′=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min{periodicity of a first MO, periodicity of a second MO}
max{periodicity of a first MO, periodicity of a second MO}
max{x ms, min{periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

Here, the first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). In addition, the UE could determine or identify the value of n′ according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Alternatively, when/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′. When/if delta_t=t′−t is greater/larger (or less/smaller) than or equal to the threshold specified herein in the present disclosure, the UE may not transmit a PN message/trigger on/over/in/by the second PUCCH resource or second PUCCH transmission/transmission occasion of the first UL channel at time t′ based on the determination, detection or declaration of the event according to or following those specified herein in the present disclosure, and/or
the UE may not transmit any PN message(s)/trigger(s) on/over/in/by any PUCCH resource(s) or any PUCCH transmission(s)/transmission occasion(s) of the first UL channel based on the determination, detection or declaration of the event according to or following those specified herein in the present disclosure.

According to or following those specified/defined herein in the present disclosure, for a UE configured with a CSI-ReportConfig with the higher layer parameter eventType-r19 e.g. set to ‘event1’, ‘event2’ etc., and dl-OrJointTCI-StateList or ul-TCI-StateList for periodic reference signals with the same periodicity, if during a time window for event evaluation(s), if provided, the L1-RSRP value determined for each transmission occasion of at least one same reference signal of the reference signals configured by the newBeamResourceSet-r19 (in a same CC of CSI-ReportConfig, or provided by carrier in the CSI-ReportConfig) is at least once, or eventInstanceCount-r19 times, an eventThreshold-r19 greater than the L1-RSRP of
the reference signal in the indicated TCI state in a same CC of CSI-ReportConfig if a/the RRC parameter cell or ServCellIndex or carrier is not provided, present or configured or is absent in the CSI-ReportConfig, or the CC indicated by a/the RRC parameter cell or ServCellIndex or carrier, if present, provided or configured, in the CSI-ReportConfig, if newBeamResourceSet-r19 is a NZP-CSI-RS-ResourceSet configured with repetition, else
the SS/PBCH block which is QCLed with the reference signal in the indicated TCI state in a same CC of CSI-ReportConfig if a/the RRC parameter cell or ServCellIndex or carrier is not provided, present or configured or is absent in the CSI-ReportConfig, or the CC indicated by a/the RRC parameter cell or ServCellIndex or carrier, if present, provided or configured, in the CSI-ReportConfig, if newBeamResourceSet-r19 is a CSI-SSB-ResourceSet,
   wherein the UE could be provided or configured by/in the CSI-ReportConfig information related to the time window for event evaluation(s) comprising one or more of:
a/the length for/of the time window provided by eventDetectionTimeWindowLength-r19
a/the starting symbol/slot for/of the time window provided by eventDetectionTimeWindowStartingSym-r19
a/the ending symbol/slot for/of the time window provided by eventDetectionTimeWindowEndingSym-r19
a/the periodicity of the time window provided by eventDetectionTimeWindowPeriodicity-r19
a/the offset (e.g. in time) of the time window provided by eventDetectionTimeWindowOffset-r19
a/the periodicity and offset (e.g. in time) of the time window provided by eventDetectionTimeWindow-periodicityAndOffset-r19,
   the UE could transmit PUCCH format 0 or format 1 in a PUCCH or PUCCH resource configured by firstPUCCHResourceConfg-UEIBR-r19 in the CSI-ReportConfig, and report in a single reporting instance nrojReportedRS-UEIBR-r19 CQI report intervals (CRIs) or SSBRIs and their absolute L1-RSRPs or differential L1-RSRPs corresponding to reference signals provided by the newBeamResourceSet-r19 that comprise at least one reference signal that satisfies the event, and, when enabledCurrentBeamReport-r19 is configured, the differential L1-RSRP corresponding to reference signal in the indicated TCI state, or to the SSB which is QCLed with the reference signal in the indicated TCI state:
on a PUSCH indicated by the DCI format 0_1/0_2 in a PDCCH reception after the end of the PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredResourceForSecondChannelOfModeB-r19 in the same CC as the corresponding CSI-ReportConfig which is the first available transmission occasion after the end of a target UL channel/resource if reportTransmissionMode-r19 is configured as ‘ModeB’, where the periodicity of the PUCCH resource and type 1 CG-PUSCH resource is the same, and the CG-PUSCH does not carry UL-SCH, and the first available transmission occasion could correspond to the first (available) transmission occasion numOjSymbols-ModeB-r19 symbols after the end of the target UL channel/resource that is not overlapping or colliding with one or more DL/UL channels/signals including e.g. dynamically scheduled PDSCH(s) and/or DG PUSCH(s)—for example, when/if a transmission occasion numOjSymbols-ModeB-r19 symbols after the end of the target UL channel/resource is overlapping or colliding with the one or more DL/UL channels/signals including e.g. dynamically scheduled PDSCH(s) and/or DG PUSCH(s), the transmission occasion cannot be determined or identified as the first available transmission occasion to carry or convey the UEI beam/CSI report and therefore the corresponding UEI report content(s)/quantity(s) as specified/defined herein in the present disclosure associated, corresponding or specific to the 1-bit indication carried or conveyed by the target UL channel/signal; optionally, when/if a transmission occasion numOfSymbols-ModeB-r19 symbols after the end of the target UL channel/resource is overlapping or colliding with the one or more DL/UL channels/signals including e.g. dynamically scheduled PDSCH(s) and/or DG PUSCH(s), the UE may still be able to determine or identify the transmission occasion (e.g., with transmission power prioritization) as the first available transmission occasion to carry or convey the UEI beam/CSI report and therefore the corresponding UEI report content(s)/quantity(s) as specified/defined herein in the present disclosure associated, corresponding or specific to the 1-bit indication carried or conveyed by the target UL channel/signal, wherein the target UL channel/resource can be (in form of) one of:
   case-1: the aforementioned PUCCH (resource) configured byfirstPUCCHResourceConfig-UEIBR-r19 in the CSI-ReportConfig
   case-2: a target PUSCH that is overlapping or colliding with the aforementioned PUCCH (resource) configured by frstPUCCHResourceConfig-UEIBR-r19 in the CSI-ReportConfig, wherein the target PUSCH can carry UL-SCH and/or hybrid automatic repeat request acknowledgement (HARQ-ACK) and/or CSI and/or UTO-UCI
wherein numOfSymbols-ModeB-r19 symbols are determined based on or according to the SCS of the target UL channel/resource or the SCS on the (active) BWP from the CC in/on which the target UL channel/resource is transmitted or sent according to or following those specified/defined herein in the present disclosure.

In the present disclosure, a first available transmission occasion corresponding, associated or specific to an UL channel/signal could correspond to the first transmission occasion numOfSymbols-ModeB-r19 symbols after the end of the UL channel/signal, e.g., not overlapping or colliding with other DL/UL channels/signals. Furthermore, according to or based on or following those specified or defined herein in the present disclosure,
if newBeamResourceSet-r19 is a NZP-CSI-RS-ResourceSet configured with repetition, the UE could determine or identify a/the CC in/on which the reference signal in the indicated TCI state is configured as or according or based on a/the CC indicated by a/the RRC parameter cell or ServCellIndex or carrier, if present, provided or configured, in a/the higher layer parameter QCL-Info in a/the higher layer parameter TCI-State that configures or provides the indicated TCI state, or a/the CC in/on which the indicated TCI state is configured/applied when/if a/the RRC parameter cell or ServCellIndex or carrier is not present, provided or configured or is absent in a/the higher layer parameter QCL-Info in a/the higher layer parameter TCI-State that configures or provides the indicated TCI state;
if newBeamResourceSet-r19 is a CSI-SSB-ResourceSet, the UE could determine or identify a/the CC in/on which the SS/PBCH block which is QCLed with the reference signal in the indicated TCI state is configured as or according or based on:
   a/the CC in/on which the reference signal in the indicated TCI state is configured according to or following those specified/defined herein in the present disclosure, and/or
   a/the CC indicated by a/the RRC parameter cell or ServCellIndex or carrier, if present, provided or configured, in a/the higher layer parameter QCL-Info in a/the higher layer parameter TCI-State that configures or provides a/the target TCI state that has, comprises, contains, includes provides, comprises or configures the SS/PBCH as the referenceSignal (or vice versa) and the reference signal (e.g., a NZP CSI-RS resource) in the indicated TCI state as the corresponding target RS (e.g., a/the higher layer parameter NZP-CSI-RS-Resource could comprise, provide, contain, include or configure a/the TCI state ID/index of the target TCI state), or a/the CC in/on which a/the target TCI state as specified/defined herein in the present disclosure is configured/applied when/if a/the RRC parameter cell or ServCellIndex or carrier is not present, provided or configured or is absent in a/the higher layer parameter QCL-Info in a/the higher layer parameter TCI-State that configures or provides the aforementioned target TCI state, and/or
   a/the CC in/on which higher layer parameter(s) e.g. master information block (MIB), SIB1, ServingCellConfigCommonSIB, ServingCellConfigCommon and/or etc. that provides or configures the SS/PBCH block or information related to the SS/PBCH block is configured/applied.

According to or following those specified/defined herein in the present disclosure, a UE could be provided or configured by the network (e.g., the network 130), e.g., via higher layer RRC signaling(s)/parameter(s) and/or MAC CE command(s) and/or dynamic DCI based L1 signaling(s) based on or according to corresponding UE's capability(s) or capability signaling(s), a list/set/pool of one or more CCs (e.g., in terms/form of the corresponding CC index(es)/ID(s)) each having/applying a (indicated) TCI state. The UE could expect that at least one of the one or more CCs in/on which the reference signal(s) in the corresponding indicated/applied TCI state(s) is configured if newBeamResourceSet-r19 is a NZP-CSI-RS-ResourceSet configured with repetition, or the SS/PBCH block(s) which is QCLed with the reference signal(s) in the corresponding indicated/applied TCI state(s) is configured if newBeamResourceSet-r19 is a CSI-SSB-ResourceSet, is same as or identical to a/the CC in/on which the newBeamResourceSet-r19 is configured, i.e., the CC of CSI-ReportConfig if a/the RRC parameter cell or ServCellIndex or carrier is not provided, present or configured or is absent in the CSI-ReportConfig, or the CC indicated by a/the RRC parameter cell or ServCellIndex or carrier, if present, provided or configured, in the CSI-ReportConfig.

Throughout the present disclosure, a CC could correspond to or could be equivalent to a carrier or a serving cell.

For the case-1 herein,
In one example, the PUCCH (resource) may not be overlapping or colliding with any PUSCH(s) and/or PUCCH(s) e.g. that carries HARQ-ACK, link recovery request (LRR) or (normal) SR
In another example, the PUCCH (resource) could be overlapping or colliding with one or more PUSCH(s) and/or PUCCH(s), and the UE has dropped the one or more PUSCH(s) and/or PUCCH(s). For instance, the type 1 CG-PUSCH configured by confguredResourceForSecondChannelOfModeB-r19 in the same CC as the corresponding CSI-ReportConfig which is the first available transmission occasion numOfSymbols-ModeB-r19 symbols after the end of the PUCCH (resource) is the earliest (or latest) in time among the type 1 CG-PUSCHs configured by configuredResourceForSecondChannelOfModeB-r19 in the same CC as the corresponding CSI-ReportConfig—each identified as the first available transmission occasion numOfSymbols-ModeB-r19 symbols after the end of the corresponding PUSCH/PUCCH among the one or more overlapping/colliding PUSCH(s) and/or PUCCH(s)—corresponding, associated or specific to the one or more overlapping/colliding PUSCH(s) and/or PUCCH(s). For this design example, a PUSCH can carry UL-SCH and/or HARQ-ACK and/or CSI and/or UTO-UCI, and a PUCCH could be with HARQ-ACK, LRR or (normal) SR.
In another example, the PUCCH (resource) could be overlapping or colliding with one or more PUCCHs, and the UE has dropped the one or more PUCCHs, wherein the one or more PUCCHs could be with HARQ-ACK, LRR or (normal) SR
In another example, the PUCCH (resource) could be overlapping or colliding with one or more PUSCHs, and the UE has dropped the one or more PUSCHs, wherein the one or more PUSCHs could be with UL-SCH, HARQ-ACK, CSI, and/or UTO-UCI.

For the case-2 herein, the UE could multiplex, append or piggyback the 1-bit indication of the PUCCH (resource) into the target PUSCH. When/if there are multiple PUSCHs—denoted by candidate PUSCHs—overlapping or colliding with the aforementioned PUCCH (resource) configured by firstPUCCHResourceConfig-UEIBR-r19 in the CSI-ReportConfig, wherein each of the (candidate) PUSCHs can carry UL-SCH and/or HARQ-ACK and/or CSI and/or UTO-UCI,
In one example, the UE could determine or identify the target PUSCH—among the candidate PUSCHs overlapping/colliding with the aforementioned PUCCH (resource)—such that the type 1 CG-PUSCH configured by configuredResourceForSecondChannelOfModeB-r19 in the same CC as the corresponding CSI-ReportConfig which is the first available transmission occasion numOfSymbols-ModeB-r19 symbols after the end of the target PUSCH is the earliest (or latest) in time among the type 1 CG-PUSCHs configured by configuredResourceForSecondChannelOfModeB-r19 in the same CC as the corresponding CSI-ReportConfig—each identified as the first available transmission occasion numOfSymbols-ModeB-r19 symbols after the end of the corresponding PUSCH among the candidate PUSCHs—corresponding or associated or specific to the candidate PUSCHs.
In one example, the UE could determine or identify the target PUSCH—among the candidate PUSCHs (1) overlapping/colliding with the aforementioned PUCCH (resource) and (2) that carry or convey one or more quantities—such that the type 1 CG-PUSCH configured by configuredResourceForSecondChannelOfModeB-r19 in the same CC as the corresponding CSI-ReportConfig which is the first available transmission occasion numOfSymbols-ModeB-r19 symbols after the end of the target PUSCH is the earliest (or latest) in time among the type 1 CG-PUSCHs configured by configuredResourceForSecondChannelOfModeB-r19 in the same CC as the corresponding CSI-ReportConfig—each identified as the first available transmission occasion numOfSymbols-ModeB-r19 symbols after the end of the corresponding PUSCH among the aforementioned candidate PUSCHs in this design example—corresponding or associated or specific to the aforementioned candidate PUSCHs in this design example, wherein the one or more quantities could correspond to or could be in terms/form of one or more of:
   UL-SCH
   HARQ-ACK
   CSI
   UTO-UCI.

For this design example, when/if the aforementioned candidate PUSCHs need to carry or convey or be with same/identical quantity(s) e.g. one of UL-SCH, HARQ-ACK, CSI and UTO-UCI, and the candidate PUSCHs could carry or convey different quantities, the UE could determine or identify the aforementioned candidate PUSCHs for determining or identifying the target PUSCH according to or based on their priority orders/indexes (e.g., in descending order or from high to low) among the candidate PUSCHs.
In another example, the UE could determine or identify the target PUSCH—among the candidate PUSCHs overlapping/colliding with the aforementioned PUCCH (resource)—as the candidate PUSCH that carries or conveys
   UL-SCH, and/or
   HARQ-ACK, and/or
   CSI, and/or
   UTO-UCI,
      according to or based on priority orders/indexes (e.g., in descending order or from high to low) of the candidate PUSCHs.

Furthermore, for the candidate PUSCH(s) that is not determined or identified as the target PUSCH
In one example, the UE could drop the candidate PUSCH(s) or drop transmission(s) of the candidate PUSCH(s).
In another example, the UE could multiplex the candidate PUSCH(s) on/in/into the target PUSCH.

Optionally, the PUCCH (resource) could be overlapping or colliding with one or more candidate PUSCH(s) and/or PUCCH(s), wherein a candidate PUSCH could carry or convey UL-SCH and/or HARQ-ACK and/or CSI and/or UTO-UCI, and a candidate PUCCH could be with HARQ-ACK, LRR or (normal) SR,
when/if the UE could determine or identify a target PUSCH/PUCCH—among the one or more candidate PUSCH(s) and/or PUCCH(s)—that satisfies or achieves one or more of the following conditions:
   according to or following those specified/defined herein in the present disclosure
   the first available transmission occasion associated, corresponding or specific to the target PUSCH/PUCCH occurs earlier in time than the first available transmission occasion associated, corresponding or specific to the PUCCH resource
   the first available transmission occasion associated, corresponding or specific to the target PUSCH/PUCCH occurs earlier in time than the first available transmission occasion associated, corresponding or specific to the PUCCH resource, by a configured threshold according to or based on a corresponding UE's capability
   the time interval/gap/offset between the target PUSCH/PUCCH and its corresponding or associated first available transmission occasion is smaller than or equal to the time interval/gap/offset between the PUCCH (resource) and its corresponding or associated first available transmission occasion
   the time interval/gap/offset between the target PUSCH/PUCCH and its corresponding or associated first available transmission occasion is smaller than or equal to the time interval/gap/offset between the PUCCH (resource) and its corresponding or associated first available transmission occasion, by a configured threshold according to or based on a corresponding UE's capability
   the target PUSCH/PUCCH ends earlier (or later) in time than the PUCCH (resource)
   the target PUSCH/PUCCH starts later (or earlier) in time than the PUCCH (resource)
   the start (e.g., the first symbol/slot) of the target PUSCH/PUCCH is earlier (or later) in time than the start (e.g., the first symbol/slot) of the PUCCH (resource) by a configured threshold
   the start (e.g., the first symbol/slot) of the target PUSCH/PUCCH is earlier (or later) in time than the end (e.g., the last symbol/slot) of the PUCCH (resource) by a configured threshold
   the end (e.g., the last symbol/slot) of the target PUSCH/PUCCH is earlier (or later) in time than the start (e.g., the first symbol/slot) of the PUCCH (resource) by a configured threshold
   the end (e.g., the last symbol/slot) of the target PUSCH/PUCCH is earlier (or later) in time than the end (e.g., the last symbol/slot) of the PUCCH (resource) by a configured threshold
   the target PUSCH, if determined or identified, carries or conveys UL-SCH
   the target PUSCH, if determined or identified, carries or conveys HARQ-ACK
   the target PUSCH, if determined or identified, carries or conveys CSI
   the target PUSCH, if determined or identified, carries or conveys UTO-UCI
   the target PUCCH, if determined or identified, is with HARQ-ACK
   the target PUCCH, if determined or identified, is with LRR
   the target PUCCH, if determined or identified, is with (normal) SR
the UE could multiplex, append or piggyback the 1-bit indication of the PUCCH (resource) into the target PUSCH/PUCCH, and the target PUSCH/PUCCH could correspond to the aforementioned target UL channel/resource;
otherwise,
   in one example, the UE could drop (transmission(s) of) the one or more candidate PUSCH(s) and/or PUCCH(s), and the PUCCH (resource) could correspond to the aforementioned target UL channel/resource
   in another example, the UE could drop (transmission(s) of) the 1-bit indication of the PUCCH (resource).

Throughout the present disclosure, a configured threshold can be of value 0.

According to or following those specified/defined herein in the present disclosure, the UE (e.g., the UE 116) could determine or identify a/the target UL channel/signal as specified/defined herein/herein in the present disclosure that carries or conveys a/the one-bit indication (e.g., corresponding to or denoted by a PN message/trigger) that requests UL resource(s) for transmitting or sending or indicates transmission(s) of the corresponding UEI CSI/beam report (and therefore, the corresponding UEI report content(s)/quantity(s) comprised therein) associated, corresponding, mapped, linked or specific to the aforementioned time window for event evaluation(s) such that:
the start (e.g., the first symbol/slot) and/or the end (e.g., the last symbol/slot) of the target UL channel/signal could be the closest in time to the end of the time window (e.g., the last symbol/slot of the time window), e.g., among the (configured) target UL channel(s)/signal(s) that can carry or convey a/the one-bit indication(s), and/or
the time window could end or the end of the time window (e.g., the last symbol/slot of the time window) could be no later than T_proc before or prior to the start (e.g., the first symbol/slot) and/or the end (e.g., the last symbol/slot) of the target UL channel/signal.

According to or following those specified/defined herein in the present disclosure, (1) the value of event instance counter index e for any of the reference signals configured by the newBeamResourceSet-r19, running from 0 to eventInstanceCount-r19 for or regarding or with respect to a time window for event evaluation(s) as specified/defined herein in the present disclosure, is set to zero, and/or (2) for a time window for event evaluation(s) as specified/defined herein in the present disclosure, the UE may not transmit or send a/the one-bit indication requesting UL resource(s) for transmitting or sending or indicating transmission(s) of the corresponding UEI CSI/beam report(s) comprising the corresponding UEI report content(s)/quantity(s) as specified/defined herein in the present disclosure in/on the target UL channel/signal associated, corresponding or specific to the time window according to or following those specified/defined herein in the present disclosure when/if one or more of the following conditions could be satisfied, achieved or met:
the UE receives a TCI state update (e.g., within the time window),
   case-A: via/by a/the TCI codepoint indicated or activated by a (unified) TCI state(s) activation/deactivation MAC CE command (e.g., received within the time window), and/or
   case-B: via/by a TCI codepoint indicated by the TCI field in/of a beam indication DCI of format(s) 1_1/1_2 with or without DL assignment (e.g., received within the time window), and/or
the TCI state update, hence the (measurement) RS(s) specific, associated or corresponding to the TCI state update, becomes applicable (e.g., within the time window) after a beam application time, wherein the (measurement) RS(s) could be determined or identified according to or based on:
   if newBeamResourceSet-r19 is a NZP-CSI-RS-ResourceSet configured with repetition, the (measurement) RS(s) could correspond to the reference signal in the TCI state update
   if newBeamResourceSet-r19 is a CSI-SSB-ResourceSet, the (measurement) RS(s) could correspond to the SS/PBCH block which is QCLed with the reference signal in the TCI state update,
and the beam application time could be determined or identified according to or based on:
   for case-A: 3 ms+TOₖ*(T_{first-SSB}+T_{SSB-proc})/NR slot length after the last symbol of a PUCCH or PUSCH with HARQ-ACK information for the PDSCH providing the (unified) TCI state(s) activation/deactivation MAC CE command, wherein
      T_{first-SSB} is time to first SSB transmission after the (unified) TCI state(s) activation/deactivation MAC CE command is decoded by the UE; The SSB could be the QCL-TypeA or QCL-TypeC to the TCI state update;

$${T}_{SSB - proc} = 2 ms ;$$

TOₖ=1 if the TCI state update is not in the active TCI state list for PDSCH, 0 otherwise;
for case-B: when the UE configured with dl-OrJointTCI-StateList would transmit a PUCCH with positive HARQ-ACK or a PUSCH with positive HARQ-ACK corresponding to the DCI carrying the updated TCI State indication and without DL assignment, or corresponding to one or more PDSCH(s) scheduled by the DCI carrying the updated TCI State indication, and if the updated TCI State(s) is/are different from the previously indicated one(s), the updated TCI-State(s) and/or TCI-UL-State(s)—hence the (measurement) RS(s)/RS resource(s) specific, associated or corresponding to the updated TCI-State(s) and/or TCI-UL-State(s) as defined/specified herein in the present disclosure—should be applied starting from the first slot that is at least beamAppTime symbols after the last symbol of the PUCCH or the PUSCH, and if the UE receives more than one updated TCI state for a CC/BWP to be applied starting from the first slot that is at least beamAppTime symbols after the last symbol of the PUCCH or the PUSCH, the updated TCI state carried in the latest DCI, for the corresponding coresetPoolIndex value when applicable, in time corresponding to positive HARQ-ACK value is applied. The first slot and the beamAppTime symbols are both determined on the active BWP with the smallest SCS among the BWP(s) from the CCs applying the indicated/updated TCI-State(s) or TCI-UL-State(s) that are active at the end of the PUCCH or the PUSCH carrying the positive HARQ-ACK, and/or
the TCI state update is the latest TCI state update received in time at least T_proc prior to or before or no later than T_proc prior to or before the start (e.g., a/the first slot/symbol) or end (e.g., a/the last slot/symbol) of the aforementioned target UL channel/signal associated, corresponding or specific to the time window
   for case-A: the (unified) TCI state(s) activation/deactivation MAC CE command is the latest (unified) TCI state(s) activation/deactivation MAC CE command received in time at least T_proc prior to or before or no later than T_proc prior to or before the start (e.g., a/the first slot/symbol) or end (e.g., a/the last slot/symbol) of the aforementioned target UL channel/signal associated, corresponding or specific to the time window;
   for case-B: the beam indication DCI is the latest beam indication DCI (e.g., of DCI format(s) 1_1/1_2 with or without DL assignment having the TCI field present/configured/provided) received in time at least T_proc prior to or before or no later than T_proc prior to or before the start (e.g., a/the first slot/symbol) or end (e.g., a/the last slot/symbol) of the aforementioned target UL channel/signal associated, corresponding or specific to the time window, or the beam indication DCI is received in the latest PDCCH (candidate(s)) in time at least T_proc prior to or before or no later than T_proc prior to or before the start (e.g., a/the first slot/symbol) or end (e.g., a/the last slot/symbol) of the aforementioned target UL channel/signal associated, corresponding or specific to the time window, and/or
the update of the (measurement) RS(s) specific, associated or corresponding to the TCI state update is the latest update in time of (measurement) RS(s) specific, associated or corresponding to TCI state(s) at least T_proc prior to or before or no later than T_proc prior to or before the start (e.g., a/the first slot/symbol) or end (e.g., a/the last slot/symbol) of the aforementioned target UL channel/signal associated, corresponding or specific to the time window, wherein the (measurement) RS(s) could be determined or identified according to or based on:
   if newBeamResourceSet-r19 is a NZP-CSI-RS-ResourceSet configured with repetition, the (measurement) RS(s) could correspond to the reference signal in the TCI state update
   if newBeamResourceSet-r19 is a CSI-SSB-ResourceSet, the (measurement) RS(s) could correspond to the SS/PBCH block which is QCLed with the reference signal in the TCI state update, and/or
the (measurement) RS(s) specific, associated or corresponding to the TCI state update is different from a/the current beam RS(s) as specified/defined herein in the present disclosure specific, associated or corresponding to the indicated TCI state, wherein,
   if newBeamResourceSet-r19 is a NZP-CSI-RS-ResourceSet configured with repetition, the (measurement) RS(s) could correspond to the reference signal in the TCI state update, and the current beam RS(s) could correspond to the reference signal in the indicated TCI state
   if newBeamResourceSet-r19 is a CSI-SSB-ResourceSet, the (measurement) RS(s) could correspond to the SS/PBCH block which is QCLed with the reference signal in the TCI state update, and the current beam RS(s) could correspond to the SS/PBCH block which is QCLed with the reference signal in the indicated TCI state,
and/or the UE has determined or identified or assessed or conducted or performed or evaluated one or more of:
   at least one event instance of an event (configured or provided or indicated by/in eventType in the CSI-ReportConfig) according to or following those specified or defined herein in the present disclosure
   an event (configured or provided or indicated by/in eventType in the CSI-ReportConfig) according to or following those specified or defined herein in the present disclsoure
   at least a UEI CSI/beam report comprising the corresponding UEI report content(s)/quantity(s)
   at least one measured L1-RSRP or L1-SINR with respect to or regarding a corresponding measurement occasion as specified/defined herein in the present disclosure
   at least one event evaluation instance as specified/defined herein in the present disclosure according to or based on the indicated TCI state hence the current beam RS(s) according to or following those specified or defined herein in the present disclosure, wherein
   the indicated TCI state (hence the current beam RS(s) corresponding, associated or specific to the indicated TCI state) could be the last/latest TCI state (hence the RS(s) corresponding, associated or specific to the last/latest TCI state) received in time before or prior to the TCI state update (hence the (measurement) RS(s) corresponding, associated or specific to the TCI state update)
      for case-A: the (unified) TCI state(s) activation/deactivation MAC CE command and/or the beam indication DCI (e.g., of DCI format(s) 1_1/1_2 with or without DL assignment having a/the TCI field present, configured or provided) that activates or indicates the indicated TCI state could be the last/latest (unified) TCI state(s) activation/deactivation MAC CE command and/or beam indication DCI received in time before or prior to reception of the (unified) TCI state(s) activation/deactivation MAC CE command that activates/indicates the TCI state update
      for case-B: the (unified) TCI state(s) activation/deactivation MAC CE command and/or the beam indication DCI (e.g., of DCI format(s) 1_1/1_2 with or without DL assignment having a/the TCI field present, configured or provided) that activates or indicates the indicated TCI state could be the last/latest (unified) TCI state(s) activation/deactivation MAC CE command and/or beam indication DCI received in time before or prior to reception of the beam indication DCI (e.g., of DCI format(s) 1_1/1_2 with or without DL assignment having a/the TCI field present, configured or provided) that indicates the TCI state update, and/or
the UE receives the indicated TCI state (e.g., within the time window),
   case-A′: via/by a/the TCI codepoint indicated or activated by a (unified) TCI state(s) activation/deactivation MAC CE command (e.g., received within the time window), and/or
   case-B′: via/by a TCI codepoint indicated by the TCI field in/of a beam indication DCI of format(s) 1_1/1_2 with or without DL assignment (e.g., received within the time window), and/or
the indicated TCI state, hence the current beam RS(s) specific, associated or corresponding to the indicated TCI state, becomes applicable (e.g., within the time window) after a beam application time, wherein the current beam RS(s) could be determined or identified according to or based on:
   if newBeamResourceSet-r19 is a NZP-CSI-RS-ResourceSet configured with repetition, the current beam RS(s) could correspond to the reference signal in the indicated TCI state
   if newBeamResourceSet-r19 is a CSI-SSB-ResourceSet, the current beam RS(s) could correspond to the SS/PBCH block which is QCLed with the reference signal in the indicated TCI state,
and the beam application time could be determined or identified according to or based on:
   for case-A′: 3 ms+TOₖ*(T_{first-SSB}+T_{SSB-proc})/NR slot length after the last symbol of a PUCCH or PUSCH with HARQ-ACK information for the PDSCH providing the (unified) TCI state(s) activation/deactivation MAC CE command, wherein
      T_{first-SSB} is time to first SSB transmission after the (unified) TCI state(s) activation/deactivation MAC CE command is decoded by the UE; The SSB could be the QCL-TypeA or QCL-TypeC to the indicated TCI state;

$${T}_{SSB - proc} = 2 ms ;$$

TOₖ=1 if the indicated TCI state is not in the active TCI state list for PDSCH, 0 otherwise;
for case-B′: when the UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to one or more PDSCH(s) scheduled by the DCI carrying the TCI State indication, and if the indicated TCI State(s) is/are different from the previously indicated one(s), the indicated TCI-State(s) and/or TCI-UL-State(s)—hence the current beam RS(s)/RS resource(s) specific, associated or corresponding to the indicated TCI-State(s) and/or TCI-UL-State(s) as defined/specified herein in the present disclosure—should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK.

The UE could determine or identify the value(s) of T_proc according to or based on: (i) fixed value(s) in system specification(s), e.g., in unit(s)/form/terms of slot, symbol, ms, and/or etc., (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified or defined herein in the present disclosure, for evaluating, assessing, detecting, determining or declaring event(s) and/or event instance(s), (higher layer(s) of) a UE could run the value of event instance counter index e for a reference signal configured or provided by/in the newBeamResourceSet-r19 within or with respect to or for or in regards to a time window for event evaluation(s) as specified/defined herein in the present disclosure, from 0 to eventInstanceCount-r19. That is, when/if (higher layer(s) of) the UE evaluates or assesses beam quality(s) e.g. measuring L1-RSRP(s) on/off a reference signal configured or provided by/in the newBeamResourceSet-r19 for evaluating, assessing, detecting, determining or declaring event(s) and/or event instance(s) within a first time window for event evaluation(s) and a second time window for event evaluation(s) as specified/defined herein in the present disclosure, (higher layer(s) of) the UE could run
the value of a first event instance counter index e₀ for the reference signal within or with respect to or for or in regards to the first time window for event evaluation(s) as specified/defined herein in the present disclosure, from 0 to eventInstanceCount-r19, and/or
the value of a second event instance counter index e₁ for the reference signal within or with respect to or for or in regards to the second time window for event evaluation(s) as specified/defined herein in the present disclosure, from 0 to eventInstanceCount-r19,
   wherein the first and second time windows could be overlapping in time, and as specified/defined herein in the present disclosure, the UE could be provided or configured by the network, e.g. via higher layer RRC signaling(s)/parameter(s) according to or based on corresponding UE's capability(s) or capability signaling(s), a/the periodicity and/or offset for or of the first and second time windows; furthermore, (higher layer(s) of) the UE could increment the first event instance counter index e₀ and the second event instance counter index e₁ separately.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/L1/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/L1/lower layer(s)

That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

Throughout the present disclosure, a PN message/trigger (i.e., the 1-bit indication that triggers or initiates transmission of the corresponding UEI CSI/beam report hence the UEI report content(s)/quantity(s) comprised therein) transmitted or sent on the PUCCH resource of PUCCH format 0 or format 1 configured by firstPUCCHResourceConfig-UEIBR-r19 in the CSI-ReportConfig as in Step-1 of Mode A/Mode B as specified/defined herein in the present disclosure could be equivalent to or represented/denoted by or referred to as an indication for UEI beam report (UEIBR) or UEI CSI report (UEICR) or a UEIBRI indication/indication (UEIBRI) or a UEICR indication/indicator (UEICRI).

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a physical cell ID (PCI) or a candidate cell via MAC CE signaling(s).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various resource allocation and association methods to enable the UE-initiated/event-driven beam reporting as well. In addition, relation(s) and/or inter-operation(s) between the UE-initiated/event-driven beam operations and beam failure recovery (BFR) procedure(s) are specified in the present disclosure as well.

The RS(s) or RS resource(s) or RS resource index(es) of/for a current serving beam—denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set so of (periodic) CSI-RS resource configuration indexes by currentServBeamRSList (e.g., via higher layer RRC signalling(s)/parameter(s) and/or MAC CE command(s) and/or dynamic DCI based L1 signalling(s)) for monitoring/assessing the radio link and/or beam qualities for the current serving beam(s) according to those specified herein in the present disclosure. The serving beam(s) set so of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.
(explicit configuration example-2): a set so of SS/PBCH block indexes by currentServBeamRSList (e.g., via higher layer RRC signalling(s)/parameter(s) and/or MAC CE command(s) and/or dynamic DCI based L1 signalling(s)) for monitoring/assessing the radio link and/or beam qualities for the current serving beam(s) according to those specified herein in the present disclosure. The serving beam(s) set so of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set so of (periodic) CSI-RS resource configuration indexes by currentServBeamRSList (e.g., via higher layer RRC signalling(s)/parameter(s) and/or MAC CE command(s) and/or dynamic DCI based L1 signalling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signalling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signalling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network (e.g., the network 130) a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signalling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource indexe(s)—could be identified or determined according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-i): a set s̅₂ of (periodic) CSI-RS resource configuration indexes by activationBeamRSList (e.g., via higher layer RRC signalling(s)/parameter(s) and/or MAC CE command(s) and/or dynamic DCI based L1 signalling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-ii): a set s̅₂ of SS/PBCH block indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1
In another example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’; when/if the higher layer parameter ‘currentBeamRStype’ is set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2, and/or when/if the higher layer parameter ‘currentBeamRStype’ is set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1. For this design example, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any set(s) of candidate/new RS index(es)—e.g., SSB index(es) or periodic CSI-RS resource configuration index(es)—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting, the UE could determine or identify the current serving beam RS(s) as SSB(s) for evaluating, assessing or determining the given event, e.g., Event-2, according to or following those specified or defined in Scheme-2, and/or when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of NZP CSI-RS resource or resource configuration index(es) as the candidate/new beam(s) set of RS index(es) for event(s) or event instance(s) evaluation(s) and/or beam measurement/reporting, the UE could determine or identify the current serving beam RS(s) as CSI-RS(s) for evaluating, assessing or determining the given event, e.g., Event-2, according to or following those specified or defined in Scheme-1. For this design example, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.

Furthermore, for evaluating, assessing or determining a given event (e.g., Event-2 as defined/specified herein in the present disclosure) and/or when/if a given event, e.g., Event-2 as defined/specified herein in the present disclosure, is enabled or provided or configured,
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ and set to ‘on’ or ‘enabled’ or ‘true’ or ‘SSB’ or ‘CSI-RS’, the UE could determine or identify whether the current serving beam RS(s) is SSB(s) or CSI-RS(s) for evaluating, assessing or determining the given event, e.g., Event-2, according to or based on the higher layer parameter ‘currentBeamRStype’ following those specified or defined herein in the present disclosure, regardless whether or not the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, candidate/new beam RS index(es)—e.g. in a resource set—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of candidate/new beam RS index(es)—e.g. a set of SSB index(es) or a set of periodic CSI-RS resource configuration index(es)—for event(s) or event instance(s) evaluation(s) and/or beam measurement/reporting, the UE could determine or identify whether the current serving beam RS(s) is SSB(s) or CSI-RS(s) for evaluating, assessing or determining the given event, e.g., Event-2, according to or based on whether the configured or provided candidate/new beam RS index(es) in the set is SSB index(es) or CSI-RS resource/resource configuration index(es) following those specified or defined herein in the present disclosure (e.g., those specified or defined in Scheme-1 and/or Scheme-2 in the present disclosure), regardless whether or not the aforementioned higher layer parameter ‘currentBeamRStype’ is present or provided or configured in the corresponding higher layer RRC signaling(s)/parameter(s), and/or regardless of the value(s) of the aforementioned higher layer parameter ‘currentBeamRStype’, if present/configured/provided.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network (e.g., the network 130) in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:

{Mode A}
{Mode B}
{Mode C}
{Mode A, Mode B}
{Mode A, Mode C}
{Mode B, Mode C}

According to or following those specified herein in the present disclosure,
For Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.
For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.
For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure.
   When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
   When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/L1/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/L1/lower layer(s)

That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

In one example, after or upon declaration and/or detection of a beam failure for a/the PCell and/or PSCell, a UE could transmit a PRACH—e.g., based on a configuration for PRACH transmission provided by PRACH-ResourceDedicatedBFR—in slot n and according to antenna port quasi co-location parameters associated with periodic CSI-RS resource configuration or with SS/PBCH block (SSB) associated with a new beam RS index q_new provided by higher layer(s) of the UE, wherein transmission of the PRACH here could be denoted/represented by or referred to as transmission of a link failure recovery indication (LFRI). In this case, after transmitting the LFRI (for the PCell and/or PSCell), the UE could monitor PDCCH in a search space set provided by recoverySearchSpaceId for detection of a DCI format with cyclic redundancy check (CRC) scrambled by C-RNTI or MCS-C-RNTI—denoted/represented by or referred to as detection or reception of a beam failure recovery response (BFRR)—starting from slot n+4+2^{μ}−k_{mac}, where p is the SCS configuration for the PRACH transmission and k_{mac} is a number of slots provided by k_{mac} or k_{mac}=0 if k_{mac} is not provided, within a window configured by BeamFailureRecoveryConfig. Furthermore, after 28 symbols from a last symbol of a first PDCCH reception in a search space set provided by recoverySearchSpaceId where the UE detects a DCI format with CRC scrambled by C-RNTI or MCS-C-RNTI, the UE could (re)set/determine spatial domain filter(s) for transmitting various UL channel(s)/signal(s) including PUCCH, PUSCH and/or SRS same as that/those used for transmitting a/the last PRACH (transmission), and/or the UE could (re)set/determine spatial domain filter(s) for receiving various DL channel(s)/signal(s) including PDCCH, PDSCH and/or CSI-RS according to the identified or determined new beam RS index q_new.

In one example, after or upon declaration and/or detection of a beam failure for a/the PCell and/or PSCell, a UE could transmit a BFR MAC CE provided in Msg3 or MsgA of contention based random access procedure—denoted/represented by or referred to as transmission of a LFRI. In this case, after transmitting the LFRI (for the PCell and/or PSCell), and after 28 symbols from the last symbol of the PDCCH reception that determines the completion of the contention based random access procedure—denoted/represented by or referred to as detection or reception of a BFRR in this case, the UE could (re)set/determine spatial domain filter(s) for transmitting various UL channel(s)/signal(s) including PUCCH, PUSCH and/or SRS same as that/those used for transmitting a/the last PRACH (transmission), and/or the UE could (re)set/determine spatial domain filter(s) for receiving various DL channel(s)/signal(s) including PDCCH, PDSCH and/or CSI-RS according to the identified or determined new beam RS index q_new.

In one example, after or upon declaration and/or detection of a beam failure for a/the PCell and/or PSCell and/or SCell, a UE could transmit a PUCCH with a link recovery request (LRR)—denoted/represented by or referred to as transmission of a LFRI; in this case, the UE could be provided or configured by the network, e.g., via higher layer RRC signalling(s)/parameter(s), a configuration for PUCCH transmission with a/the LRR. The UE could provide, in a PUSCH MAC CE—denoted/represented by or referred to as transmission of a link failure recovery report (LFRR), information related to the identified or determined new beam RS index q_new. After 28 symbols from a last symbol of a PDCCH reception with a DCI format scheduling a PUSCH transmission with a same HARQ process number as for the transmission of the PUSCH MAC CE (hence, the LFRR) and having a toggled NDI field value—denoted/represented by or referred to as detection or reception of a BFRR in this case, the UE could (re)set/determine spatial domain filter(s) for receiving various DL channel(s)/signal(s) including PDCCH, PDSCH and/or CSI-RS and/or transmitting various UL channel(s)/signal(s) including PUCCH, PUSCH and/or SRS according to the identified or determined new beam RS index q_new.

According to or following those specified herein in the present disclosure,
after (higher layer(s) of) a UE has started a beamFailureDetectionTimer, and/or
before the beamFailureDetectionTimer expires or resets, and/or
after (higher layer(s) of) the UE has started a beamFailureRecoveryTimer, and/or
before the beamFailureRecoveryTimer expires or resets, and/or
before the UE transmits or sends to the network a LFRI, e.g., before a first or last symbol/slot/etc. of transmission of the LFRI but after (higher layer(s) of) the UE has declared, detected or determined beam failure(s) for the corresponding cell(s), and/or
after the UE has transmitted or sent to the network a LFRI, e.g., starting from a last symbol/slot/etc. of transmission of the LFRI, and/or
X symbol(s)/slot(s)/etc. after the UE has transmitted or sent to the network a LFRI, e.g., X symbol(s)/slot(s)/etc. starting from a last symbol/slot/etc. of transmission of the LFRI, and/or
within a first time window/duration/gap/offset after the UE has transmitted or sent to the network a LFRI, e.g., starting from a last symbol/slot/etc. of transmission of the LFRI, and/or
within a first time window/duration/gap/offset X symbol(s)/slot(s)/etc. after the UE has transmitted or sent to the network a LFRI, e.g., within the first time window/duration/gap/offset X symbol(s)/slot(s)/etc. starting from a last symbol/slot/etc. of transmission of the LFRI, and/or
(higher layer(s) of) the UE could start a prohibit timer provided or configured by prohibitTimerLFRI after the UE has transmitted or sent to the network a LFRI, e.g., starting from a last symbol/slot/etc. of transmission of the LFRI, and before the prohibit timer expires or resets, and/or
(higher layer(s) of) the UE could start a prohibit timer provided or configured by prohibitTimerLFRI X symbol(s)/slot(s)/etc. after the UE has transmitted or sent to the network a LFRI, e.g., X symbol(s)/slot(s)/etc. starting from a last symbol/slot/etc. of transmission of the LFRI, and before the prohibit timer expires or resets, and/or
before the UE receives from the network a corresponding BFRR, e.g., before a first or last symbol/slot/etc. of reception of the corresponding BFRR, and/or
after the UE has received from the network the corresponding BFRR, e.g., starting from a last symbol/slot/etc. of reception of the corresponding BFRR, and/or
Y symbol(s)/slot(s)/etc. after the UE has received from the network the corresponding BFRR, e.g., Y symbol(s)/slot(s)/etc. starting from a last symbol/slot/etc. of reception of the corresponding BFRR, and/or
within a second time window/duration/gap/offset after the UE has received from the network the corresponding BFRR, e.g., starting from a last symbol/slot/etc. of reception of the corresponding BFRR, and/or
within a second time window/duration/gap/offset Y symbol(s)/slot(s)/etc. after the UE has received from the network the corresponding BFRR, e.g., within the second time window/duration/gap/offset Y symbol(s)/slot(s)/etc. starting from a last symbol/slot/etc. of reception of the corresponding BFRR, and/or
(higher layer(s) of) the UE could start a prohibit timer provided or configured by prohibitTimerBFRR after the UE has received from the network the corresponding BFRR, e.g., starting from a last symbol/slot/etc. of reception of the corresponding BFRR, and before the prohibit timer expires or resets, and/or
(higher layer(s) of) the UE could start a prohibit timer provided or configured by prohibitTimerBFRR Y symbol(s)/slot(s)/etc. after the UE has received from the network the corresponding BFRR, e.g., Y symbol(s)/slot(s)/etc. starting from a last symbol/slot/etc. of reception of the corresponding BFRR, and before the prohibit timer expires or resets, and/or
before the UE transmits or sends to the network a LFRR if any, e.g., before a first or last symbol/slot/etc. of transmission of the LFRR, and/or
after the UE has transmitted or sent to the network a LFRR if any, e.g., starting from a last symbol/slot/etc. of transmission of the LFRR, and/or
Z symbol(s)/slot(s)/etc. after the UE has transmitted or sent to the network a LFRR if any, e.g., Z symbol(s)/slot(s)/etc. starting from a last symbol/slot/etc. of transmission of the LFRR, and/or
within a third time window/duration/gap/offset after the UE has transmitted or sent to the network a LFRR if any, e.g., starting from a last symbol/slot/etc. of transmission of the LFRR, and/or
within a third time window/duration/gap/offset Z symbol(s)/slot(s)/etc. after the UE has transmitted or sent to the network a LFRR if any, e.g., within the third time window/duration/gap/offset Z symbol(s)/slot(s)/etc. starting from a last symbol/slot/etc. of transmission of the LFRR, and/or
(higher layer(s) of) the UE could start a prohibit timer provided or configured by prohibitTimerLFRR after the UE has transmitted or sent to the network a LFRR if any, e.g., starting from a last symbol/slot/etc. of transmission of the LFRR, and before the prohibit timer expires or resets, and/or
(higher layer(s) of) the UE could start a prohibit timer provided or configured by prohibitTimerLFRR Z symbol(s)/slot(s)/etc. after the UE has transmitted or sent to the network a LFRR if any, e.g., Z symbol(s)/slot(s)/etc. starting from a last symbol/slot/etc. of transmission of the LFRR, and before the prohibit timer expires or resets, and/or
after (higher layer(s) of) the UE has declared, detected or determined beam failure(s) for the corresponding cell(s), and/or
U symbol(s)/slot(s)/ms/etc. after (higher layer(s) of) the UE has declared, detected or determined beam failure(s) for the corresponding cell(s), and/or
within a fourth time window/duration/gap/offset after (higher layer(s) of) the UE has declared, detected or determined beam failure(s) for the corresponding cell(s), and/or
within a fourth time window/duration/gap/offset U symbol(s)/slot(s)/ms/etc. after (higher layer(s) of) the UE has declared, detected or determined beam failure(s) for the corresponding cell(s), and/or
(higher layer(s) of) the UE could start a prohibit timer provided or configured by prohibitTimerBFRevent after (higher layer(s) of) the UE has declared, detected or determined beam failure(s) for the corresponding cell(s), and before the prohibit timer expires or resets, and/or
(higher layer(s) of) the UE could start a prohibit timer provided or configured by prohibitTimerBFRevent U symbol(s)/slot(s)/ms/etc. after (higher layer(s) of) the UE has declared, detected or determined beam failure(s) for the corresponding cell(s), and before the prohibit timer expires or resets,
   regarding Mode A, Mode B and/or Mode C,
in one example, (higher layer(s) of) the UE is not expected to or would not declare or detect or determine, or could stop evaluating, assessing, detecting, declaring and/or determining any event(s) and/or event instance(s) according to or following those specified herein in the present disclosure, and/or (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s)
in another example, the UE is not expected to or would not transmit any PUCCH(s) and/or PN message(s)/trigger(s) via/by/in any PUCCH resource(s) of the first UL channel as in Step-1 of Mode A, Mode B and/or Mode C as specified/defined herein in the present disclosure, or the UE could stop or terminate or abandon transmission(s) or re-transmission(s) of any PUCCH(s) and/or PN message(s)/trigger(s) via/by/in any PUCCH resource(s) of the first UL channel as in Step-1 of Mode A, Mode B and/or Mode C as specified/defined herein in the present disclosure, though (higher layer(s) of) the UE may have detected or declared or determined one or more events according to or following those specified/defined herein in the present disclosure
in another example, the UE could transmit a PUCCH and/or a PN message/trigger via/by/in a PUCCH resource of the first UL channel as in Step-1 of Mode A, Mode B and/or Mode C as specified/defined herein in the present disclosure to indicate or inform to the network (e.g., the network 130) that the UE would not transmit or send or stop transmitting or sending any beam report(s)—in this case, the PUCCH or the PN message/trigger could be a one-bit indicator set to ‘0’ (or ‘1’) or negative (or positive); when the one-bit PUCCH or PN message/trigger is set to ‘1’ (or ‘0’) or positive (or negative), the UE could (i) request UL grant for PUSCH resource(s) to transmit corresponding beam report(s) as in Step-3 of Mode A and/or Mode C or (ii) notify transmission of corresponding beam report(s) over/in/by higher layer configured PUSCH resource(s) of the second UL channel—associated/linked to the PUCCH resource of the first UL channel as in Step-1—as in Step-2 of Mode B
in another example, the UE is not expected to or would not receive any (downlink/uplink) DCI in response to transmission of PUCCH of the first UL channel as in Step-2 of Mode A and/or Mode C, which provides UL grant, i.e., dynamic grant PUSCH resource(s), for transmitting corresponding beam report(s), or the UE could stop monitoring any PDCCH(s)/PDCCH candidate(s) in respective CORESET(s) that may carry (downlink/uplink) DCI(s) in response to transmission of PUCCH of the first UL channel as in Step-2 of Mode A and/or Mode C, which could provide UL grant, i.e., dynamic grant PUSCH resource(s), for transmitting corresponding beam report(s), though the UE may have transmitted or sent PUCCH(s) and/or PN message(s)/trigger(s) via/by/in PUCCH resource(s) of the first UL channel as in Step-1 of Mode A, Mode B and/or Mode C
in another example, when/if the UE has received a (downlink/uplink) DCI in response to transmission of PUCCH of the first UL channel as in Step-2 of Mode A and/or Mode C, which provides UL grant, i.e., dynamic grant PUSCH resource(s), for transmitting corresponding beam report(s), the UE could ignore the DCI and/or the UL grant
in another example, the UE is not expected to or would not transmit any beam report(s), e.g., the UEI beam report(s) as specified/defined herein in the present disclosure, via/by/in any PUSCH resource(s) of the second UL channel as in Step-2 of Mode B and/or Step-3 of Mode A and/or Mode C, or the UE could stop or terminate or abandon transmission(s) or re-transmission(s) of any beam report(s), e.g., the UEI beam report(s) as specified/defined herein in the present disclosure, via/by/in any PUSCH resource(s) of the second UL channel as in Step-2 of Mode B and/or Step-3 of Mode A and/or Mode C, though (1) for Mode A and/or Mode C, the UE may have received a (downlink/uplink) DCI as in Step-2 that provides dynamic grant PUSCH resource(s) for transmitting the beam report(s) as in Step-3, or (2) for Mode B, the UE may have determined or identified a PUSCH resource associated/linked to the PUCCH resource of the first UL channel as in Step-1 used/applied to transmit the corresponding PN message/trigger for transmitting the beam report(s) as in Step-2, according to or following those specified/defined herein in the present disclosure

Here, the UE could determine or identify the value(s) of X, Y, Z, U (e.g., in terms/form/number of slot(s)/symbol(s)/ms/etc.), duration(s)/length(s) of the prohibit timer(s) prohibitTimerLFRI, prohibitTimerLFRR, prohibitTimerBFRR, prohibitTimerBFRevent (e.g., in terms/form/number of slot(s)/symbol(s)/ms/etc.), duration(s)/length(s) of the first time window/duration/gap/offset and/or the second time window/duration/gap/offset and/or the third time window/duration/gap/offset and/or the fourth time window/duration/gap/offset (e.g., in terms/form/number of symbol(s)/slot(s)/ms/etc.) according to or based on: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).

According to or following those specified/defined herein in the present disclosure, during the BFR procedure(s), the UE could determine or identify a new beam RS or RS resource (hence a corresponding new beam RS index q_new) from a set of candidate beam RSs or RS resources (hence a corresponding set of candidate beam RS index(es) of periodic CSI-RS resource configuration indexes and/or SS/PBCH block indexes provided by candidateBeamRSList), and send, transmit, indicate or inform to the network their determined or identified new beam RS index q_new. Furthermore, as specified/defined herein in the present disclosure, after 28 symbols from a last symbol of detection or reception of a BFRR, the UE could (re)set/determine spatial domain filter(s) for receiving various DL channel(s)/signal(s) including PDCCH, PDSCH and/or CSI-RS and/or transmitting various UL channel(s)/signal(s) including PUCCH, PUSCH and/or SRS according to the identified or determined new beam RS index q_new—e.g., for SCell BFR. In this case, for evaluating, assessing, detecting, declaring or determining event(s) or event instance(s) according to or following those specified herein in the present disclosure, the UE could determine or identify the current (serving) beam RS/RS resource according to or based on the new beam RS index q_new.
In one example, the new beam RS index q_new could correspond to a periodic CSI-RS resource configuration index:
   for example, the set of candidate beam RS index(es) provided by candidateBeamRSList could (only) contain, comprise, include, provide or configure only periodic CSI-RS resource configuration indexes; in this case, the UE could identify or determine or select the new beam RS index q_new from the set of candidate beam RS index(es);
   for another example, the set of candidate beam RS index(es) provided by candidateBeamRSList could contain, comprise, include, provide or configure both periodic CSI-RS resource configuration indexes (denoted/represented by or referred to as a first subset of candidate beam RS index(es)) and SSB indexes (denoted/represented by or referred to as a second subset of candidate beam RS index(es)); in this case, the UE could identify or determine or select the new beam RS index q_new from the first subset of candidate beam RS index(es) that could (only) contain, comprise, include, provide or configure only periodic CSI-RS resource configuration indexes.

In one case (Case-X),
for evaluating, assessing, detecting, declaring or determining Event-1 and/or Event-1 instance(s) according to or following those specified/defined herein in the present disclosure, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of periodic CSI-RS resource configuration index(es) as the candidate/new beam(s) set of RS index(es) for event(s) or event instance(s) evaluation(s).
for evaluating, assessing, detecting, declaring or determining Event-2 and/or Event-2 instance(s) according to or following those specified/defined herein in the present disclosure,
   in one example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’, and/or the higher layer parameter ‘currentBeamRStype’ could be set to ‘on’ or ‘enabled’ or ‘true’ or ‘CSI-RS’—in this case, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any periodic CSI-RS resource configuration index(es) as the candidate/new beam(s) set of RS index(es) for event(s) or event instance(s) evaluation(s) and/or beam measurement/reporting
   in one example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of periodic CSI-RS resource configuration index(es) as the candidate/new beam(s) set of RS index(es) for event(s) or event instance(s) evaluation(s) and/or beam measurement/reporting—in this case, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.
for evaluating, assessing, detecting, declaring or determining Event-3 and/or Event-3 instance(s) according to or following those specified/defined herein in the present disclosure, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of periodic CSI-RS resource configuration index(es) as the candidate/new beam(s) set of RS index(es) for event(s) or event instance(s) evaluation(s).

For this Case-X as specified/described herein in the present disclosure, the UE could determine or identify the (NZP) CSI-RS or (NZP) CSI-RS resource or resource configuration corresponding/associated to the new beam RS index q_new (corresponding to a periodic CSI-RS resource configuration index in this case) as the current (serving) beam RS or RS resource for evaluating, assessing, detecting, declaring or determining Event-1, Event-2 and/or Event-3 and/or the corresponding event instance(s) according to or following those specified herein in the present disclosure (e.g., those specified or described in Scheme-1). In another case (Case-Y),
for evaluating, assessing, detecting, declaring or determining Event-1 and/or Event-1 instance(s) according to or following those specified/defined herein in the present disclosure, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s).
for evaluating, assessing, detecting, declaring or determining Event-2 and/or Event-2 instance(s) according to or following those specified/defined herein in the present disclosure,
   in one example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’, and/or the higher layer parameter ‘currentBeamRStype’ could be set to ‘on’ or ‘enabled’ or ‘true’ or ‘SSB’—in this case, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any SSB index(es) as the candidate/new beam(s) set of RS index(es) for event(s) or event instance(s) evaluation(s) and/or beam measurement/reporting
   in one example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting—in this case, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.
for evaluating, assessing, detecting, declaring or determining Event-3 and/or Event-3 instance(s) according to or following those specified/defined herein in the present disclosure, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s).

For this Case-Y as specified/described herein in the present disclosure, the UE (e.g., the UE 116) could determine or identify the SSB that is QCL'ed (e.g., of QCL-TypeD) with the (NZP) CSI-RS or (NZP) CSI-RS resource or resource configuration corresponding/associated to the new beam RS index q_new (corresponding to a periodic CSI-RS resource configuration index in this case) as the current (serving) beam RS or RS resource for evaluating, assessing, detecting, declaring or determining Event-1, Event-2 and/or Event-3 and/or the corresponding event instance(s) according to or following those specified herein in the present disclosure (e.g., those specified or described in Scheme-2).
In another example, the new beam RS index q_new could correspond to a SSB index:
   for example, the set of candidate beam RS index(es) provided by candidateBeamRSList could (only) contain, comprise, include, provide or configure only SSB indexes; in this case, the UE could identify or determine or select the new beam RS index q_new from the set of candidate beam RS index(es);
   for another example, the set of candidate beam RS index(es) provided by candidateBeamRSList could contain, comprise, include, provide or configure both periodic CSI-RS resource configuration indexes (denoted/represented by or referred to as a first subset of candidate beam RS index(es)) and SSB indexes (denoted/represented by or referred to as a second subset of candidate beam RS index(es)); in this case, the UE could identify or determine or select the new beam RS index q_new from the second subset of candidate beam RS index(es) that could (only) contain, comprise, include, provide or configure only SSB indexes.
   for another example, the set of candidate beam RS index(es) provided by candidateBeamRSList could (only) contain, comprise, include, provide or configure only periodic CSI-RS resource configuration indexes; in this case, the UE could identify or determine a target set of SSB indexes wherein SSB(s) corresponding/associated to each of the SSB indexes in the target set could be QCL'ed (e.g., of QCL-TypeD) with (NZP) CSI-RS(s) or (NZP) CSI-RS resource(s) or resource configuration(s) corresponding/associated to each of the periodic CSI-RS resource configuration indexes in the set provided by candidateBeamRSList; for this design example, the UE could identify or determine or select the new beam RS index q_new from the target set of SSB index(es);
   for another example, the set of candidate beam RS index(es) provided by candidateBeamRSList could contain, comprise, include, provide or configure both periodic CSI-RS resource configuration indexes (denoted/represented by or referred to as a first subset of candidate beam RS index(es)) and SSB indexes (denoted/represented by or referred to as a second subset of candidate beam RS index(es)); in this case, the UE could identify or determine or select the new beam RS index q_new from the second subset of candidate beam RS index(es) that could (only) contain, comprise, include, provide or configure only SSB indexes;
   for another example, the set of candidate beam RS index(es) provided by candidateBeamRSList could contain, comprise, include, provide or configure both periodic CSI-RS resource configuration indexes (denoted/represented by or referred to as a first subset of candidate beam RS index(es)) and SSB indexes (denoted/represented by or referred to as a second subset of candidate beam RS index(es)); in this case, the UE could identify or determine a target set of SSB indexes wherein SSB(s) corresponding/associated to each of the SSB indexes in the target set could be QCL'ed (e.g., of QCL-TypeD) with (NZP) CSI-RS(s) or (NZP) CSI-RS resource(s) or resource configuration(s) corresponding/associated to each of the periodic CSI-RS resource configuration indexes in the first subset of candidate beam RS index(es); for this design example, the UE could identify or determine or select the new beam RS index q_new from the second subset of candidate beam RS index(es) that could (only) contain, comprise, include, provide or configure only SSB indexes and/or the target set of SSB index(es).

In this case,
for evaluating, assessing, detecting, declaring or determining Event-1 and/or Event-1 instance(s) according to or following those specified/defined herein in the present disclosure, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s).
for evaluating, assessing, detecting, declaring or determining Event-2 and/or Event-2 instance(s) according to or following those specified/defined herein in the present disclosure,
   in one example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’, and/or the higher layer parameter ‘currentBeamRStype’ could be set to ‘on’ or ‘enabled’ or ‘true’ or ‘SSB’—in this case, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any SSB index(es) as the candidate/new beam(s) set of RS index(es) for event(s) or event instance(s) evaluation(s) and/or beam measurement/reporting
   in one example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting—in this case, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.
for evaluating, assessing, detecting, declaring or determining Event-3 and/or Event-3 instance(s) according to or following those specified/defined herein in the present disclosure, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s).

For this design example, the UE could determine or identify the SSB corresponding/associated to the new beam RS index q_new (corresponding to a SSB index in this case) as the current (serving) beam RS or RS resource for evaluating, assessing, detecting, declaring or determining Event-1, Event-2 and/or Event-3 and/or the corresponding event instance(s) according to or following those specified herein in the present disclosure.

According to or following those specified or defined herein in the present disclosure, when/if a UE has determined or identified that a/the current (serving) beam RS or RS resource could correspond to a (NZP) periodic CSI-RS or CSI-RS resource/resource configuration,
in one example, the UE may not expect to be provided or configured by the network a set of candidate beam RS index(es) provided by candidateBeamRSList, from which the new beam RS index q_new could be determined, selected or identified, that (only) contain, comprise, include, provide or configure only SSB indexes;
in another example, the UE may expect to be provided or configured by the network a set of candidate beam RS index(es) provided by candidateBeamRSList, from which the new beam RS index q_new could be determined, selected or identified, that contains, comprises, includes, provides or configures at least one (or one or more) periodic CSI-RS resource configuration index or index(es)

According to or following those specified or defined herein in the present disclosure, when/if a UE has determined or identified that a/the current (serving) beam RS or RS resource could correspond to a SSB,
in one example, the UE may not expect to be provided or configured by the network a set of candidate beam RS index(es) provided by candidateBeamRSList, from which the new beam RS index q_new could be determined, selected or identified, that (only) contain, comprise, include, provide or configure only periodic CSI-RS resource configuration indexes;
in another example, the UE may expect to be provided or configured by the network a set of candidate beam RS index(es) provided by candidateBeamRSList, from which the new beam RS index q_new could be determined, selected or identified, that contains, comprises, includes, provides or configures at least one (or one or more) SSB index or index(es);
in another example, when/if the UE is provided or configured by the network a/the set of candidate beam RS index(es) provided by candidateBeamRSList containing, comprising, including, providing or configuring only periodic CSI-RS resource configuration indexes, the UE could be expected to identify or determine a target set of SSB indexes wherein SSB(s) corresponding/associated to each of the SSB indexes in the target set could be QCL'ed (e.g., of QCL-TypeD) with (NZP) CSI-RS(s) or (NZP) CSI-RS resource(s) or resource configuration(s) corresponding/associated to each of the periodic CSI-RS resource configuration indexes in the set provided by candidateBeamRSList, and the UE could be expected to identify or determine or select the new beam RS index q_new from the target set of SSB index(es);
in another example, when/if the UE is provided or configured by the network a/the set of candidate beam RS index(es) provided by candidateBeamRSList containing, comprising, including, providing or configuring both periodic CSI-RS resource configuration indexes (denoted/represented by or referred to as a first subset of candidate beam RS index(es)) and SSB indexes (denoted/represented by or referred to as a second subset of candidate beam RS index(es)), the UE could be expected to identify or determine or select the new beam RS index q_new from the second subset of candidate beam RS index(es) containing, comprising, including, providing or configuring only SSB indexes;
in another example, when/if the UE is provided or configured by the network a/the set of candidate beam RS index(es) provided by candidateBeamRSList containing, comprising, including, providing or configuring both periodic CSI-RS resource configuration indexes (denoted/represented by or referred to as a first subset of candidate beam RS index(es)) and SSB indexes (denoted/represented by or referred to as a second subset of candidate beam RS index(es)), the UE could be expected to identify or determine a target set of SSB indexes wherein SSB(s) corresponding/associated to each of the SSB indexes in the target set could be QCL'ed (e.g., of QCL-TypeD) with (NZP) CSI-RS(s) or (NZP) CSI-RS resource(s) or resource configuration(s) corresponding/associated to each of the periodic CSI-RS resource configuration indexes in the first subset of candidate beam RS index(es), and the UE could be expected to identify or determine or select the new beam RS index q_new from the second subset of candidate beam RS index(es) containing, comprising, including, providing or configuring only SSB indexes and/or the target set of SSB index(es).

According to or following those specified or defined herein in the present disclosure, when/if the UE is provided or configured by the network a set of candidate beam RS index(es) provided by candidateBeamRSList, from which the new beam RS index q_new could be determined or selected or identified, that (only) contain, comprise, include, provide or configure only SSB indexes, or when/if the UE is provided or configured by the network a set of candidate beam RS index(es) provided by candidateBeamRSList, from which the new beam RS index q_new could be determined or selected or identified, that contains, comprises, includes, provides or configures both periodic CSI-RS resource configuration index(es) and SSB index(es)
In one example, for evaluating, assessing, detecting, declaring or determining Event-1 and/or Event-1 instance(s) and/or Event-3 and/or Event-3 instance(s) according to or following those specified/defined herein in the present disclosure, the UE may not expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, only periodic CSI-RS resource configuration index(es)—e.g. in a set—as the candidate/new beam RS index(es) for event(s) or event instance(s) evaluation(s), and/or the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, at least SSB index(es)—e.g. in a set—as the candidate/new beam RS index(es) for event(s) or event instance(s) evaluation(s)
In another example, for evaluating, assessing, detecting, declaring or determining Event-2 and/or Event-2 instance(s) according to or following those specified/defined herein in the present disclosure
   in one example, the UE may not expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘CSI-RS’—if present, and/or the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘SSB’, if present
   in another example, the UE may not expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, only periodic CSI-RS resource configuration index(es)—e.g. in a set—as the candidate/new beam RS index(es) for event(s) or event instance(s) evaluation(s) and/or beam measurement/reporting, and/or the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, at least SSB index(es)—e.g. in a set—as the candidate/new beam RS index(es) for event(s) or event instance(s) evaluation(s) and/or beam measurement/reporting.

According to or following those specified or defined herein in the present disclosure, when/if the UE is provided or configured by the network a set of candidate beam RS index(es) provided by candidateBeamRSList, from which the new beam RS index q_new could be determined or selected or identified, that (only) contain, comprise, include, provide or configure only periodic CSI-RS resource configuration indexes,
In one example, for evaluating, assessing, detecting, declaring or determining Event-1 and/or Event-1 instance(s) and/or Event-3 and/or Event-3 instance(s) according to or following those specified/defined herein in the present disclosure, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s), and/or periodic CSI-RS resource configuration index(es)—e.g. in a set—as the candidate/new beam RS index(es) for event(s) or event instance(s) evaluation(s)
In another example, for evaluating, assessing, detecting, declaring or determining Event-2 and/or Event-2 instance(s) according to or following those specified/defined herein in the present disclosure
   in one example, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘SSB’ or ‘CSI-RS’, if present
   in another example, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s) and/or beam measurement/reporting, and/or periodic CSI-RS resource configuration index(es)—e.g. in a set—as the candidate/new beam RS index(es) for event(s) or event instance(s) evaluation(s) and/or beam measurement/reporting

According to or following those specified or defined herein in the present disclosure, when/if the UE is provided or configured by the network a set of candidate beam RS index(es) provided by candidateBeamRSList, from which the new beam RS index q_new could be determined or selected or identified, that (only) contain, comprise, include, provide or configure only SSB indexes,
In one example, for evaluating, assessing, detecting, declaring or determining Event-1 and/or Event-1 instance(s) and/or Event-3 and/or Event-3 instance(s) according to or following those specified/defined herein in the present disclosure, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s), and/or periodic CSI-RS resource configuration index(es)—e.g. in a set—as the candidate/new beam RS index(es) for event(s) or event instance(s) evaluation(s)
In another example, for evaluating, assessing, detecting, declaring or determining Event-2 and/or Event-2 instance(s) according to or following those specified/defined herein in the present disclosure
   in one example, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘SSB’ or ‘CSI-RS’, if present
   in another example, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s) and/or beam measurement/reporting, and/or periodic CSI-RS resource configuration index(es)—e.g. in a set—as the candidate/new beam RS index(es) for event(s) or event instance(s) evaluation(s) and/or beam measurement/reporting.

According to or following those specified or defined herein in the present disclosure, when/if the UE is provided or configured by the network a set of candidate beam RS index(es) provided by candidateBeamRSList, from which the new beam RS index q_new could be determined or selected or identified, that (only) contain, comprise, include, provide or configure only periodic CSI-RS resource configuration indexes, or when/if the UE is provided or configured by the network a set of candidate beam RS index(es) provided by candidateBeamRSList, from which the new beam RS index q_new could be determined or selected or identified, that contains, comprises, includes, provides or configures both periodic CSI-RS resource configuration index(es) and SSB index(es)
In one example, for evaluating, assessing, detecting, declaring or determining Event-1 and/or Event-1 instance(s) and/or Event-3 and/or Event-3 instance(s) according to or following those specified/defined herein in the present disclosure, the UE may not expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, only SSB index(es)—e.g. in a set—as the candidate/new beam RS index(es) for event(s) or event instance(s) evaluation(s), and/or the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, at least periodic CSI-RS resource configuration index(es)—e.g. in a set—as the (potential) candidate/new beam RS index(es) for event(s) or event instance(s) evaluation(s)
In another example, for evaluating, assessing, detecting, declaring or determining Event-2 and/or Event-2 instance(s) according to or following those specified/defined herein in the present disclosure
   in one example, the UE may not expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘SSB’—if present, and/or the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘CSI-RS’, if present
   in another example, the UE may not expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, only SSB index(es)—e.g. in a set—as the candidate/new beam RS index(es) for event(s) or event instance(s) evaluation(s) and/or beam measurement/reporting, and/or the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, at least periodic CSI-RS resource configuration index(es)—e.g. in a set—as the (potential) candidate/new beam RS index(es) for event(s) or event instance(s) evaluation(s) and/or beam measurement/reporting.

In this case,
when/if the UE has determined or identified that the new beam index q_new corresponds to a periodic CSI-RS resource configuration index, and the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, periodic CSI-RS resource configuration index(es)—e.g. in a set—as the potential candidate/new beam RS index(es) for event(s) or event instance(s) evaluation(s), the UE could determine or identify the NZP (periodic) CSI-RS resource(s) or resource configuration(s) corresponding/associated to the periodic CSI-RS resource configuration index(es) in the set as the actual candidate/new beam RS(s) for event(s) or event instance(s) evaluation(s)
when/if the UE has determined or identified that the new beam index q_new corresponds to a SSB, and the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, periodic CSI-RS resource configuration index(es)—e.g. in a set—as the potential candidate/new beam RS index(es) for event(s) or event instance(s) evaluation(s), the UE could determine or identify SSB(s) that is QCL'ed (e.g., of QCL-TypeD) with the NZP (periodic) CSI-RS resource(s) or resource configuration(s) corresponding/associated to the periodic CSI-RS resource configuration index(es) in the set as the actual candidate/new beam RS(s) for event(s) or event instance(s) evaluation(s).

According to or following those specified or defined herein in the present disclosure, when/if the UE is provided or configured by the network a set of candidate beam RS index(es) provided by candidateBeamRSList, from which the new beam RS index q_new could be determined or selected or identified, that (only) contain, comprise, include, provide or configure only SSB indexes,
In one example, for evaluating, assessing, detecting, declaring or determining Event-1 and/or Event-1 instance(s) and/or Event-3 and/or Event-3 instance(s) according to or following those specified/defined herein in the present disclosure, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s), and/or periodic CSI-RS resource configuration index(es)—e.g. in a set—as the (potential) candidate/new beam RS index(es) for event(s) or event instance(s) evaluation(s)
In another example, for evaluating, assessing, detecting, declaring or determining Event-2 and/or Event-2 instance(s) according to or following those specified/defined herein in the present disclosure
   in one example, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ set to ‘CSI-RS’ or ‘SSB’, if present
   in another example, the UE could expect to be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s) and/or beam measurement/reporting, and/or periodic CSI-RS resource configuration index(es)—e.g. in a set—as the (potential) candidate/new beam RS index(es) for event(s) or event instance(s) evaluation(s) and/or beam measurement/reporting.

In this case, the new beam index q_new, if/when determined or identified, corresponds to a SSB index
when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, SSB index(es)—e.g. in a set—as the candidate/new beam RS index(es) for event(s) or event instance(s) evaluation(s), the UE could determine or identify the SSBs corresponding/associated to the SSB index(es) in the set as the actual candidate/new beam RS(s) for event(s) or event instance(s) evaluation(s)
when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, periodic CSI-RS resource configuration index(es)—e.g. in a set—as the potential candidate/new beam RS index(es) for event(s) or event instance(s) evaluation(s), the UE could determine or identify SSB(s) that is QCL'ed (e.g., of QCL-TypeD) with the NZP (periodic) CSI-RS resource(s) or resource configuration(s) corresponding/associated to the periodic CSI-RS resource configuration index(es) in the set as the actual candidate/new beam RS(s) for event(s) or event instance(s) evaluation(s).

According to or following those specified/defined herein in the present disclosure, the (NZP) periodic CSI-RS or CSI-RS resource or resource configuration corresponding/associated to the determined or identified new beam RS index q_new could correspond to CSI-RS(s) or CSI-RS resource(s) or CSI-RS resource configuration(s) provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

According to or following those specified herein in the present disclosure, for Mode A, Mode B and/or Mode C, after (higher layer(s) of) a UE has detected, declared or determined one or more events, the UE could transmit or send to the network a PN message/trigger over/in/by a PUCCH resource of the first UL channel as in Step-1 to (i) request UL grant for PUSCH resource(s) to transmit corresponding beam report(s) as in Step-3 of Mode A and/or Mode C or (ii) notify transmission of corresponding beam report(s) over/in/by higher layer configured PUSCH resource(s) of the second UL channel—associated/linked to the PUCCH resource of the first UL channel as in Step-1—as in Step-2 of Mode B. In this case,
after (higher layer(s) of) a UE has detected, declared or determined the one or more events according to or following those specified herein in the present disclosure, and/or
before the UE transmits or sends to the network a PUCCH (or a PN message/trigger over/in/by a PUCCH resource) of the first UL channel as in Step-1, e.g., before a first or last symbol/slot/etc. of transmission of the PUCCH (or the PN message/trigger over/in/by the PUCCH resource) of the first UL channel as in Step-1, and/or
after the UE has transmitted or sent to the network a PUCCH (or a PN message/trigger over/in/by a PUCCH resource) of the first UL channel as in Step-1, e.g., starting from a last symbol/slot/etc. of transmission of the PUCCH (or the PN message/trigger over/in/by the PUCCH resource) of the first UL channel as in Step-1, and/or
X′ symbol(s)/slot(s)/etc. after the UE has transmitted or sent to the network (e.g., the network 130) a PUCCH (or a PN message/trigger over/in/by a PUCCH resource) of the first UL channel as in Step-1, e.g., X′ symbol(s)/slot(s)/etc. starting from a last symbol/slot/etc. of transmission of the PUCCH (or the PN message/trigger over/in/by the PUCCH resource) of the first UL channel as in Step-1, and/or
within a 1-st time window/duration/gap/offset after the UE has transmitted or sent to the network a PUCCH (or a PN message/trigger over/in/by a PUCCH resource) of the first UL channel as in Step-1, e.g., starting from a last symbol/slot/etc. of transmission of the PUCCH (or the PN message/trigger over/in/by the PUCCH resource) of the first UL channel as in Step-1, and/or
within a 1-st time window/duration/gap/offset X′ symbol(s)/slot(s)/etc. after the UE has transmitted or sent to the network a PUCCH (or a PN message/trigger over/in/by a PUCCH resource) of the first UL channel as in Step-1, e.g., within the 1-st time window/duration/gap/offset X′ symbol(s)/slot(s)/etc. starting from a last symbol/slot/etc. of transmission of the PUCCH (or the PN message/trigger over/in/by the PUCCH resource) of the first UL channel as in Step-1, and/or
(higher layer(s) of) the UE could start a prohibit timer provided or configured by prohibitTimerFirstPUCCH after the UE has transmitted or sent to the network a PUCCH (or a PN message/trigger over/in/by a PUCCH resource) of the first UL channel as in Step-1, e.g., starting from a last symbol/slot/etc. of transmission of the PUCCH (or the PN message/trigger over/in/by the PUCCH resource) of the first UL channel as in Step-1, and before the prohibit timer expires or resets, and/or
(higher layer(s) of) the UE could start a prohibit timer provided or configured by prohibitTimerFirstPUCCH X′ symbol(s)/slot(s)/etc. after the UE has transmitted or sent to the network a PUCCH (or a PN message/trigger over/in/by a PUCCH resource) of the first UL channel as in Step-1, e.g., X′ symbol(s)/slot(s)/etc. starting from a last symbol/slot/etc. of transmission of the PUCCH (or the PN message/trigger over/in/by the PUCCH resource) of the first UL channel as in Step-1, and before the prohibit timer expires or resets, and/or
before the UE receives from the network a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., before a first or last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and/or
after the UE has received a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., starting from a last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and/or
Y′ symbol(s)/slot(s)/etc. after the UE has received a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., Y′ symbol(s)/slot(s)/etc. starting from a last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and/or
within a 2-nd time window/duration/gap/offset after the UE has received a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., starting from a last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and/or
within a 2-nd time window/duration/gap/offset Y′ symbol(s)/slot(s)/etc. after the UE has received a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., within the 2-nd time window/duration/gap/offset Y′ symbol(s)/slot(s)/etc. starting from a last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and/or
(higher layer(s) of) the UE could start a prohibit timer provided or configured by prohibitTimerDCI after the UE has received a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., starting from a last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and before the prohibit timer expires or resets, and/or
(higher layer(s) of) the UE could start a prohibit timer provided or configured by prohibitTimerDCI Y′ symbol(s)/slot(s)/etc. after the UE has received a PDCCH carrying a DCI (e.g., of format 0_0/0_1/0_2) as in Step-2 of Mode A and/or Mode C in response to transmission of a PUCCH (or a PN message/trigger over/in/by a PUCCH resource) of the first UL channel as in Step-1 to provide UL grant for transmitting beam report(s), e.g., Y′ symbol(s)/slot(s)/etc. starting from a last symbol/slot/etc. of reception of the PDCCH carrying the DCI (e.g., of format 0_0/0_1/0_2) as in Step-2 of Mode A and/or Mode C in response to transmission of the PUCCH (or the PN message/trigger over/in/by the PUCCH resource) of the first UL channel as in Step-1 to provide UL grant for transmitting beam report(s), and before the prohibit timer expires or resets, and/or
before the UE transmits or sends to the network a PUSCH (or beam report(s) over/in/by a PUSCH resource) of the second UL channel as in Step-2 of Mode B and/or Step-3 of Mode A and/or Mode C, e.g., before a first or last symbol/slot/etc. of transmission of the PUSCH (or beam report(s) over/in/by the PUSCH resource) of the second UL channel as in Step-2 of Mode B and/or Step-3 of Mode A and/or Mode C, and/or
after the UE has transmitted or sent to the network a PUSCH (or beam report(s) over/in/by a PUSCH resource) of the second UL channel as in Step-2 of Mode B and/or Step-3 of Mode A and/or Mode C, e.g., starting from a last symbol/slot/etc. of transmission of the PUSCH (or beam report(s) over/in/by the PUSCH resource) of the second UL channel as in Step-2 of Mode B and/or Step-3 of Mode A and/or Mode C, and/or
Z′ symbol(s)/slot(s)/etc. after the UE has transmitted or sent to the network a PUSCH (or beam report(s) over/in/by a PUSCH resource) of the second UL channel as in Step-2 of Mode B and/or Step-3 of Mode A and/or Mode C, e.g., Z′ symbol(s)/slot(s)/etc. starting from a last symbol/slot/etc. of transmission of the PUSCH (or beam report(s) over/in/by the PUSCH resource) of the second UL channel as in Step-2 of Mode B and/or Step-3 of Mode A and/or Mode C, and/or
within a 3-rd time window/duration/gap/offset after the UE has transmitted or sent to the network a PUSCH (or beam report(s) over/in/by a PUSCH resource) of the second UL channel as in Step-2 of Mode B and/or Step-3 of Mode A and/or Mode C, e.g., starting from a last symbol/slot/etc. of transmission of the PUSCH (or beam report(s) over/in/by the PUSCH resource) of the second UL channel as in Step-2 of Mode B and/or Step-3 of Mode A and/or Mode C, and/or
within a 3-rd time window/duration/gap/offset Z′ symbol(s)/slot(s)/etc. after the UE has transmitted or sent to the network a PUSCH (or beam report(s) over/in/by a PUSCH resource) of the second UL channel as in Step-2 of Mode B and/or Step-3 of Mode A and/or Mode C, e.g., within the 3-rd time window/duration/gap/offset Z′ symbol(s)/slot(s)/etc. starting from a last symbol/slot/etc. of transmission of the PUSCH (or beam report(s) over/in/by the PUSCH resource) of the second UL channel as in Step-2 of Mode B and/or Step-3 of Mode A and/or Mode C, and/or
(higher layer(s) of) the UE could start a prohibit timer provided or configured by prohibitTimerSecondPUSCH after the UE has transmitted or sent to the network a PUSCH (or beam report(s) over/in/by a PUSCH resource) of the second UL channel as in Step-2 of Mode B and/or Step-3 of Mode A and/or Mode C, e.g., starting from a last symbol/slot/etc. of transmission of the PUSCH (or beam report(s) over/in/by the PUSCH resource) of the second UL channel as in Step-2 of Mode B and/or Step-3 of Mode A and/or Mode C, and before the prohibit timer expires or resets, and/or
(higher layer(s) of) the UE could start a prohibit timer provided or configured by prohibitTimerSecondPUSCH Z′ symbol(s)/slot(s)/etc. after the UE has a PUSCH (or beam report(s) over/in/by a PUSCH resource) of the second UL channel as in Step-2 of Mode B and/or Step-3 of Mode A and/or Mode C, e.g., Z′ symbol(s)/slot(s)/etc. starting from a last symbol/slot/etc. of transmission of the PUSCH (or beam report(s) over/in/by the PUSCH resource) of the second UL channel as in Step-2 of Mode B and/or Step-3 of Mode A and/or Mode C, and before the prohibit timer expires or resets, and/or
after (higher layer(s) of) the UE has declared, detected or determined beam failure(s) for the corresponding cell(s), and/or
V symbol(s)/slot(s)/ms/etc. after (higher layer(s) of) the UE has detected, declared or determined the one or more events according to or following those specified herein in the present disclosure, and/or
within a 4-th time window/duration/gap/offset after (higher layer(s) of) the UE has detected, declared or determined the one or more events according to or following those specified herein in the present disclosure, and/or
within a 4-th time window/duration/gap/offset V symbol(s)/slot(s)/ms/etc. after (higher layer(s) of) the UE has detected, declared or determined the one or more events according to or following those specified herein in the present disclosure, and/or
(higher layer(s) of) the UE could start a prohibit timer provided or configured by prohibitTimerUEIevent after (higher layer(s) of) the UE has detected, declared or determined the one or more events according to or following those specified herein in the present disclosure, and before the prohibit timer expires or resets, and/or
(higher layer(s) of) the UE could start a prohibit timer provided or configured by prohibitTimerUEIevent V symbol(s)/slot(s)/ms/etc. after (higher layer(s) of) the UE has detected, declared or determined the one or more events according to or following those specified herein in the present disclosure, and before the prohibit timer expires or resets, and/or
   when/if one or more of:
the UE has started a beamFailureDetectionTimer, and/or
the beamFailureDetectionTimer has not expired or reset, and/or
(higher layer(s) of) the UE has started a beamFailureRecoveryTimer, and/or
the beamFailureRecoveryTimer has not expired or reset, and/or
the UE has transmitted or sent to the network a LFRI, e.g., after (higher layer(s) of) the UE has declared, detected or determined beam failure(s) for the corresponding cell(s), and/or
(higher layer(s) of) the UE has started a prohibit timer provided or configured by prohibitTimerLFRI after the UE has transmitted or sent to the network a LFRI, and the prohibit timer has not expired or reset, and/or
the UE has received from the network a corresponding BFRR, and/or
(higher layer(s) of) the UE has started a prohibit timer provided or configured by prohibitTimerBFRR after the UE has received from the network the corresponding BFRR, and the prohibit timer has not expired or reset, and/or
the UE has transmitted or sent to the network a LFRR if any, and/or
(higher layer(s) of) the UE has started a prohibit timer provided or configured by prohibitTimerLFRR after the UE has transmitted or sent to the network a LFRR if any, and the prohibit timer has not expired or reset, and/or
(higher layer(s) of) the UE has declared, detected or determined beam failure(s) for the corresponding cell(s), and/or
(higher layer(s) of) the UE has started a prohibit timer provided or configured by prohibitTimerBFRevent after (higher layer(s) of) the UE has declared, detected or determined beam failure(s) for the corresponding cell(s), and the prohibit timer has not expired or reset,
   regarding Mode A, Mode B and/or Mode C,
in one example, (higher layer(s) of) the UE is not expected to or would not declare or detect or determine, or could stop evaluating, assessing, detecting, declaring and/or determining any event(s) and/or event instance(s) according to or following those specified herein in the present disclosure, and/or (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s)
in another example, the UE is not expected to or would not transmit any PUCCH(s) and/or PN message(s)/trigger(s) via/by/in any PUCCH resource(s) of the first UL channel as in Step-1 of Mode A, Mode B and/or Mode C as specified/defined herein in the present disclosure, or the UE could stop or terminate or abandon transmission(s) or re-transmission(s) of any PUCCH(s) and/or PN message(s)/trigger(s) via/by/in any PUCCH resource(s) of the first UL channel as in Step-1 of Mode A, Mode B and/or Mode C as specified/defined herein in the present disclosure, though (higher layer(s) of) the UE may have detected or declared or determined one or more events according to or following those specified/defined herein in the present disclosure
in another example, the UE could transmit a PUCCH and/or a PN message/trigger via/by/in a PUCCH resource of the first UL channel as in Step-1 of Mode A, Mode B and/or Mode C as specified/defined herein in the present disclosure to indicate or inform to the network that the UE would not transmit or send or stop transmitting or sending any beam report(s)—in this case, the PUCCH or the PN message/trigger could be a one-bit indicator set to ‘0’ (or ‘1’) or negative (or positive); when the one-bit PUCCH or PN message/trigger is set to ‘1’ (or ‘0’) or positive (or negative), the UE could (i) request UL grant for PUSCH resource(s) to transmit corresponding beam report(s) as in Step-3 of Mode A and/or Mode C or (ii) notify transmission of corresponding beam report(s) over/in/by higher layer configured PUSCH resource(s) of the second UL channel—associated/linked to the PUCCH resource of the first UL channel as in Step-1—as in Step-2 of Mode B
in another example, the UE is not expected to or would not receive any (downlink/uplink) DCI in response to transmission of PUCCH of the first UL channel as in Step-2 of Mode A and/or Mode C, which provides UL grant, i.e., dynamic grant PUSCH resource(s), for transmitting corresponding beam report(s), or the UE could stop monitoring any PDCCH(s)/PDCCH candidate(s) in respective CORESET(s) that may carry (downlink/uplink) DCI(s) in response to transmission of PUCCH of the first UL channel as in Step-2 of Mode A and/or Mode C, which could provide UL grant, i.e., dynamic grant PUSCH resource(s), for transmitting corresponding beam report(s), though the UE may have transmitted or sent PUCCH(s) and/or PN message(s)/trigger(s) via/by/in PUCCH resource(s) of the first UL channel as in Step-1 of Mode A, Mode B and/or Mode C
in another example, when/if the UE has received a (downlink/uplink) DCI in response to transmission of PUCCH of the first UL channel as in Step-2 of Mode A and/or Mode C, which provides UL grant, i.e., dynamic grant PUSCH resource(s), for transmitting corresponding beam report(s), the UE could ignore the DCI and/or the UL grant
in another example, the UE (e.g., the UE 116) is not expected to or would not transmit any beam report(s), e.g., the UEI beam report(s) as specified/defined herein in the present disclosure, via/by/in any PUSCH resource(s) of the second UL channel as in Step-2 of Mode B and/or Step-3 of Mode A and/or Mode C, or the UE could stop or terminate or abandon transmission(s) or re-transmission(s) of any beam report(s), e.g., the UEI beam report(s) as specified/defined herein in the present disclosure, via/by/in any PUSCH resource(s) of the second UL channel as in Step-2 of Mode B and/or Step-3 of Mode A and/or Mode C, though (1) for Mode A and/or Mode C, the UE may have received a (downlink/uplink) DCI as in Step-2 that provides dynamic grant PUSCH resource(s) for transmitting the beam report(s) as in Step-3, or (2) for Mode B, the UE may have determined or identified a PUSCH resource associated/linked to the PUCCH resource of the first UL channel as in Step-1 used/applied to transmit the corresponding PN message/trigger for transmitting the beam report(s) as in Step-2, according to or following those specified/defined herein in the present disclosure

Here, the UE could determine or identify the value(s) of X, Y, Z, U, X′, Y′, Z′, V (e.g., in terms/form/number of slot(s)/symbol(s)/ms/etc.), duration(s)/length(s) of the prohibit timer(s) prohibitTimerLFRI, prohibitTimerLFRR, prohibitTimerBFRR, prohibitTimerBFRevent, prohibitTimerFirstPUCCH, prohibitTimerDCI, prohibitTimerSecondPUSCH, prohibitTimerUEIevent (e.g., in terms/form/number of slot(s)/symbol(s)/ms/etc.), duration(s)/length(s) of the first time window/duration/gap/offset and/or the second time window/duration/gap/offset and/or the third time window/duration/gap/offset and/or the fourth time window/duration/gap/offset and/or the 1-st time window/duration/gap/offset and/or the 2-nd time window/duration/gap/offset and/or the 3-rd time window/duration/gap/offset and/or the 4-th time window/duration/gap/offset (e.g., in terms/form/number of symbol(s)/slot(s)/ms/etc.) according to or based on: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).

According to or following those specified/defined herein in the present disclosure, the UE may not be expected to or may not transmit any PUCCH(s) and/or PN message(s)/trigger(s) via/by/in any PUCCH resource(s) of the first UL channel as in Step-1 of Mode A, Mode B and/or Mode C as specified/defined herein in the present disclosure, or the UE may stop or terminate or abandon transmission(s) or re-transmission(s) of any PUCCH(s) and/or PN message(s)/trigger(s) via/by/in any PUCCH resource(s) of the first UL channel as in Step-1 of Mode A, Mode B and/or Mode C as specified/defined herein in the present disclosure, for/during a first prohibit time period/window/gap/offset/duration. In this case,
in one example, during the first prohibit time period/window/gap/offset/duration, (higher layer(s) of) the UE is not expected to or would not declare or detect or determine, or could stop evaluating, assessing, detecting, declaring and/or determining any event(s) and/or event instance(s) according to or following those specified herein in the present disclosure,
   for example, (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the first prohibit time period/window/gap/offset/duration; in this case, after the first prohibit time period/window/gap/offset/duration—e.g., starting from a first or last symbol/slot/etc. of the first prohibit time period/window/gap/offset/duration, (higher layer(s) of) the UE could (re-)evaluate or (re-)assess the corresponding event(s) and/or event instance(s) starting from zero count/counting of the corresponding event instance(s) and/or based on or according to or following new timer(s)/time window(s) for evaluating, assessing, detecting, declaring and/or determining event(s) or event instance(s)
   for another example, (higher layer(s) of) the UE may not reset any count(s)/counting(s) of event instance(s), and/or may not reset any corresponding timer(s)/time window(s) for evaluating, assessing, detecting, declaring and/or determining event(s) or event instance(s), e.g. to zero(s); in this case, after the first prohibit time period/window/gap/offset/duration—e.g., starting from a first or last symbol/slot/etc. of the first prohibit time period/window/gap/offset/duration, (higher layer(s) of) the UE could (re-)evaluate or (re-)assess the corresponding event(s) and/or event instance(s) starting from the number(s) of count(s)/counting(s) of the corresponding event instance(s) and/or based on/according to the corresponding timer(s)/time window(s) for evaluating, assessing, detecting, declaring and/or determining event(s) or event instance(s) determined or detected or evaluated or assessed before the first prohibit time period/window/gap/offset/duration (e.g., before a first or last symbol/slot/etc. of the first prohibit time period/window/gap/offset/duration)

The UE could determine or identify whether or not (higher layer(s) of) the UE could reset the count(s)/counting(s) of event instance(s), and/or corresponding timer(s)/time window(s) for evaluating, assessing, detecting, declaring and/or determining event(s) or event instance(s) starting from a first or last symbol/slot/etc. of or during the first prohibit time period/window/gap/offset/duration according to or based on or following: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).
for example, the UE could receive from the network a higher layer RRC signalling/parameter denoted by eventEvaluation, e.g., via/in/by higher layer RRC signalling(s)/parameter(s) e.g. CSI-ReportConfig and/or UEI-ReportConfig that provides or configures necessary information/setting(s) for the UE-initiated/event-driven beam reporting as specified/defined herein in the present disclosure. For this design example, when/if eventEvaluation is set to ‘enabled’ (or ‘disabled), (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the first prohibit time period/window/gap/offset/duration according to or following those specified/defined herein in the present disclosure; otherwise, i.e., when/if eventEvaluation is set to ‘disabled’ (or ‘enabled), (higher layer(s) of) the UE may not reset any count(s)/counting(s) of event instance(s) and/or any corresponding timer(s)/time window(s) for evaluating, assessing, detecting, declaring and/or determining event(s) or event instance(s) determined, assessed or evaluated before the first prohibit time period/window/gap/offset/duration, e.g., before a first or last symbol/slot/etc. of the first prohibit time period/window/gap/offset/duration according to or following those specified/defined herein in the present disclosure
for another example, when/if the duration/length/value/number of the first prohibit time period/window/gap/offset/duration is greater than or equal to a threshold, (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the first prohibit time period/window/gap/offset/duration according to or following those specified/defined herein in the present disclosure; otherwise, i.e., when/if the duration/length/value/number of the first prohibit time period/window/gap/offset/duration is less than or equal to the threshold, (higher layer(s) of) the UE may not reset any count(s)/counting(s) of event instance(s) and/or any corresponding timer(s)/time window(s) for evaluating, assessing, detecting, declaring and/or determining event(s) or event instance(s) determined, assessed or evaluated before the first prohibit time period/window/gap/offset/duration, e.g., before a first or last symbol/slot/etc. of the first prohibit time period/window/gap/offset/duration according to or following those specified/defined herein in the present disclosure. In this case, the UE could determine or identify the value(s) of the threshold according to or based on or following: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).
In another example, during the first prohibit time period/window/gap/offset/duration, (higher layer(s) of) the UE could continue evaluating, assessing, detecting, declaring and/or determining event(s) and/or event instance(s) according to or following those specified herein in the present disclosure.

Optionally,
In one example, the first prohibit time period/window/gap/offset/duration could correspond to or could be represented/denoted by or referred to as a first prohibit timer associated with or with respect to transmission(s) of PUCCH(s) and/or PN message(s)/trigger(s) via/by/in PUCCH resource(s) of the first UL channel as in Step-1 of Mode A, Mode B and/or Mode C as specified/defined herein in the present disclosure. The UE could start the first prohibit timer after transmitting the PUCCH(s) and/or PN message(s)/trigger(s) via/by/in PUCCH resource(s) of the first UL channel as in Step-1 of Mode A, Mode B and/or Mode C as specified/defined herein in the present disclosure—e.g., after a first or last symbol/slot/etc. of transmission(s) of the PUCCH(s) and/or PN message(s)/trigger(s) via/by/in PUCCH resource(s) of the first UL channel as in Step-1 of Mode A, Mode B and/or Mode C as specified/defined herein in the present disclosure
In another example, the first prohibit time period/window/gap/offset/duration could correspond to or could be represented/denoted by or referred to as a second prohibit timer associated with or with respect to reception(s) of the PDCCH(s)/PDCCH candidate(s) in respective CORESET(s) carrying the (downlink/uplink) DCI(s), e.g., of format 0_0/0_1/0_2, as in Step-2 of Mode A and/or Mode C in response to transmission(s) of the PUCCH(s) or the PN message(s)/trigger(s) over/in/by the PUCCH resource(s) of the first UL channel as in Step-1 to provide UL grant, i.e., dynamic grant PUSCH resource(s), for transmitting beam report(s). The UE could start the second prohibit timer after receiving the PDCCH(s)/PDCCH candidate(s) in respective CORESET(s) carrying the (downlink/uplink) DCI(s), e.g., of format 0_0/0_1/0_2, as in Step-2 of Mode A and/or Mode C in response to transmission(s) of the PUCCH(s) or the PN message(s)/trigger(s) over/in/by the PUCCH resource(s) of the first UL channel as in Step-1 to provide UL grant, i.e., dynamic grant PUSCH resource(s), for transmitting beam report(s)—e.g., after a first or last symbol/slot/etc. of the reception(s) of the PDCCH(s)/PDCCH candidate(s) in respective CORESET(s) carrying the (downlink/uplink) DCI(s), e.g., of format 0_0/0_1/0_2, as in Step-2 of Mode A and/or Mode C in response to transmission(s) of the PUCCH(s) or the PN message(s)/trigger(s) over/in/by the PUCCH resource(s) of the first UL channel as in Step-1 to provide UL grant, i.e., dynamic grant PUSCH resource(s), for transmitting beam report(s)
In another example, the first prohibit time period/window/gap/offset/duration could correspond to or could be represented/denoted by or referred to as a third prohibit timer associated with or with respect to transmission(s) of beam report(s), e.g., the UEI beam report(s) as specified/defined herein in the present disclosure, via/by/in (DG/CG) PUSCH resource(s) of the second UL channel as in Step-2 of Mode B and/or Step-3 of Mode A and/or Mode C. The UE could start the third prohibit timer after transmitting beam report(s), e.g., the UEI beam report(s) as specified/defined herein in the present disclosure, via/by/in (DG/CG) PUSCH resource(s) of the second UL channel as in Step-2 of Mode B and/or Step-3 of Mode A and/or Mode C—e.g., after a first or last symbol/slot/etc. of the transmission(s) of the beam report(s), e.g., the UEI beam report(s) as specified/defined herein in the present disclosure, via/by/in (DG/CG) PUSCH resource(s) of the second UL channel as in Step-2 of Mode B and/or Step-3 of Mode A and/or Mode C.

The UE could be provided or configured by the network e.g. via higher layer RRC signalling(s)/parameter(s) the first, second and/or third prohibit timer(s) and/or duration(s)/length(s)/number(s)/value(s) of the first, second and/or third prohibit timer(s) as specified/defined herein in the present disclosure. Here, when/if the first, second and/or third prohibit timer(s) is/are running, the UE may not be expected to or may not transmit any PUCCH(s) and/or PN message(s)/trigger(s) via/by/in any PUCCH resource(s) of the first UL channel as in Step-1 of Mode A, Mode B and/or Mode C as specified/defined herein in the present disclosure, or the UE may stop or terminate or abandon transmission(s) or re-transmission(s) of any PUCCH(s) and/or PN message(s)/trigger(s) via/by/in any PUCCH resource(s) of the first UL channel as in Step-1 of Mode A, Mode B and/or Mode C as specified/defined herein in the present disclosure; otherwise, i.e., when/if the first, second and/or third prohibit timer(s) is/are not running, the UE could transmit or send to the network PUCCH(s) and/or PN message(s)/trigger(s) over/in/by PUCCH resource(s) of the first UL channel as in Step-1 to (i) request UL grant for PUSCH resource(s) to transmit corresponding beam report(s) as in Step-3 of Mode A and/or Mode C or (ii) notify transmission of corresponding beam report(s) over/in/by higher layer configured PUSCH resource(s) of the second UL channel—associated/linked to the PUCCH resource(s) of the first UL channel as in Step-1—as in Step-2 of Mode B.

According to or following those specified/defined herein in the present disclosure, the UE may not be expected to or may not receive any (downlink/uplink) DCI in response to transmission of PUCCH of the first UL channel as in Step-2 of Mode A and/or Mode C, which provides UL grant, i.e., dynamic grant PUSCH resource(s), for transmitting corresponding beam report(s), or the UE may stop monitoring any PDCCH(s)/PDCCH candidate(s) in respective CORESET(s) that may carry (downlink/uplink) DCI(s) in response to transmission of PUCCH of the first UL channel as in Step-2 of Mode A and/or Mode C, which could provide UL grant, i.e., dynamic grant PUSCH resource(s), for transmitting corresponding beam report(s), for/during a second prohibit time period/window/gap/offset/duration. In this case,
in one example, during the second prohibit time period/window/gap/offset/duration, (higher layer(s) of) the UE is not expected to or would not declare or detect or determine, or could stop evaluating, assessing, detecting, declaring and/or determining any event(s) and/or event instance(s) according to or following those specified herein in the present disclosure,
   for example, (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the second prohibit time period/window/gap/offset/duration; in this case, after the second prohibit time period/window/gap/offset/duration—e.g., starting from a first or last symbol/slot/etc. of the second prohibit time period/window/gap/offset/duration, (higher layer(s) of) the UE could (re-)evaluate or (re-)assess the corresponding event(s) and/or event instance(s) starting from zero count/counting of the corresponding event instance(s) and/or based on or according to or following new timer(s)/time window(s) for evaluating, assessing, detecting, declaring and/or determining event(s) or event instance(s)
   for another example, (higher layer(s) of) the UE may not reset any count(s)/counting(s) of event instance(s), and/or may not reset any corresponding timer(s)/time window(s) for evaluating, assessing, detecting, declaring and/or determining event(s) or event instance(s), e.g. to zero(s); in this case, after the second prohibit time period/window/gap/offset/duration—e.g., starting from a first or last symbol/slot/etc. of the second prohibit time period/window/gap/offset/duration, (higher layer(s) of) the UE could (re-)evaluate or (re-)assess the corresponding event(s) and/or event instance(s) starting from the number(s) of count(s)/counting(s) of the corresponding event instance(s) and/or based on/according to the corresponding timer(s)/time window(s) for evaluating, assessing, detecting, declaring and/or determining event(s) or event instance(s) determined or detected or evaluated or assessed before the second prohibit time period/window/gap/offset/duration (e.g., before a first or last symbol/slot/etc. of the second prohibit time period/window/gap/offset/duration)

The UE could determine or identify whether or not (higher layer(s) of) the UE could reset the count(s)/counting(s) of event instance(s), and/or corresponding timer(s)/time window(s) for evaluating, assessing, detecting, declaring and/or determining event(s) or event instance(s) starting from a first or last symbol/slot/etc. of or during the second prohibit time period/window/gap/offset/duration according to or based on or following: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).
for example, the UE could receive from the network a higher layer RRC signalling/parameter denoted by eventEvaluation, e.g., via/in/by higher layer RRC signalling(s)/parameter(s) e.g. CSI-ReportConfig and/or UEI-ReportConfig that provides or configures necessary information/setting(s) for the UE-initiated/event-driven beam reporting as specified/defined herein in the present disclosure. For this design example, when/if eventEvaluation is set to ‘enabled’ (or ‘disabled), (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the second prohibit time period/window/gap/offset/duration according to or following those specified/defined herein in the present disclosure; otherwise, i.e., when/if eventEvaluation is set to ‘disabled’ (or ‘enabled), (higher layer(s) of) the UE may not reset any count(s)/counting(s) of event instance(s) and/or any corresponding timer(s)/time window(s) for evaluating, assessing, detecting, declaring and/or determining event(s) or event instance(s) determined, assessed or evaluated before the second prohibit time period/window/gap/offset/duration, e.g., before a first or last symbol/slot/etc. of the second prohibit time period/window/gap/offset/duration according to or following those specified/defined herein in the present disclosure
for another example, when/if the duration/length/value/number of the second prohibit time period/window/gap/offset/duration is greater than or equal to a threshold, (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the second prohibit time period/window/gap/offset/duration according to or following those specified/defined herein in the present disclosure; otherwise, i.e., when/if the duration/length/value/number of the second prohibit time period/window/gap/offset/duration is less than or equal to the threshold, (higher layer(s) of) the UE may not reset any count(s)/counting(s) of event instance(s) and/or any corresponding timer(s)/time window(s) for evaluating, assessing, detecting, declaring and/or determining event(s) or event instance(s) determined, assessed or evaluated before the second prohibit time period/window/gap/offset/duration, e.g., before a first or last symbol/slot/etc. of the second prohibit time period/window/gap/offset/duration according to or following those specified/defined herein in the present disclosure. In this case, the UE could determine or identify the value(s) of the threshold according to or based on or following: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).
In another example, during the second prohibit time period/window/gap/offset/duration, (higher layer(s) of) the UE could continue evaluating, assessing, detecting, declaring and/or determining event(s) and/or event instance(s) according to or following those specified herein in the present disclosure. In this case, e.g., even during the second prohibit time period/window/gap/offset/duration, when/if or after (higher layer(s) of) the UE has detected, declared or determined one or more events according to or following those specified/defined herein in the present disclosure, the UE could transmit or send to the network a PN message/trigger over/in/by a PUCCH resource of the first UL channel as in Step-1 to (i) request UL grant for PUSCH resource(s) to transmit corresponding beam report(s) as in Step-3 of Mode A and/or Mode C or (ii) notify transmission of corresponding beam report(s) over/in/by higher layer configured PUSCH resource(s) of the second UL channel—associated/linked to the PUCCH resource of the first UL channel as in Step-1—as in Step-2 of Mode B.

According to or following those specified/defined herein in the present disclosure, the UE may not be expected to or may not transmit any beam report(s), e.g., the UEI beam report(s) as specified/defined herein in the present disclosure, via/by/in any PUSCH resource(s) of the second UL channel as in Step-2 of Mode B and/or Step-3 of Mode A and/or Mode C, or the UE may stop or terminate or abandon transmission(s) or re-transmission(s) of any beam report(s), e.g., the UEI beam report(s) as specified/defined herein in the present disclosure, via/by/in any PUSCH resource(s) of the second UL channel as in Step-2 of Mode B and/or Step-3 of Mode A and/or Mode C, for/during a third prohibit time period/window/gap/offset/duration. In this case,
in one example, during the third prohibit time period/window/gap/offset/duration, (higher layer(s) of) the UE is not expected to or would not declare or detect or determine, or could stop evaluating, assessing, detecting, declaring and/or determining any event(s) and/or event instance(s) according to or following those specified herein in the present disclosure,
   for example, (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the third prohibit time period/window/gap/offset/duration; in this case, after the third prohibit time period/window/gap/offset/duration—e.g., starting from a first or last symbol/slot/etc. of the third prohibit time period/window/gap/offset/duration, (higher layer(s) of) the UE could (re-)evaluate or (re-)assess the corresponding event(s) and/or event instance(s) starting from zero count/counting of the corresponding event instance(s) and/or based on or according to or following new timer(s)/time window(s) for evaluating, assessing, detecting, declaring and/or determining event(s) or event instance(s)
   for another example, (higher layer(s) of) the UE may not reset any count(s)/counting(s) of event instance(s), and/or may not reset any corresponding timer(s)/time window(s) for evaluating, assessing, detecting, declaring and/or determining event(s) or event instance(s), e.g. to zero(s); in this case, after the third prohibit time period/window/gap/offset/duration—e.g., starting from a first or last symbol/slot/etc. of the third prohibit time period/window/gap/offset/duration, (higher layer(s) of) the UE could (re-)evaluate or (re-)assess the corresponding event(s) and/or event instance(s) starting from the number(s) of count(s)/counting(s) of the corresponding event instance(s) and/or based on/according to the corresponding timer(s)/time window(s) for evaluating, assessing, detecting, declaring and/or determining event(s) or event instance(s) determined or detected or evaluated or assessed before the third prohibit time period/window/gap/offset/duration (e.g., before a first or last symbol/slot/etc. of the third prohibit time period/window/gap/offset/duration)

The UE could determine or identify whether or not (higher layer(s) of) the UE could reset the count(s)/counting(s) of event instance(s), and/or corresponding timer(s)/time window(s) for evaluating, assessing, detecting, declaring and/or determining event(s) or event instance(s) starting from a first or last symbol/slot/etc. of or during the third prohibit time period/window/gap/offset/duration according to or based on or following: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).
for example, the UE could receive from the network a higher layer RRC signalling/parameter denoted by eventEvaluation, e.g., via/in/by higher layer RRC signalling(s)/parameter(s) e.g. CSI-ReportConfig and/or UEI-ReportConfig that provides or configures necessary information/setting(s) for the UE-initiated/event-driven beam reporting as specified/defined herein in the present disclosure. For this design example, when/if eventEvaluation is set to ‘enabled’ (or ‘disabled), (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the third prohibit time period/window/gap/offset/duration according to or following those specified/defined herein in the present disclosure; otherwise, i.e., when/if eventEvaluation is set to ‘disabled’ (or ‘enabled), (higher layer(s) of) the UE may not reset any count(s)/counting(s) of event instance(s) and/or any corresponding timer(s)/time window(s) for evaluating, assessing, detecting, declaring and/or determining event(s) or event instance(s) determined, assessed or evaluated before the third prohibit time period/window/gap/offset/duration, e.g., before a first or last symbol/slot/etc. of the third prohibit time period/window/gap/offset/duration according to or following those specified/defined herein in the present disclosure
for another example, when/if the duration/length/value/number of the third prohibit time period/window/gap/offset/duration is greater than or equal to a threshold, (higher layer(s) of) the UE could reset count(s)/counting(s) of event instance(s), and/or reset the corresponding timer(s)/time window(s) for evaluating, assessing, detecting, declaring and/or determining event(s) or event instance(s), e.g. to zero(s), e.g. starting from a first or last symbol/slot/etc. of the third prohibit time period/window/gap/offset/duration according to or following those specified/defined herein in the present disclosure; otherwise, i.e., when/if the duration/length/value/number of the third prohibit time period/window/gap/offset/duration is less than or equal to the threshold, (higher layer(s) of) the UE may not reset any count(s)/counting(s) of event instance(s) and/or any corresponding timer(s)/time window(s) for evaluating, assessing, detecting, declaring and/or determining event(s) or event instance(s) determined, assessed or evaluated before the third prohibit time period/window/gap/offset/duration, e.g., before a first or last symbol/slot/etc. of the third prohibit time period/window/gap/offset/duration according to or following those specified/defined herein in the present disclosure. In this case, the UE could determine or identify the value(s) of the threshold according to or based on or following: (i) fixed value(s)/rule(s) in system specification(s) and/or per RRC (re-)configuration, (ii) network's configuration(s)/indication(s), e.g., via/by/in higher layer RRC signalling(s)/parameter(s) and/or MAC CE command(s) and/or dynamic DCI based L1 signaling(s) based on or according to a corresponding UE's capability or capability signalling, and/or (iii) UE's autonomous determination or selection or decision, which could be further sent to the network via various UL channels/signals including UE's capability signalling(s) and/or (UEI) beam/CSI report(s).
In another example, during the third prohibit time period/window/gap/offset/duration, (higher layer(s) of) the UE could continue evaluating, assessing, detecting, declaring and/or determining event(s) and/or event instance(s) according to or following those specified herein in the present disclosure. In this case, e.g., even during the third prohibit time period/window/gap/offset/duration, when/if or after (higher layer(s) of) the UE has detected, declared or determined one or more events according to or following those specified/defined herein in the present disclosure, the UE could transmit or send to the network a PN message/trigger over/in/by a PUCCH resource of the first UL channel as in Step-1 to (i) request UL grant for PUSCH resource(s) to transmit corresponding beam report(s) as in Step-3 of Mode A and/or Mode C or (ii) notify transmission of corresponding beam report(s) over/in/by higher layer configured PUSCH resource(s) of the second UL channel—associated/linked to the PUCCH resource of the first UL channel as in Step-1—as in Step-2 of Mode B.

For a UE configured with a CSI-ReportConfig with eventType-r19 for periodic reference signals with the same periodicity configured by the newBeamResourceSet-r19 and with dl-OrJointTCI-StateList or ul-TCI-StateList and without eventDetectionTimeWindowLength-r19 (or eventDetectionTimeWindowLength-r19 not provided), when an event instance is determined,
for a reference signal configured by the newBeamResourceSet-r19, if eventType-r19 is set to ‘event2’ or ‘event7’, or
for the reference signal in the indicated TCI state or the SS/PBCH block which is QCLed with the reference signal in the indicated TCI, if eventType-r19 is set to ‘event1’,
   the UE transmits PUCCH format 0 or format 1 in (the earlies transmission occasion of) the PUCCH resource configured by PUCCHResource-r19 in the CSI-ReportConfig, e.g., at least T_proc (a fixed value in system specification(s) and/or per RRC (re-)configuration(s) e.g. in unit of symbol(s)/slot(s)/etc., or configured by the network e.g. in the CSI-ReportConfig subject to a corresponding UE's capability) after (the start/end of) determination of the event instance, and/or the event instance is determined no later than T_proc before or prior to (the earlies transmission occasion of) the PUCCH resource—here, the PUCCH/PUCCH resource can be referred to as specific, associated or corresponding to the event evaluation or determination.

For a UE configured with a CSI-ReportConfig with eventType-r19 for periodic reference signals with the same periodicity configured by the newBeamResourceSet-r19 and with dl-OrJointTCI-StateList or ul-TCI-StateList with eventDetectionTimeWindowLength-r19 (or eventDetectionTimeWindowLength-r19 provided), when an event instance is determined,
for a reference signal configured by the newBeamResourceSet-r19, if eventType-r19 is set to ‘event2’ or event7′, or
for the reference signal in the indicated TCI state or the SS/PBCH block which is QCLed with the reference signal in the indicated TCI, if eventType-r19 is set to ‘event1’,
   in one example, if eventDetectionTimeWindowLength-r19 is provided, the UE starts or determines a time window for such reference signal (denoted by/as a/the first reference signal)
for example, at the beginning of or from the first transmission occasion of such reference signal (or the first reference signal) that determines the event instance,
for another example, at the beginning of or from a transmission occasion of a second reference signal (as defined/specified herein in the present disclosure) that is associated, specific or corresponding to the first transmission occasion of such reference signal (or the first reference signal) that determines the event instance,
for another example, at the beginning of or from (1) the first transmission occasion of such reference signal (or the first reference signal) that determines the event instance or (2) a transmission occasion of a second reference signal (as defined/specified herein in the present disclosure) that is associated, specific or corresponding to the first transmission occasion of such reference signal (or the first reference signal) that determines the event instance that starts (or ends) later/the latest (or earlier/the earliest) in time,
for another example, at the beginning of or from the last/first transmission occasion or the transmission occasion that ends (or starts) the latest/earliest in time among candidate transmission occasions of (all) the reference signals configured by the newBeamResourceSet-r19, wherein any two of the candidate transmission occasions has a time gap/interval/offset smaller than (or equal to) the periodicity of the reference signals configured by the newBeamResourceSet-r19, and the candidate transmission occasions comprise, contain or include the first transmission occasion of such reference signal (or the first reference signal) that determines the event instance,
for another example, at the beginning of or from the last/first transmission occasion or the transmission occasion that ends (or starts) the latest/earliest in time among candidate transmission occasions of a second reference signal and (all) the reference signals configured by the newBeamResourceSet-r19, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of such reference signal (or the first reference signal) that determines the event instance and a/the transmission occasion of the second reference signal that is associated, specific or corresponding to the first transmission occasion of such reference signal (or the first reference signal) that determines the event instance.
for another example, at the beginning of or from the last/first transmission occasion or the transmission occasion that ends (or starts) the latest/earliest in time among the first (candidate) transmission occasions of (one or more of all) the reference signals configured by the newBeamResourceSet-r19 each determines an event instance, wherein any two of the first (candidate) transmission occasions has a time gap/interval/offset smaller than (or equal to) the periodicity of the reference signals configured by the newBeamResourceSet-r19, and the first (candidate) transmission occasions comprise, contain or include the first transmission occasion of aforementioned such reference signal (or the aforementioned first reference signal) that determines the aforementioned event instance,
for another example, at the beginning of or from the last/first transmission occasion or the transmission occasion that ends (or starts) the latest/earliest in time among candidate transmission occasions comprising a/the transmission occasion of a second reference signal and the first (candidate) transmission occasions of (one or more of all) the reference signals configured by the newBeamResourceSet-r19 each determines an event instance, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of aforementioned such reference signal (or the aforementioned first reference signal) that determines the aforementioned event instance and a/the transmission occasion of the second reference signal that is associated, specific or corresponding to the first transmission occasion of such reference signal (or the first reference signal) that determines the event instance,
   wherein the time window does not overlap (e.g., in time or time domain) with other time windows for such reference signal. When the number of event instances determined for such reference signal within the time window, if eventDetectionTimeWindowLength-r19 is provided, is greater than or equal to 1 or to eventInstanceCount-r19, if provided, which can be referred to as satisfying the corresponding event or event condition(s) wherein the event is provided by eventType-r19, the UE transmits PUCCH format 0 or format 1 in (the earlies transmission occasion of) the PUCCH resource configured by PUCCHResource-r19 in the CSI-ReportConfig, e.g., at least T_proc (a fixed value in system specification(s) and/or per RRC (re-)configuration(s) e.g. in unit of symbol(s)/slot(s)/etc., or configured by the network (e.g., the network 130) e.g. in the CSI-ReportConfig subject to a corresponding UE's capability) after the end/start of the time window, and/or the time window ends no later than T_proc before or prior to (the earlies transmission occasion of) the PUCCH resource—here, the PUCCH/PUCCH resource can be referred to as specific, associated or corresponding to the event evaluation or determination. In addition,
when/if eventType-r19 is set to ‘event2’ or ‘event7’, and/or when/if the first transmission occasion of such reference signal (or the first reference signal) that determines the event instance starts (or ends) later in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples described herein to determine the time window for such reference signal (or the first reference signal), and/or
when/if eventType-r19 is set to ‘event2’ or ‘event7’, and/or when/if the first transmission occasion of such reference signal (or the first reference signal) that determines the event instance starts (or ends) earlier in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples described herein to determine the time window for such reference signal (or the first reference signal);

The counting of the event instances for such reference signal could be (re-)started if the reference signal in the indicated TCI state or the SS/PBCH block which is QCLed with the reference signal in the indicated TCI state is updated. In another example, if eventDetectionTimeWindowLength-r19 is provided, the UE
starts a timer for such reference signal (denoted by/as a/the first reference signal)
   for example, at the beginning of or from the first transmission occasion of such reference signal (or the first reference signal) that determines the event instance,
   for another example, at the beginning of or from a transmission occasion of a second reference signal (as defined/specified herein in the present disclosure) that is associated, specific or corresponding to the first transmission occasion of such reference signal (or the first reference signal) that determines the event instance,
   for another, at the beginning of or from (1) the first transmission occasion of such reference signal (or the first reference signal) that determines the event instance or (2) a transmission occasion of a second reference signal (as defined/specified herein in the present disclosure) that is associated, specific or corresponding to the first transmission occasion of such reference signal (or the first reference signal) that determines the event instance that starts (or ends) later/the latest (or earlier/the earliest) in time,
   for another example, at the beginning of or from the last/first transmission occasion or the transmission occasion that ends (or starts) the latest/earliest in time among candidate transmission occasions of (all) the reference signals configured by the newBeamResourceSet-r19, wherein any two of the candidate transmission occasions has a time gap/interval/offset smaller than (or equal to) the periodicity of the reference signals configured by the newBeamResourceSet-r19, and the candidate transmission occasions comprise, contain or include the first transmission occasion of such reference signal (or the first reference signal) that determines the event instance,
   for another example, at the beginning of or from the last/first transmission occasion or the transmission occasion that ends (or starts) the latest/earliest in time among candidate transmission occasions of a second reference signal and (all) the reference signals configured by the newBeamResourceSet-r19, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of such reference signal (or the first reference signal) that determines the event instance and a/the transmission occasion of the second reference signal that is associated, specific or corresponding to the first transmission occasion of such reference signal (or the first reference signal) that determines the event instance.
   for another example, at the beginning of or from the last/first transmission occasion or the transmission occasion that ends (or starts) the latest/earliest in time among the first (candidate) transmission occasions of (one or more of all) the reference signals configured by the newBeamResourceSet-r19 each determines an event instance, wherein any two of the first (candidate) transmission occasions has a time gap/interval/offset smaller than (or equal to) the periodicity of the reference signals configured by the newBeamResourceSet-r19, and the first (candidate) transmission occasions comprise, contain or include the first transmission occasion of aforementioned such reference signal (or the aforementioned first reference signal) that determines the aforementioned event instance,
   for another example, at the beginning of or from the last/first transmission occasion or the transmission occasion that ends (or starts) the latest/earliest in time among candidate transmission occasions comprising a/the transmission occasion of a second reference signal and the first (candidate) transmission occasions of (one or more of all) the reference signals configured by the newBeamResourceSet-r19 each determines an event instance, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of aforementioned such reference signal (or the aforementioned first reference signal) that determines the aforementioned event instance and a/the transmission occasion of the second reference signal that is associated, specific or corresponding to the first transmission occasion of such reference signal (or the first reference signal) that determines the event instance,
and/or sets the counter for such reference signal (or the first reference signal) to 1, if the timer is not running; and/or
increments the counter for such reference signal by 1 if the timer is already running.

If the timer is running and the counter for such reference signal is greater than or equal to eventInstanceCount-r19 (the UE could stop the timer and/or before the timer is expired), the UE transmits PUCCH format 0 or format 1 in the PUCCH resource configured by PUCCHResource-r19 in the CSI-ReportConfig, e.g., at least T_proc (a fixed value in system specification(s) and/or per RRC (re-)configuration(s) e.g. in unit of symbol(s)/slot(s)/etc., or configured by the network e.g. in the CSI-ReportConfig subject to a corresponding UE's capability) after the end/expiration of the timer (e.g., the timer is stopped or expired), and/or the stoppage or expiration of the timer is no later than T_proc before or prior to (the earlies transmission occasion of) the PUCCH resource—here, the PUCCH/PUCCH resource can be referred to as specific, associated or corresponding to the event evaluation or determination. In addition, a/the timer is running until a symbol/slot/etc. eventDetectionTimeWindowLength-r19 after the start of the timer
when/if eventType-r19 is set to ‘event2’ or ‘event7’, and/or when/if the first transmission occasion of such reference signal (or the first reference signal) that determines the event instance starts (or ends) later in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples described herein to start a/the timer for such reference signal (or the first reference signal), and/or
when/if eventType-r19 is set to ‘event2’ or ‘event7’, and/or when/if the first transmission occasion of such reference signal (or the first reference signal) that determines the event instance starts (or ends) earlier in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples described herein to start a/the timer for such reference signal (or the first reference signal);

The counter of the event instances for such reference signal is reset to zero and the timer for such reference signal is stopped:
if the reference signal in the indicated TCI state or the SS/PBCH block which is QCLed with the reference signal in the indicated TCI state is updated. In another example, if eventDetectionTimeWindowLength-r19 is provided, the UE starts a timer for such reference signal (denoted by/as a/the first reference signal)
for example, at the beginning of or from the first transmission occasion of such reference signal (or the first reference signal) that determines the event instance,
for another example, at the beginning of or from a transmission occasion of a second reference signal (as defined/specified herein in the present disclosure) that is associated, specific or corresponding to the first transmission occasion of such reference signal (or the first reference signal) that determines the event instance,
for another example, at the beginning of or from (1) the first transmission occasion of such reference signal (or the first reference signal) that determines the event instance or (2) a transmission occasion of a second reference signal (as defined/specified herein in the present disclosure) that is associated, specific or corresponding to the first transmission occasion of such reference signal (or the first reference signal) that determines the event instance that starts (or ends) later/the latest (or earlier/the earliest) in time,
for another example, at the beginning of or from the last/first transmission occasion or the transmission occasion that ends (or starts) the latest/earliest in time among candidate transmission occasions of (all) the reference signals configured by the newBeamResourceSet-r19, wherein any two of the candidate transmission occasions has a time gap/interval/offset smaller than (or equal to) the periodicity of the reference signals configured by the newBeamResourceSet-r19, and the candidate transmission occasions comprise, contain or include the first transmission occasion of such reference signal (or the first reference signal) that determines the event instance,
for another example, at the beginning of or from the last/first transmission occasion or the transmission occasion that ends (or starts) the latest/earliest in time among candidate transmission occasions of a second reference signal and (all) the reference signals configured by the newBeamResourceSet-r19, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of such reference signal (or the first reference signal) that determines the event instance and a/the transmission occasion of the second reference signal that is associated, specific or corresponding to the first transmission occasion of such reference signal (or the first reference signal) that determines the event instance.
for another example, at the beginning of or from the last/first transmission occasion or the transmission occasion that ends (or starts) the latest/earliest in time among the first (candidate) transmission occasions of (one or more of all) the reference signals configured by the newBeamResourceSet-r19 each determines an event instance, wherein any two of the first (candidate) transmission occasions has a time gap/interval/offset smaller than (or equal to) the periodicity of the reference signals configured by the newBeamResourceSet-r19, and the first (candidate) transmission occasions comprise, contain or include the first transmission occasion of aforementioned such reference signal (or the aforementioned first reference signal) that determines the aforementioned event instance,
for another example, at the beginning of or from the last/first transmission occasion or the transmission occasion that ends (or starts) the latest/earliest in time among candidate transmission occasions comprising a/the transmission occasion of a second reference signal and the first (candidate) transmission occasions of (one or more of all) the reference signals configured by the newBeamResourceSet-r19 each determines an event instance, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of aforementioned such reference signal (or the aforementioned first reference signal) that determines the aforementioned event instance and a/the transmission occasion of the second reference signal that is associated, specific or corresponding to the first transmission occasion of such reference signal (or the first reference signal) that determines the event instance,
   and/or ends/expires in/at a symbol/slot/etc. eventDetectionTimeWindowLength-r19 after the start of the timer, if a/the (or another) timer for such reference signal is not running; if the timer is running and the number of event instances determined for such reference signal is greater than or equal to eventInstanceCount-r19 (the UE could stop the timer and/or before the timer is expired), the UE transmits PUCCH format 0 or format 1 in the PUCCH resource configured by PUCCHResource-r19 in the CSI-ReportConfig, e.g., at least T_proc (a fixed value in system specification(s) and/or per RRC (re-)configuration(s) e.g. in unit of symbol(s)/slot(s)/etc., or configured by the network e.g. in the CSI-ReportConfig subject to a corresponding UE's capability) after the end/expiration of the timer (e.g., the timer is stopped or expired), and/or the stoppage or expiration of the timer is no later than T_proc before or prior to (the earlies transmission occasion of) the PUCCH resource—here, the PUCCH/PUCCH resource can be referred to as specific, associated or corresponding to the event evaluation or determination. In addition,
when/if eventType-r19 is set to ‘event2’ or ‘event7’, and/or when/if the first transmission occasion of such reference signal (or the first reference signal) that determines the event instance starts (or ends) later in time than a transmission occasion of a second reference signal (as defined/specified herein in the present disclosure) that is associated, specific or corresponding to the first transmission occasion of such reference signal (or the first reference signal) that determines the event instance, the UE (e.g., the UE 116) could follow those specified/defined in one or more examples described herein to start a/the timer for such reference signal (or the first reference signal), and/or
when/if eventType-r19 is set to ‘event2’ or ‘event7’, and/or when/if the first transmission occasion of such reference signal (or the first reference signal) that determines the event instance starts (or ends) earlier in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples described herein to start a/the timer for such reference signal (or the first reference signal);

The counting of the event instances for such reference signal could be (re-)started if the reference signal in the indicated TCI state or the SS/PBCH block which is QCLed with the reference signal in the indicated TCI state is updated. In another example, if eventDetectionTimeWindowLength-r19 is provided, the UE starts a timer for such reference signal (denoted by/as a/the first reference signal)
for example, at the beginning of or from the first transmission occasion of such reference signal (or the first reference signal) that determines the event instance,
for another example, at the beginning of or from a transmission occasion of a second reference signal (as defined/specified herein in the present disclosure) that is associated, specific or corresponding to the first transmission occasion of such reference signal (or the first reference signal) that determines the event instance,
for another example, at the beginning of or from (1) the first transmission occasion of such reference signal (or the first reference signal) that determines the event instance or (2) a transmission occasion of a second reference signal (as defined/specified herein in the present disclosure) that is associated, specific or corresponding to the first transmission occasion of such reference signal (or the first reference signal) that determines the event instance that starts (or ends) later/the latest (or earlier/the earliest) in time,
for another example, at the beginning of or from the last/first transmission occasion or the transmission occasion that ends (or starts) the latest/earliest in time among candidate transmission occasions of (all) the reference signals configured by the newBeamResourceSet-r19, wherein any two of the candidate transmission occasions has a time gap/interval/offset smaller than (or equal to) the periodicity of the reference signals configured by the newBeamResourceSet-r19, and the candidate transmission occasions comprise, contain or include the first transmission occasion of such reference signal (or the first reference signal) that determines the event instance,
for another example, at the beginning of or from the last/first transmission occasion or the transmission occasion that ends (or starts) the latest/earliest in time among candidate transmission occasions of a second reference signal and (all) the reference signals configured by the newBeamResourceSet-r19, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of such reference signal (or the first reference signal) that determines the event instance and a/the transmission occasion of the second reference signal that is associated, specific or corresponding to the first transmission occasion of such reference signal (or the first reference signal) that determines the event instance.
for another example, at the beginning of or from the last/first transmission occasion or the transmission occasion that ends (or starts) the latest/earliest in time among the first (candidate) transmission occasions of (one or more of all) the reference signals configured by the newBeamResourceSet-r19 each determines an event instance, wherein any two of the first (candidate) transmission occasions has a time gap/interval/offset smaller than (or equal to) the periodicity of the reference signals configured by the newBeamResourceSet-r19, and the first (candidate) transmission occasions comprise, contain or include the first transmission occasion of aforementioned such reference signal (or the aforementioned first reference signal) that determines the aforementioned event instance,
for another example, at the beginning of or from the last/first transmission occasion or the transmission occasion that ends (or starts) the latest/earliest in time among candidate transmission occasions comprising a/the transmission occasion of a second reference signal and the first (candidate) transmission occasions of (one or more of all) the reference signals configured by the newBeamResourceSet-r19 each determines an event instance, wherein any two of the candidate transmission occasions has a time gap/interval/offset smaller than (or equal to) the periodicity of the second reference signal and/or the reference signals configured by the newBeamResourceSet-r19, and the candidate transmission occasions comprise, contain or include the first transmission occasion of aforementioned such reference signal (or the aforementioned first reference signal) that determines the aforementioned event instance and a/the transmission occasion of the second reference signal that is associated, specific or corresponding to the first transmission occasion of such reference signal (or the first reference signal) that determines the event instance,
   to determine a time window with a length of eventDetectionTimeWindowLength-r19 for such reference signal, if a/the (or another) timer for such reference signal is not running, and the time window includes the time while the timer is running. When the number of event instances determined for such reference signal within the time window, if eventDetectionTimeWindowLength-r19 is provided, is greater than or equal to 1 or to eventInstanceCount-r19, if provided, the UE transmits PUCCH format 0 or format 1 in the PUCCH resource configured by PUCCHResource-r19 in the CSI-ReportConfig. e.g., at least T_proc (a fixed value in system specification(s) and/or per RRC (re-)configuration(s) e.g. in unit of symbol(s)/slot(s)/etc., or configured by the network e.g. in the CSI-ReportConfig subject to a corresponding UE's capability) after the end of the time window, and/or the time window ends no later than T_proc before or prior to (the earlies transmission occasion of) the PUCCH resource—here, the PUCCH/PUCCH resource can be referred to as specific, associated or corresponding to the event evaluation or determination. In addition,
when/if eventType-r19 is set to ‘event2’ or ‘event7’, and/or when/if the first transmission occasion of such reference signal (or the first reference signal) that determines the event instance starts (or ends) later in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples herein to start a/the timer (and/or determine the corresponding time window(s)) for such reference signal (or the first reference signal), and/or
when/if eventType-r19 is set to ‘event2’ or ‘event7’, and/or when/if the first transmission occasion of such reference signal (or the first reference signal) that determines the event instance starts (or ends) earlier in time than a transmission occasion of a second reference signal (as defined/specified herein in the present disclosure) that is associated, specific or corresponding to the first transmission occasion of such reference signal (or the first reference signal) that determines the event instance, the UE could follow those specified/defined in one or more examples herein to start a/the timer (and/or determine the corresponding time window(s)) for such reference signal (or the first reference signal);

The counting of the event instances for such reference signal is restarted:
if the reference signal in the indicated TCI state or the SS/PBCH block which is QCLed with the reference signal in the indicated TCI state is updated.

In one embodiment, for a UE configured with a CSI-ReportConfig with the higher layer parameter eventType-r19 set to ‘event2’, an event instance is determined for a reference signal configured by the newBeamResourceSet-r19 (in a same CC of CSI-ReportConfig, or in the CC provided by carrier in the CSI-ReportConfig)—denoted by/as a first reference signal—if the L1-RSRP value determined for a transmission occasion of such reference signal (or the first reference signal) is an eventThreshold-r19 greater than the L1-RSRP value determined for a transmission occasion of
the reference signal in the indicated TCI state (applied to the same CC of the reference signal configured by the newBeamResourceSet-r19, or to the CC indicated by CCofIndicatedTCI-r19 in the CSI-ReportConfig)—denoted by/as a second reference signal, if newBeamResourceSet-r19 is a NZP-CSI-RS-ResourceSet configured with repetition, wherein when/if the UE is configured with SSB-MTC-AdditionalPCI, the reference signal in the indicated TCI state could be associated with a PCI (e.g., a/the serving cell PCI or a PCI other than the serving cell PCI) or a PCI index pointing to the PCI from/in a list/set/pool of PCIs higher layer configured or provided to the UE such that the reference signal here could be associated with a SS/PBCH (SSB)—e.g., the SSB could be QCLed with the reference signal, and the SSB is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this design example, a/the SSB index of or corresponding to the SSB could be associated with a/the (same) PCI or PCI index,
else,
the SS/PBCH block which is QCLed with the reference signal in the indicated TCI state (applied to the same CC of the reference signal configured by the newBeamResourceSet-r19 or to the CC indicated by CCofIndicatedTCI-r19 in the CSI-ReportConfig)—denoted by/as a second reference signal, if newBeamResourceSet-r19 is a CSI-SSB-ResourceSet, wherein when/if the UE is configured with SSB-MTC-AddtionalPCI, the SS/PBCH block (SSB) here could be associated with a PCI (e.g., a/the serving cell PCI or a PCI other than the serving cell PCI) or a PCI index pointing to the PCI from/in a list/set/pool of PCIs higher layer configured or provided to the UE
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this design example, a/the SSB index of or corresponding to the SSB could be associated with a/the (same) PCI or PCI index.

Throughout the present disclosure, in this this case, the transmission occasion of the second reference signal is associated, specific or corresponding to the transmission occasion of such reference signal (or the first reference signal) that determines the event instance.

The UE, after transmitting PUCCH format 0 or 1 corresponding to a CSI-ReportConfig with eventType-r19, reports in a single reporting instance (or an UEI (CSI/beam) report) nrofReportedRS-UEIBR-r19 CRIs or SSBRIs—when/if the UE is configured with the higher layer parameter SSB-MTC-AdditionalPCI, the NZP CSI-RS resources or SSB resources corresponding to the reported CRIs or SSBRIs could be associated with PCI indices referring to the PCI of the serving cell and PCI(s) different from the PCI of the serving cell within the set of PCIs configured, their absolute L1-RSRP or differential L1-RSRPs and, when eventConditionMetIndicationInclusion, eventDetectionTimeWindowLength-r19, and eventInstanceCount-r19 are configured and nrofReportedRS-UEIBR-r19 is set to a value greater than 1, their indications on whether reference signals indicated by reported CRIs or SSBRIs satisfy the event, corresponding to reference signals provided by the newBeamResourceSet-r19 that comprise at least one reference signal that satisfies the event, and, when enabledCurrentBeamReport-r19 is configured, the differential L1-RSRP corresponding to the reference signal in the indicated TCI state, or to the SS/PBCH block which is QCLed with the reference signal in the indicated TCI state (the herein can also be referred to as or denoted by UEI report content(s)):
on a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB-r19 in the same CC as the corresponding CSI-ReportConfig on the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.

The reference signal in the indicated TCI state is the reference signal w.r.t. QCL-TypeD, if there are two QCL RSs in the indicated TCI state.

In one embodiment, for a UE configured with a CSI-ReportConfig with the higher layer parameter eventType-r19 set to ‘event1’, an event instance is determined if the L1-RSRP value determined for a transmission occasion of
the reference signal in the indicated TCI state (applied to the same CC of the reference signal configured by the newBeamResourceSet-r19, or to the CC indicated by CCofIndicatedTCI-r19 in the CSI-ReportConfig)—denoted by/as a second reference signal, if newBeamResourceSet-r19 is a NZP-CSI-RS-ResourceSet configured with repetition, wherein when/if the UE is configured with SSB-MTC-AddtionalPCI, the reference signal in the indicated TCI state could be associated with a PCI (e.g., a/the serving cell PCI or a PCI other than the serving cell PCI) or a PCI index pointing to the PCI from/in a list/set/pool of PCIs higher layer configured or provided to the UE such that the reference signal here could be associated with a SS/PBCH (SSB)—e.g., the SSB could be QCLed with the reference signal, and the SSB is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this design example, a/the SSB index of or corresponding to the SSB could be associated with a/the (same) PCI or PCI index,
else,
the SS/PBCH block which is QCLed with the reference signal in the indicated TCI state (applied to the same CC of the reference signal configured by the newBeamResourceSet-r19, or to the CC indicated by CCofIndicatedTCI-r19 in the CSI-ReportConfig)—denoted by/as a second reference signal, if newBeamResourceSet-r19 is a CSI-SSB-ResourceSet, wherein when/if the UE is configured with SSB-MTC-AddtionalPCI, the SS/PBCH block (SSB) here could be associated with a PCI (e.g., a/the serving cell PCI or a PCI other than the serving cell PCI) or a PCI index pointing to the PCI from/in a list/set/pool of PCIs higher layer configured or provided to the UE
   in one example, a/the TCI state—e.g., the higher layer parameter TCI-State that configures or provides the TCI state—that has the SSB as a/the (QCL source) reference signal provided or indicated or configured therein and the reference signal in the indicated TCI state as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this design example, a/the SSB index of or corresponding to the SSB could be associated with a/the (same) PCI or PCI index
      is lower than eventThreshold-Event1-r19, where newBeamResourceSet-r19 is in a same CC of CSI-ReportConfig, or in the CC provided by carrier in the CSI-ReportConfig.

The UE, after transmitting PUCCH format 0 or 1 corresponding to a CSI-ReportConfig with eventType-r19, reports in a single reporting instance (or an UEI (CSI/beam) report) nrofReportedRS-UEIBR-r19 CRIs or SSBRIs—when/if the UE is configured with the higher layer parameter SSB-MTC-AdditionalPCI, the NZP CSI-RS resources or SSB resources corresponding to the reported CRIs or SSBRIs could be associated with PCI indices referring to the PCI of the serving cell and PCI(s) different from the PCI of the serving cell within the set of PCIs configured, and their absolute L1-RSRP or differential L1-RSRPs, corresponding to reference signals provided by the newBeamResourceSet-r19, and, when enabledCurrentBeamReport-r19 is configured, the absolute L1-RSRP corresponding to the reference signal in the indicated TCI state, or to the SSB which is QCLed with the reference signal in the indicated TCI state (the herein can also be referred to as or denoted by UEI report content(s)):
on a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB-r19 in the same CC as the corresponding CSI-ReportConfig, on the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.

The reference signal in the indicated TCI state is the reference signal w.r.t. QCL-TypeD, if there are two QCL RSs in the indicated TCI state.

In one embodiment, for a UE configured with a CSI-ReportConfig with the higher layer parameter eventType-r19 set to ‘event7’, an event instance is determined for a reference signal configured by the newBeamResourceSet-r19 (in a same CC of CSI-ReportConfig, or in the CC provided by carrier in the CSI-ReportConfig)—denoted by/as a first reference signal—if the L1-RSRP value determined for a transmission occasion of such reference signal (i.e., the first reference signal) is an eventThreshold-r19 greater than the L1-RSRP value determined for a transmission occasion of
the reference signal with the valueOfQ-r19 highest L1-RSRP out of the reference signals among the activated TCI states (applied to the same CC of CSI-ReportConfigCSI-ReportConfig, or to the CC indicated by CCofIndicatedTCI-r19 in the CSI-ReportConfig)—denoted by/as a second reference signal, if newBeamResourceSet-r19 is a NZP-CSI-RS-ResourceSet configured with repetition, wherein when/if the UE is configured with SSB-MTC-AdditionalPCI, the aforementioned reference signal could be associated with a PCI (e.g., a/the serving cell PCI or a PCI other than the serving cell PCI) or a PCI index pointing to the PCI from/in a list/set/pool of PCIs higher layer configured or provided to the UE such that the reference signal here could be associated with a SS/PBCH (SSB)—e.g., the SSB could be QCLed with the reference signal, and the SSB is associated with a/the (same) PCI or PCI index
   in one example, a/the TCI state—e.g., the higher layer parameter TCI-State that configures or provides the TCI state—that has the SSB as a/the (QCL source) reference signal provided or indicated or configured therein and the aforementioned reference signal as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this design example, a/the SSB index of or corresponding to the SSB could be associated with a/the (same) PCI or PCI index,
else,
a SS/PBCH block corresponding to
   setting-1: the SS/PBCH block with the valueOfQ-r19 highest L1-RSRP out of the SS/PBCH blocks QCLed with the reference signals among the activated TCI states (applied to the same CC of CSI-ReportConfigCSI-ReportConfig, or to the CC indicated by CCofIndicatedTCI-r19 in the CSI-ReportConfig)—denoted by/as a second reference signal, if newBeamResourceSet-r19 is a CSI-SSB-ResourceSet.
   setting-IL: the SS/PBCH block QCLed with the reference signal with the valueOfQ-r19 highest L1-RSRP out of the reference signals among the activated TCI states (applied to the same CC of CSI-ReportConfigCSI-ReportConfig, or to the CC indicated by CCofIndicatedTCI-r19 in the CSI-ReportConfig)—denoted by/as a second reference signal, if newBeamResourceSet-r19 is a CSI-SSB-ResourceSet.
The UE could follow setting-I and/or setting-II to identify/determine the SS/PBCH block according to or following: (1) fixed rule(s)/value(s) in system specification(s) and/or per RRC (re-)configuration, e.g., following setting-I or setting-II, (2) network's configuration(s)/indication(s) e.g. via/by/in higher layer RRC signalling(s)/parameter(s) and/or MAC CE command(s) and/or dynamic DCI based L1 signaling(s) based on or according to UE's capability(s) or capability signalling(s), and/or (3) UE's autonomous determination/selection, which could be further sent or transmitted or indicated to the network (e.g., the network 130) via/by/in various UL channels/signals including CSI/beam report(s), UE's capability signalling(s) and/or etc. For instance, depending on or according to or based on a corresponding UE's capability or capability signalling, when/if the UE is configured with a/the CSI-ReportConfig with the higher layer parameter ssbDetermination set to ‘type-I’ or ‘setting-I’, the UE could follow those specified/defined in setting-I to identify/determine the SS/PBCH block; and/or when/if the UE is configured with a/the CSI-ReportConfig with the higher layer parameter ssbDetermination set to ‘type-II’ or ‘setting-II’, the UE could follow those specified/defined in setting-II to identify/determine the SS/PBCH block. When/if the UE is configured with SSB-MTC-AdditionalPCI, the SS/PBCH block (SSB) here could be associated with a PCI (e.g., a/the serving cell PCI or a PCI other than the serving cell PCI) or a PCI index pointing to the PCI from/in a list/set/pool of PCIs higher layer configured or provided to the UE
   in one example, a/the TCI state—e.g., the higher layer parameter TCI-State that configures or provides the TCI state—that has the SSB as a/the (QCL source) reference signal provided or indicated or configured therein and the aforementioned reference signal as a/the (QCL target) reference signal could include, contain, comprise, provide or configure a/the (same) PCI or PCI index
   in another example, a/the SSB index of or corresponding to the SSB could be in a/the CSI-SSB-ResourceSet that includes one set of SSB indices and one set of PCI indices, where each SSB index is associated with a PCI index; for this design example, a/the SSB index of or corresponding to the SSB could be associated with a/the (same) PCI or PCI index.

Throughout the present disclosure, in this this case, the transmission occasion of the second reference signal is associated, specific or corresponding to the transmission occasion of such reference signal (or the first reference signal) that determines the event instance.

The UE, after transmitting PUCCH format 0 or 1 corresponding to a CSI-ReportConfig with eventType-r19, reports in a single reporting instance (or an UEI (CSI/beam) report) nrofReportedRS-UEIBR-r19 CRIs or SSBRIs—when/if the UE is configured with the higher layer parameter SSB-MTC-AdditionalPCI, the NZP CSI-RS resources or SSB resources corresponding to the reported CRIs or SSBRIs could be associated with PCI indices referring to the PCI of the serving cell and PCI(s) different from the PCI of the serving cell within the set of PCIs configured, their absolute L1-RSRP or differential L1-RSRPs and, when eventConditionMetIndicatorInclusion, eventDetectionTimeWindowLength-r19, and eventInstanceCount-r19 are configured and nrofReportedRS-UEIBR-r19 is set to a value greater than 1, their indications on whether reference signals indicated by reported CRIs or SSBRIs satisfy the event, corresponding to reference signals provided by the newBeamResourceSet-r19 that comprise at least one reference signal that satisfies the event, and, when enabledCurrentBeamReport-r19 is configured, the differential L1-RSRP corresponding to the reference signal with the valueOfQ-r19 highest L1-RSRP out of the activated TCI state reference signals, or to the SSB which is QCLed with the reference signal with the valueOfQ-r19 highest L1-RSRP out of the activated TCI state reference signals (the herein can also be referred to as or denoted by UEI report content(s)):
on a PUSCH indicated by the DCI format 0_1/0_2 in a PDCCH reception after the end of the transmitted PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredPUSCHResourceOfModeB-r19 in the same CC as the corresponding CSI-ReportConfig, which is the first available transmission occasion numOfSymbols-ModeB-r19 symbols after the end of the transmitted PUCCH if reportTransmissionMode-r19 is configured as ‘ModeB’, where the periodicity of the PUCCH resource and type 1 CG-PUSCH resource is the same, and the CG-PUSCH does not carry UL-SCH.

The reference signal with the valueOfQ-r19 highest L1-RSRP out of the activated TCI state reference signals is the reference signal w.r.t. QCL-TypeD, if there are two QCL RSs in such activated TCI state.

For a UE configured with multiple CSI-ReportConfig in a same CC with same higher layer parameters eventType-r19, firstPUCCHResourceConfig-UEIBR-r19, and reportTransmissionMode-r19, the UE expects
the multiple CSI-ReportConfig to be associated with a same CSI trigger state if reportTransmissionMode-r19 is configured as ‘ModeA’, else
the same configuredPUSCHResourceOfModeB-r19 if reportTransmissionMode-r19 is configured as ‘ModeB’, and
   when reporting in a single reporting instance nrofReportedRS-UEIBR-r19 CRIs or SSBRIs corresponding to reference signals provided by the newBeamResourceSet-r19 in a CSI-ReportConfig that satisfies the event, the CSI report contains the corresponding CSI-ReportConfigId and is zero padded to a fixed payload size (when needed), with the fixed payload size given by the maximum payload size among the multiple CSI-ReportConfig.

Throughout the present disclosure, transmitting or transmission(s) of or re-transmission(s) of a PUCCH of the first UL channel as in Step-1 of Mode A, Mode B and/or Mode C according to or following those specified/defined herein in the present disclosure could be equivalent to transmitting or transmission(s) of or re-transmission(s) of a PN message/trigger over/in/by a PUCCH resource of the first UL channel as in Step-1 of Mode A, Mode B and/or Mode C according to or following those specified/defined herein in the present disclosure. Similarly, transmitting, transmission(s) of or re-transmission(s) of beam report(s), e.g., the UEI beam report(s) as specified/defined herein in the present disclosure, via/by/in (DG or CG) PUSCH resource(s) of the second UL channel as in Step-2 of Mode B and/or Step-3 of Mode A and/or Mode C according to or following those specified/defined herein in the present disclosure is equivalent to transmitting, transmission(s) of or re-transmission(s) of PUSCH(s) or PUSCH resource(s) of the second UL channel as in Step-2 of Mode B and/or Step-3 of Mode A and/or Mode C carrying beam report(s), e.g., the UEI beam report(s) as specified/defined herein in the present disclosure, according to or following those specified/defined herein in the present disclosure. The UE could be provided or configured by the network, e.g., via higher layer RRC signalling(s)/parameter(s) e.g. firstPUCCHResourceConfig-UEIBR, a configuration for PUCCH transmission of the first UL channel as in Step-1 of Mode A, Mode B and/or Mode C with a/the report notification (RN) or report resource request (RRR), wherein a/the RN or RRR could be of a UCI type/parameter. Furthermore, the UE could be provided or configured by the network, e.g., via higher layer RRC signalling(s)/parameter(s) e.g. secondPUSCHResourceConfig-UEIBR, a configuration for PUSCH transmission of the second UL channel as in Step-2 of Mode B.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to abeam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc. A/the higher layer parameter CSI-ReportConfig and/or UEI-ReportConfig could correspond to or could be equivalent to or referred to a/the higher layer parameter CSI-AssociatedReportConfigInfo, and vice versa, such that they could be used or applied exchangeable or in similar/same manner(s) throughout the present disclosure. Additionally, a CSI reporting setting not (dedicated) for the UE-initiated/event-driven beam reporting as specified/defined herein in the present disclosure could correspond to or could be equivalent to or could be referred to a CSI reporting setting for aperiodic CSI/beam reporting or a CSI reporting setting for L1/L2 triggered mobility (LTM), and vice versa. In addition, a CSI reporting setting corresponding to another CSI reporting setting could be equivalent to the CSI reporting setting comprising, containing, including and/or providing the another CSI reporting setting.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). Furthermore, a CSI report setting/CSI report configuration is equivalent to a CSI reporting setting/CSI reporting configuration and vice versa.

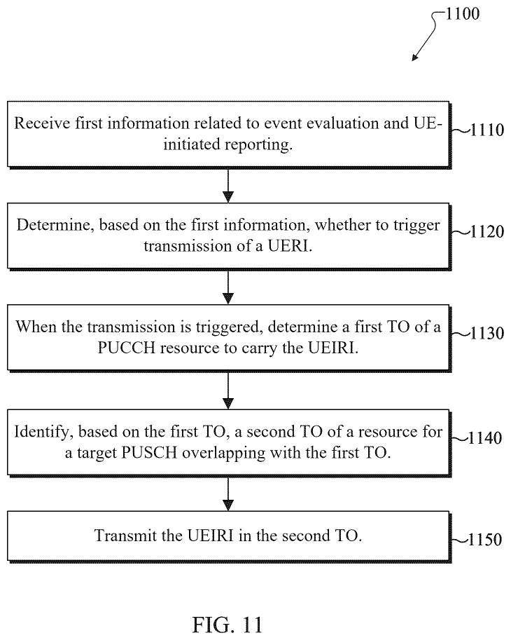

FIG. 11 illustrates an example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method 1100 begins with the UE receiving first information related to event evaluation and UE-initiated reporting (1110). The UE then determines, based on the first information, whether to trigger transmission of a UERI (1120). The UE then, when the transmission is triggered, determines a first TO of a PUCCH resource to carry the UEIRI (1130). The UE then identifies, based on the first TO, a second TO of a resource for a target PUSCH overlapping with the first TO (1140). For example, in 1140, the target PUSCH carries second information. The UE then transmits the UEIRI in the second TO (1150).

In various embodiments, the first information indicates a threshold of an event instance. The UE, when the first information comprises a transmission configuration indication (TCI) state update, resets a counter of the event instance. When a value of the counter reaches the threshold, the transmission is triggered. In various embodiments, when a SSB resource set is configured for event evaluation, an SSB quasi co-located with a NZP CSI-RS resource in the TCI state update is different from an SSB currently used for event evaluation. When a NZP CSI-RS resource set is configured for event evaluation, a NZP CSI-RS resource in the TCI state update is different from an NZP CSI-RS resource currently used for event evaluation. In various embodiments, the UEIRI is a one-bit uplink control information (UCI) indication. The second information includes at least one of an uplink transport block, a CSI report, a HARQ-ACK, and an UTO-UCI. In various embodiments, the UEIRI is appended to the second information carried in the target PUSCH. In various embodiments, when multiple PUSCH resources with respective TOs overlap with the first TO, the processor is further configured to determine the target PUSCH resource, from the multiple PUSCH resources according to one of the second TO of the target PUSCH resource having a latest ending time among all TOs of the multiple PUSCH resources, or the second TO of the target PUSCH resource having an earliest starting time among all TOs of the multiple PUSCH resources. In various embodiments, the first information indicates N symbols, where N is a positive integer. The UE identifies a first available TO of a configured grant PUSCH resource. The first available TO is at least N symbols after an end of the second TO. The UE transmits a UEIR in the first available TO of the configured grant PUSCH resource.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive first information related to event evaluation and UE-initiated reporting; and
a processor operably coupled with the transceiver, the processor configured to:
determine, based on the first information, whether to trigger transmission of a UE-initiated report indicator (UERI);
when the transmission is triggered, determine a first transmission occasion (TO) of a physical uplink control channel (PUCCH) resource to carry the UEIRI; and
identify, based on the first TO, a second TO of a resource for a target physical uplink shared channel (PUSCH) overlapping with the first TO, wherein the target PUSCH carries second information,
wherein the transceiver is further configured to transmit the UEIRI in the second TO.

2. The UE of claim 1, wherein:
the first information indicates a threshold of an event instance;
the processor is further configured to, when the first information comprises a transmission configuration indication (TCI) state update, reset a counter of the event instance; and
when a value of the counter reaches the threshold, the transmission is triggered.

3. The UE of claim 2, wherein:
when a synchronization signal/physical broadcast channel block (SSB) resource set is configured for event evaluation, an SSB quasi co-located with a non-zero-power (NZP) channel state information reference signal (CSI-RS) resource in the TCI state update is different from an SSB currently used for event evaluation; and
when a NZP CSI-RS resource set is configured for event evaluation, a NZP CSI-RS resource in the TCI state update is different from an NZP CSI-RS resource currently used for event evaluation.

4. The UE of claim 1, wherein:
the UEIRI is a one-bit uplink control information (UCI) indication; and
the second information includes at least one of:
an uplink transport block,
a channel state information (CSI) report,
a hybrid automatic repeat request acknowledgement (HARQ-ACK), and
an unused transmission occasion UCI (UTO-UCI).

5. The UE of claim 1, wherein the UEIRI is appended to the second information carried in the target PUSCH.

6. The UE of claim 1, wherein:
the processor is further configured to, when multiple PUSCH resources with respective TOs overlap with the first TO, determine the target PUSCH resource, from the multiple PUSCH resources according to one of:
the second TO of the target PUSCH resource having a latest ending time among all TOs of the multiple PUSCH resources, or
the second TO of the target PUSCH resource having an earliest starting time among all TOs of the multiple PUSCH resources.

7. The UE of claim 1, wherein:
the first information indicates N symbols, where N is a positive integer;
the processor is further configured to identify a first available TO of a configured grant PUSCH resource,
the first available TO is at least N symbols after an end of the second TO; and
the transceiver is further configured to transmit a UE-initiated report (UEIR) in the first available TO of the configured grant PUSCH resource.

8. A base station (BS), comprising:
a processor; and
a transceiver operably coupled with the processor, the transceiver configured to:
transmit first information related to event evaluation and user equipment (UE)-initiated reporting; and
receive a UE-initiated report indicator (UERI) in a second transmission occasion (TO) after transmission of a UE-initiated report indicator (UERI) is triggered,
wherein the second TO is of a resource for a target physical uplink shared channel (PUSCH) overlapping with a first TO,
wherein the first TO is of a physical uplink control channel (PUCCH) resource to carry the UEIRI, and
wherein the target PUSCH carries second information.

9. The BS of claim 8, wherein:
the first information indicates a threshold of an event instance;
a counter of the event instance is reset when the first information comprises a transmission configuration indication (TCI) state update; and
when a value of the counter reaches the threshold, the transmission is triggered.

10. The BS of claim 9, wherein:
when a synchronization signal/physical broadcast channel block (SSB) resource set is configured for event evaluation, an SSB quasi co-located with a non-zero-power (NZP) channel state information reference signal (CSI-RS) resource in the TCI state update is different from an SSB currently used for event evaluation; and
when a NZP CSI-RS resource set is configured for event evaluation, a NZP CSI-RS resource in the TCI state update is different from an NZP CSI-RS resource currently used for event evaluation.

11. The BS of claim 8, wherein:
the UEIRI is a one-bit uplink control information (UCI) indication; and
the second information includes at least one of:
an uplink transport block,
a channel state information (CSI) report,
a hybrid automatic repeat request acknowledgement (HARQ-ACK), and
an unused transmission occasion UCI (UTO-UCI).

12. The BS of claim 8, wherein the UEIRI is appended to the second information carried in the target PUSCH.

13. The BS of claim 8, wherein:
when multiple PUSCH resources with respective TOs overlap with the first TO, the target PUSCH resource, from the multiple PUSCH resources is according to one of:
the second TO of the target PUSCH resource having a latest ending time among all TOs of the multiple PUSCH resources, or
the second TO of the target PUSCH resource having an earliest starting time among all TOs of the multiple PUSCH resources.

14. The BS of claim 8, wherein:
the first information indicates N symbols, where N is a positive integer;
a first available TO of a configured grant PUSCH resource is at least N symbols after an end of the second TO; and
the transceiver is further configured to receive a UE-initiated report (UEIR) in the first available TO of the configured grant PUSCH resource.

15. A method performed by a user equipment (UE), the method comprising:
receiving first information related to event evaluation and UE-initiated reporting;
determining, based on the first information, whether to trigger transmission of a UE-initiated report indicator (UERI);
when the transmission is triggered, determining a first transmission occasion (TO) of a physical uplink control channel (PUCCH) resource to carry the UEIRI;
identifying, based on the first TO, a second TO of a resource for a target physical uplink shared channel (PUSCH) overlapping with the first TO, wherein the target PUSCH carries second information; and
transmitting the UEIRI in the second TO.

16. The method of claim 15, wherein:
the first information indicates a threshold of an event instance;
the method further comprises, when the first information comprises a transmission configuration indication (TCI) state update, resetting a counter of the event instance; and
when a value of the counter reaches the threshold, the transmission is triggered.

17. The method of claim 16, wherein:
when a synchronization signal/physical broadcast channel block (SSB) resource set is configured for event evaluation, an SSB quasi co-located with a non-zero-power (NZP) channel state information reference signal (CSI-RS) resource in the TCI state update is different from an SSB currently used for event evaluation; and
when a NZP CSI-RS resource set is configured for event evaluation, a NZP CSI-RS resource in the TCI state update is different from an NZP CSI-RS resource currently used for event evaluation.

18. The method of claim 15, wherein:
the UEIRI is a one-bit uplink control information (UCI) indication; and
the second information includes at least one of:
an uplink transport block,
a channel state information (CSI) report,
a hybrid automatic repeat request acknowledgement (HARQ-ACK), and
an unused transmission occasion UCI (UTO-UCI).

19. The method of claim 15, wherein the UEIRI is appended to the second information carried in the target PUSCH.

20. The method of claim 15, further comprising:
when multiple PUSCH resources with respective TOs overlap with the first TO, determining the target PUSCH resource, from the multiple PUSCH resources according to one of:
the second TO of the target PUSCH resource having a latest ending time among all TOs of the multiple PUSCH resources, or
the second TO of the target PUSCH resource having an earliest starting time among all TOs of the multiple PUSCH resources.
